(19) United States
(12) Patent Application Publication
(10) Pub. No.: US 2024/0281211 A1
(43) Pub. Date: Aug. 22, 2024

(54) Augmented formulaic solver of cubic and quartic polynomials

(71) Applicant: Michael Everest, Sunnyvale, CA (US)

(72) Inventor: Michael Everest, Sunnyvale, CA (US)

(21) Appl. No.: 18/172,089

(22) Filed: Feb. 21, 2023

(51) Int. Cl. G06F 7/552

(52) U.S. Cl. CPC G06F 7/552

(57) ABSTRACT

An augmentation of the traditional formulaic solving of all complex cubic and quartic univariate equations, with alternative code-paths for guaranteed precise root finding, including precise root-pair sums and differences, for all complex, cubic and quartic, equations, including fast processing for scaling and addition to roots. Iteration and interval processing are not needed. Fundamental correctness is based upon proven formulas. CPU and memory requirements are like historical implementations.

### BACKGROUND OF THE INVENTION

Formulaic solutions for roots of cubic and quartic were discovered about five hundred years ago, but with serious numeric stability issues. These formulas are one type of solution among many others, such as iterative solutions, for equation solving. The historical formulas are not numerically stable.

### SUMMARY OF THE INVENTION

This augmented formulaic method precisely solves for roots, root-pair sums, and root-pair differences, of all cubic and quartic equations. Many of these augmentations simply find alternative code paths whenever numeric cancellation occurs in the traditional formulas. Unexpectedly, there are often many ways of eliminating a specific numeric cancellation; in such cases, a “best-mode” is discussed. Also, many structural changes are introduced. Cubic equation solving involves splitting processing into first solving an intrinsic polynomial, where the roots sum to zero, and a final calculation to add a constant to all roots to produce the final roots. This leads to a second structural innovation: delta processing. This process, of scaling and adding a constant to all roots of the derived cubic polynomial of the quartic polynomial, is used to compute precise quadratic coefficients needed to solve the two traditional quadratic equations whose solutions are the four quartic roots, with only half-precision guaranteed due to possible cancellation when finding the root-pair difference. However, to find full precision results, the concept of “Multi-U” processing is invented. Unlike the historic approach of using just one root of the derived cubic polynomial, all three roots are used to produce three quadratic coefficient sets. The relationships between these sets allows the construction of full-precision quartic roots: All without even knowing the root-pair differences for the quadratic equations! Additionally, for both cubic and quartic equations, all root-pair sums and differences can be calculated. In formulaic solutions, the calculation of root-pair differences is simpler than the roots themselves, and therefore special configurations of processing return only root-pair differences. The result is a tree of new solution applications: Near the end of the specification, see the section “DETAILED SUMMARY OF AUGMENTATIONS” which discusses FIG. 28, which summarizes different configurations.

### PRIOR ART

Handbook of Mathematical Functions edited by Milton Abramowitz and Irene A. Stegun, from National Bureau of Standards Applied Mathematics Series '55, Issued June 1964, Tenth Printing, December 1972, with corrections, Library of Congress catalog number: 64-60036. Pages 17,18, from 3.81 to 3.83. The named symbols in the formulas form the foundation for the naming conventions in this patent application; the shown formulas are not perfectly correct due to incorrect branch cuts.

Beyond the Quartic Equation, by Bruce R. King, published by Birkhauser (Boston, Basel, Berlin), 1996, pages 82 to 82 to 87 for cubic solving and 87 to 89 for quartic solving. This description is very dense, but on page 84, we have conditions for choosing the proper cube root branch cuts: “In (5.1-14) the cube roots for the two terms are selected so that their product is always −b2/3 . . . ” Also, on page 88, lines (5.2-8a) and (5.2-8b), provide insight into selecting quadratic branch cuts when solving the quartic equation.

CRC Concise Encyclopedia of Mathematics, by Eric W. Weisstein, 1999, ISBN 0-8493-9640-9, Library of Congress 98-22385, published by CRC Press (Boca Raton, London, New York, Washington D.C., ISBN pages 362 to 365 for Cubic and pages 1489 to1491 for quartic. Shows a wide variety of formulaic solutions to cubic and quartic polynomials. Although the terminology changes, this book does not improve upon the solution in Handbook of Mathematical Functions, indicated above.

Also, Wolfram Research provides a program called Mathematica, version 12, which solves cubic and quartic equations. The symbolic cubic solution is shown in FIG. 29. The solution for the first of four quartic roots is shown in FIG. 30. Although the solutions appear theoretically correct, they have some problems: potential zero divides and potential massive numeric cancellation. Mathematica automatically iterates the evaluation precision until the cancellation errors are mitigated. However, this may take minutes or hours, or more! These figures illustrate the complexity of the most basic formulaic solution, but no further reference is made to these figures.

### BRIEF DESCRIPTION OF FIGURES

FIG. 1A, Polynomial Types (Prior Art): nomenclature for coefficients of polynomials, and more.

FIG. 1B, Generic Split Process: separately processing ‘Intrinsics’ and the final roots.

FIG. 2A, Quadratic Solution (Prior Art): standard quadratic solution viewed as a Generic Split Process.

FIG. 2B, Precise Quadratic Solver: a precise quadratic solution with only precise, not exact, input.

FIG. 2C, Ratio Product Solver: quadratic solution which uses the ratio of roots instead of a discriminant.

FIG. 3A, Numeric Utilities: numeric utilities frequently used in the document.

FIG. 3B, Delta Polynomials: transformations to polynomials to scale and add a constant to all roots.

FIG. 4A, Standard Delta Process: finding final delta roots and associating to intrinsic roots.

FIG. 4B, Split Delta Process: fast method for solving and associating delta results.

FIG. 4C, Delta Iteration: iteration to higher precision results.

FIG. 5, Cubic Split Processing: cubic solution of finding Intrinsics before final roots.

FIG. 6 (Prior Art), Cubic Intrinsic Setup (Prior Art): setup for cubic intrinsic roots.

FIG. 7A, Cube Roots of Unity: table of the exact and approximate cube roots of unity.

FIG. 7B, Multipliers for CRS Pairs: table of three CRS pairs from any initial CSR pair.

FIG. 7C, Decimal Digits Loss: visualization of loss of precision.

FIG. 8A, Traditional Cubic Intrinsic Roots: eliminating the final offset yields intrinsic roots.

FIG. 8B, Cubic Intrinsic Root-Pair Sums: formulas for root-pair sums.

FIG. 8C, Cubic Root-Pair Differences: formulas for cubic root-pair differences.

FIG. 8D, Cubic Intrinsic Root Pair Differences of Intrinsic root-pair sums

FIG. 9A, Cubic Polynomial Identities (Prior Art): well-known meaning of cubic coefficients

FIG. 9B, Cubic Paired Root Summation: formulas for root-pair summation.

FIG. 9C, Inverted Roots Polynomial (Prior Art): inverse roots for cubic and quartic polynomials.

FIG. 10, Cubic Final Calculator: components for finding the final cubic roots from Intrinsics.

FIGS. 11A to 11F, visualizations of relationships between intrinsic roots and final cubic roots.

FIG. 12, Degenerate Table: shows how to find the final roots in cubic degenerate cases.

FIG. 13, Constrained Double Root Solver: processing with two unknown final cubic roots.

FIG. 14, Quadratic Double Root Finder: Quadratic Double Root Finder method to find two unknown roots.

FIG. 15A, Tau Equations: equations using a +tau or −tau root offset for finding missing root.

FIG. 15B, Tau Key Values: the key intrinsic calculations for plus/minus tau equations.

FIG. 16A, Paired Test Table: table of relative error calculation for tau equations.

FIG. 16B, Double Root Matching Table: matching roots using tau equations.

FIG. 17A, Cubic Univariate Intrinsic Scaling: single variable cubic intrinsic processing.

FIG. 17B, Q=1, Univariate Setup: shows setup of pre-scaling for case of setting Q=1.

FIG. 18A, Cubic Split Delta Process: generic method to add-to and scale original roots.

FIG. 18B, Cubic Split Delta Process, quick summary.

FIG. 18C, Cubic Delta Iteration, improving known root values.

FIG. 19A (Prior Art), Quartic Polynomial: the canonical quartic polynomial in‘x’.

FIG. 19B, Derived Cubic Polynomial: derived Cubic's coefficients in terms of the original quartic.

FIG. 19C, (Prior Art), parts of quadratic coefficient construction for two quadratics to solve quartic.

FIG. 19D, Quartic Polynomial: branch cut adjustment for quartic.

FIG. 19E, Quartic Polynomial: final quadratic equations of quartic polynomial.

FIG. 20A, m1p1Eq Quadratic: delta specifications for construction of m1p1Eq quadratic.

FIG. 20B, m0p0Eq Quadratic: delta specifications for construction of m0p0Eq quadratic.

FIG. 20C, BCS Usage: several methods for ensuring compatible quadratic branch cuts.

FIG. 21A, Split Coefficient Processor: repeated delta processing for coefficients of two quadratic equations.

FIG. 21B, Sqrt1 Divide Mode: alternative for finding coefficients without evaluating Sqrt0.

FIG. 21C, Coefficient Manager Implementations: alternatives for finding coefficients.

FIG. 22A, Sqrt1 Alternate Resolver: diagram for the Sqrt1 Divide Mode when Sqrt1 is zero.

FIG. 22B, Sqrt0 Divide Mode: alternative for finding coefficients without evaluating Sqrt1.

FIG. 22C, Sqrt0 Alternate Resolver: diagram for the Sqrt0 Divide Mode when Sqrt0 is zero.

FIG. 23A, Quick Quartic Processor: basic quartic solver for guaranteed ½ precision.

FIG. 23B, Multi-U Solver: high level view of solver for full precision quartic processing.

FIG. 24A, Uxy Cubic Data: Derived Cubic root-pair difference and sum, Ux−Uy, Ux+Uy.

FIG. 24B, Quartic Root Layouts: all possible layouts of quartic roots based on three U roots.

FIG. 24C Quartic Coefficients (Prior Art): arrangement of roots within the quartic coefficients

FIG. 25A, UzData: coefficient data from single u-root, for the quadratic processing.

FIG. 25B, UxySumDiff: finding the root-pair differences between quadratic roots.

FIG. 25C, Choices for Multi-U Evaluator (540)

FIG. 26A, UxyProductDiffData: differencing the Uxy data, difference between M0 and P0.

FIG. 26B, UxyProductAddData: adding the Uxy data, adding M0 and P0.

FIG. 26C, UxyMultiplyAddData: ratio of quadratic roots by multiplying coefficients.

FIG. 27A, UxyDivideData: ratio of roots of the quadratics by dividing coefficients.

FIG. 27B, Quartic Difference Processor: diagram of fast method of finding quartic root-pair differences.

FIG. 28, Summary of Augmentations

FIG. 29, Prior Art: Mathematica's Cubic Solution

FIG. 30, Prior Art: Mathematica's Quartic, First of Four Roots

### REFERENCE NUMERALS

002 Split Delta Manager
003 Delta Iterator
010 Generic Split Process
018 Polynomial Solver
020 Intrinsic Calculator
030 Intrinsic Setup
040 Intrinsic Evaluator
050 Final Calculator
060 Final Setup
070 Final Evaluator
090 Delta Setup
090 Delta Setup
092 Root Accumulator
094 Delta Manager
200 Quadratic Solution
202 Precise Quadratic Solver
203 Ratio Product Solver
220 Quadratic Intrinsic Calculator
230 Quadratic Intrinsic Setup
240 Quadratic Intrinsic Evaluator
250 Quadratic Final Calculator
260 Quadratic Final Setup
270 Quadratic Final Evaluator
272 Primary Root Extractor
273 Ambiguous Roots Finder
274 Secondary Root Extractor
300 Cubic Split Process
304 Generic Cubic Intrinsic Calculator
305 Paired Root Sum Calculator
317 Cubic Delta Iterator
318 Cubic Split Delta Manager
319 Cubic Delta Setup
320 Cubic Intrinsic Calculator
321 Univariate Cubic Intrinsic Calculator
330 Cubic Intrinsic Setup
340 Cubic Intrinsic Evaluator
342 Cubic CRS Pair
343 Cubic CRS List
344 Cubic SumDiff CRS
347 Cubic Intrinsic Root-Pair Sums
348 Cubic Intrinsic Root Solver
349 Cubic Root Difference Solver
350 Cubic Final Calculator
351 Cubic Split Solver
353 Brute Force Solver
354 Generic Cubic Split Solver
360 Cubic Final Setup
370 Cubic Final Evaluator
372 Final Roots Constrainer
373 Inverse Root Solver
375 Double Root Degenerate Processor
376 One Root Processor
377 Degenerate One Zero Matcher 377
380 Constrained Double Root Solver
382 Universal Double Matcher
386 Equation Solver
388 Paired Double Root Finder
389 Missing Paired Sum Evaluator
390 Quadratic Double Root Finder
391 Two Candidates Solver
392 Candidates Pairing Calculator
394 Correct Pair Resolver
396 Root Pair Matcher
396 Root Pair Matcher
398 Pair Analyzer
399 Generic Cubic Final Calculator
407 Split Coefficient Processor
408 Quartic Precise Setup
409 Triple Coefficient Processor
424 Multi-U Tables
430 Coefficient Manager
435 One Sqrt1 Zero
436 Sqrt1 Divide Solver
437 Two Sqrt1 Zero
438 Three Sqrt1 Zero
439 Inner0 Polynomial Evaluation
441 Sqrt0 Divide Solver
443 Inner1 Polynomial Evaluation
444 productN1 Evaluator
446 Sqrt1 Evaluator
448 Sqrt0 Evaluator
450 Branch Cut Evaluator
460 Sqrt1 Zero Resolver
462 Sqrt1 Zero Direct Resolver
464 Sqrt1 Zero Coefficient Resolver
480 Sqrt0 Zero Resolver
482 Sqrt0 Zero Direct Resolver
484 Sqrt0 Zero Coefficient Resolver 484
495 One Sqrt0 Zero
497 Two Sqrt0 Zero
498 Three Sqrt0 Zero
500 Basic Quartic Processor
502 Quick Final Solver
518 Zero Processor
520 Multi-U Solver
540 Multi-U Evaluator
541 Multi-U Preprocessor
560 Uxy Analyzer
562 Uxy Sum Differencer
564 Uxy Multiplier
566 Uxy Product Differencer
568 Uxy Product Adder
570 Uxy Divider
580 Ux Analyzer
581 Uxy Cubic Provider
582 Uz Data Provider
600 Univariate Manager
605 Z-Looper
606 Direct Solver
607 Zero Handler
608 One Solved Handler
609 Z-Looper Associator
610 Univariate Preprocessor
611 Generic-Z Handler
612 Ratio Divider Solver
616 Triple Multi-U Solver
620 Univariate Calculator
630 Univariate Post Processor
650 Multi-U NoDiff Evaluator
651 Multi-U Diff Evaluator
653 Multi-U NoZeroesNoDiffs
654 Multi-U ZeroesNoDiffs
655 Multi-U NoZeroesDiffs
656 Multi-U ZeroesDiffs
680 Difference Processor
684 Derived Polynomial Creator
688 Inner1 Delta Extraction
810 CancellationTest
812 Precise
813 PreciselyEqual
814 NQuick
816 SquareAbs
818 RelativeError
820 DotProduct

### TERMINOLOGY AND UTILITIES

Augmented Solution: a solution relying on formulas or other methods, but with alternative formulas processed when the original formula produces too much numeric error.

Exact Expression Evaluations: An exact expression represents an exact numeric value, a value without any error whatsoever; such expressions can be evaluated to precise value with minimal round-off error.

Floating-Point Numbers: The term floating-point number can refer to either a real value or a complex value. Typically, floating-point is implemented in hardware, but may be an arbitrary complicated software implementation. In general, to understand this description, consider a floating-point value as having a “sign”, mantissa, and exponent.

Precise: When working with floating point, whether hardware or software floating point, the term ‘precise’ result means that the result values are correct except for a small error, where the small error is equivalent to a small number of round-off errors. For example, if the floating-point precision, hardware, or software, is 16 decimal digits, then, after extensive computation, a non-zero result is never less than about twelve or thirteen decimal digits of precision, which includes all numerical errors. Also, if the correct result is exactly zero, then the resulting precise evaluation result must also be an exact zero.

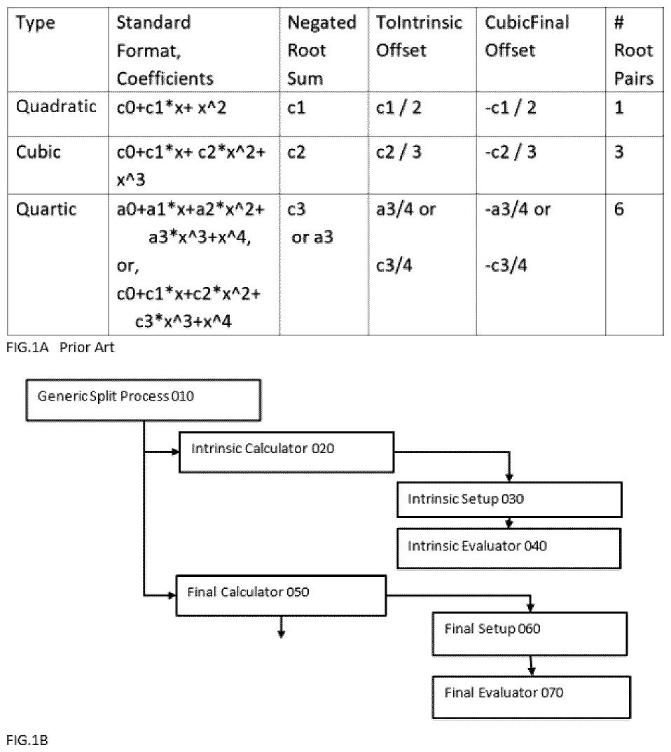

Intrinsic: Intrinsic roots of a polynomial are critical. In this document's definition, as seen in FIG. 1A, the intrinsic roots always sum to zero with a unique constant, the Cubic Final Offset, that when added to each of the intrinsic roots, produces the final roots of the polynomial. Also, we have intrinsic root-pair sums and differences. In a cubic polynomial, suppose the three final roots of a polynomial are {fR1, fR2, fR3}. Then, the Cubic Final Offset, is exactly −c3/3=(fR1+fR2+fR3)/3. See FIG. 1A for the definition of ToIntrinsic Offset which is the negated Cubic Final Offset. Then, the three intrinsic roots are {iR1=fR1+ToIntrinsic, iR1=fR2+ToIntrinsic, iR3=fR3+ToIntrinsic}. The three possible intrinsic root-pair differences and intrinsic root-pair sums are derived from the sums and differences between all pairing of the intrinsic roots. For this document, all these values are collectively called Intrinsics, even though the word Intrinsics is, technically, not a proper noun. This new concept, Intrinsics, is essential to this invention. At first, the computation of Intrinsics might seem futile, because adding the Cubic Final offset, to the intrinsic roots can cause massive cancellation. None-the-less finding the Intrinsics is often easier than finding the final roots, and as will be seen, precise methods exist for adding an offset to the cubic intrinsic roots without causing cancellation. Also, other values which do not vary when a constant is added to all roots, such as any polynomial discriminant, are also considered part of the Intrinsics.

Arbitrary Precision vs. High Precision: Here the term ‘arbitrary precision’ refers to the ability to call upon nearly unlimited precision to achieve a precise result. Arbitrary precision evaluation often involves starting a calculation, and if the result lacks sufficient precision, the precision is raised and the computations are repeated with, say, twice the precision; this is repeated as necessary until patience is exhausted or the result is precise. However, often only ‘high precision’ is needed, such as when precisely evaluating expression terms of multiplies of exact floating-point values. For example, a*(b+c), where {a,b,c} are exact floating point values, is evaluated by summing the exact expressions a+b and a*c, both of which may require twice the precision of the original floating point to perform the multiples. If one of the products is grossly smaller, then it need not be considered in the final product. On the other hand, if b and c are arbitrary values or functions of values, then the result can require arbitrary precision. Generally, the term arbitrary precision is used, herein, to refer to both arbitrary precision and high precision, and the exact nature of the polynomial's coefficients determines if high precision is sufficient.

Numeric Errors: Four encountered numeric errors are: approximation, roundoff, cancellation, and branch cut errors. Approximation errors are tiny and occur when taking a number and approximating to some specified precision; roundoff error occurs when rounding the result to a floating-point precision. Both approximation error and roundoff errors are tiny relative other precision errors. Cancellation error occurs with addition and subtraction of approximate numbers. For example, let x represent unknown digits. Then, for subtracting an approximate 3.1417x from an approximate 3.1418x, leaves .0001xxxxxx; note that the inputs have 5 digits of precision, but the result only has 1 significant digit of precision. To avoid significant errors within the historic formulas, when using approximate numbers, every formula is checked for cancellation for each addition and each subtraction. And, if cancellation is found, an alternative process is used. Branch-cut errors are typically catastrophic unless some fixup is provided, as given herein.

Constrained Cancellation: Constrained Cancellation detects the amount of cancellation, and if small enough, then a standard code path is use; otherwise, an alternative code path is used. If the allowed amount of cancellation is exceeded, then the slight amount of detected cancellation ensures that the selected alternative code path is guaranteed to have only a small amount of cancellation. Thus, whatever the correct code path, only a small amount of error is introduced, and that detected error guarantees a precise result, as needed for solving cubic polynomials.

### Historical Perspective

Finding Roots: Finding roots of cubic and quartic polynomials is important in many applications. As with the Sqrt function, simple algebraic formulas to theoretically find these roots were discovered long ago. These formulas are likened to an accurate treasure map, but like treasure maps in the movies, having an accurate treasure map doesn't eliminate the hazards of traversing the map; many extraordinary dangers await. Historical mathematical expressions for direct expression evaluation for cubic and quartic root finding are often theoretically correct and appear easy to apply. But they cannot be directly used in critical real-time situations. Why? Unexpected numerical cancellation of digits sometimes washes away precise results, and arbitrarily-high-precision intermediate results are sometimes required to obtain even a low precision result. Traditional descriptions of cubic and quartic solutions are typically limited to polynomials with real coefficients, but mathematicians have known that the same underlying formulas can work for complex numbers, as utilized herein.

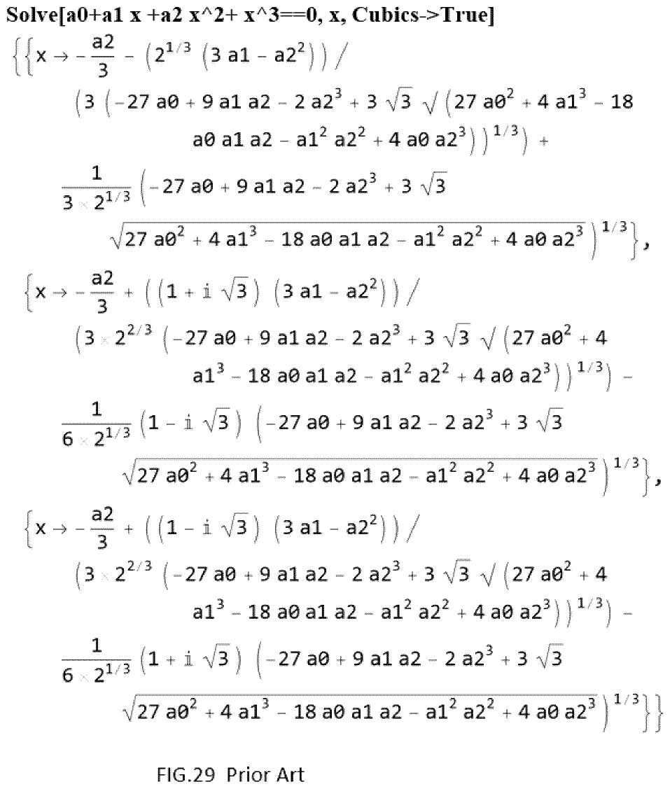

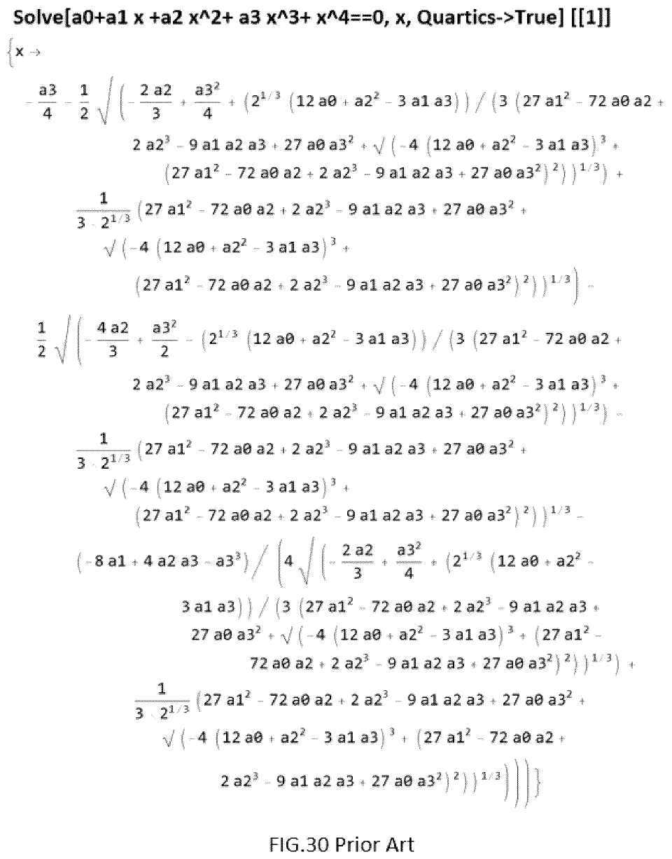

Example of Correct Formula: Theoretically correct non-augmented formulas exist. For example, Wolfram Research's Mathematica program can symbolically or numerically solve these formulas, although divide-by-zero still is a problem: See FIG. 29 for the cubic solution, and FIG. 30 for one of the four quartic roots. To deal with arbitrarily high cancellation errors, the program iterates through higher and higher precision. Such implementations typically require some form of interval processing to detect the achievement of satisfactory precision.

### Advantages

Real-Time Processing: Finally, after hundreds of years, the historical formulas, with new alternative code paths, are useful for all applications, including real-time processing. This new method provides detailed guidance which turns the historic treasure map of formulas, mentioned above, into step-by-step procedures for guaranteeing success in precisely solving cubic and quartic polynomials.

Correctness: Mathematicians have analyzed the historical root-finding formulas and found them perfectly correct for all real and complex polynomials. Therefore, when all significant numeric errors are eliminated, only a small amount of precision is lost from floating point operations. Although the new alternative code paths increase the complexity of the overall solution, each alternative code path stands on its own, and can be understood separately from other changes. There are no mysterious complications arising from changes in one code path affecting other alternative code paths.

Key Coefficient Evaluations: The descriptions of equation solvers often assume that polynomial coefficients are exact floating-point values. However, in real life applications, each coefficient can be an arbitrarily complicated expression representing an exact value. For example, even a simple intersection of two lines found by equating two linear polynomials: a1*x+b1==a2*x+b2, utilizes coefficients requiring expressions, as in: (a1−a2)*x+(b1−b2)==0, or x+(b1−b2)/(a1−a2)==0. Thus, polynomial coefficients, and a few other key values derived from coefficients, must be computed to a final and precise floating-point precision; this may require, in some cases, unlimited precision requirements. However, if all expressions defining coefficients consist of adds, subtracts, multiplies and divides of exact floating-point numbers, then guaranteed fast methods exist for computing the key values using only high precision (see earlier definition) multiplies and adds, followed by only one divide, where the divide only requires simple floating-point divide; this is done by converting partial fractions into a single rational polynomial. If the myriad of add and multiply operands are exact floating-point operations, then expanding the terms allows each sub-term to be evaluated with high-precision techniques, but not requiring arbitrarily precision.

Precise Root Pair Sums and Differences: Computations of all root results and root-pair sums and root-pair differences, are precise for all cubic and quartic polynomials.

No Interval Processing: Achieving precise results does not require performance-killing methods, such as interval processing. In traditional processing of historical formulas, some form of interval processing is often used to determine if sufficient precision of the results is achieved; if not, then the evaluation precision is raised and the whole process is repeated; this iterative process can be unbearably slow. Here, for this new approach, the precise results are guaranteed in one simple pass, all without resorting to such methods. Simple arithmetic comparison tests are included that allow the correct code path to be chosen with guaranteed precise results without recourse to any type of interval processing.

Univariate Forms: A key part of the historical cubic-equation solutions uses two variables, derived from coefficients, in the initial expression evaluations. This presents no problems in this method. However, in the critical parts of the solution, these 2-variable expressions can, if desired, be converted to univariate expressions. The univariate form is useful because the visual graphing of relative precision, for any complex value of the single input variable, can be easily visualized when the input consists of a single complex value. Although univariate cubic processing is described, it is certainly not required!

Delta Processing: Suppose we have a root, “RootA”, as a solution of a polynomial, p[x], and need to compute RootA+delta, where delta is an exact number almost the same as RootA. This may cause massive cancellation. Even though the problem is external to solving the polynomial, we can adjust the value of RootA to be (RootA+delta); this “delta processing” is a key part of solving the quartic polynomials. In this invention, after finding RootA, the value of (RootA+delta) requires much less calculation than the original RootA calculation. Indeed the “delta specification” can also include a multiply by complex value, as in (RootA*DeltaMultiply+delta).

Parallelism: augmented formulaic processing of a polynomial allows for efficient SIMD parallelism, which is so critical to many applications, such as computer graphics. A few key values require arbitrary precision, or simply high precision, for evaluation, which for arbitrary input, can hurt parallelism. However, standardized inputs, such as calculating the intersection of two quartics, can have standardized parallel processing across all SIMD threads. Parallelism usually doesn't like code branches, because some SIMD threads will take one path and other threads another; herein, this is mitigated because the two branching code paths quickly return to a common path. Thus, parallel-processing applications, such as in computer graphics, can achieve exceptional performance.

### Some Numeric Cancellation Rules

Introduction: Here are a collection of some rules which are used herein for evaluating cancellation, most of which are self-evident. Other rules are found as part of the description.

CR1: Add and Subtract Zero Cancellation Rule: With precise complex input values A and B, where at least A or B is an exact zero, there is no cancellation when computing A+B or A−B.

CR2: Add and Subtract Magnitude Cancellation Rule: With complex values A and B, the evaluation result, A+B or A−B, the result with the larger magnitude, absolute value, has no significant cancellation. The magnitude test is fast.

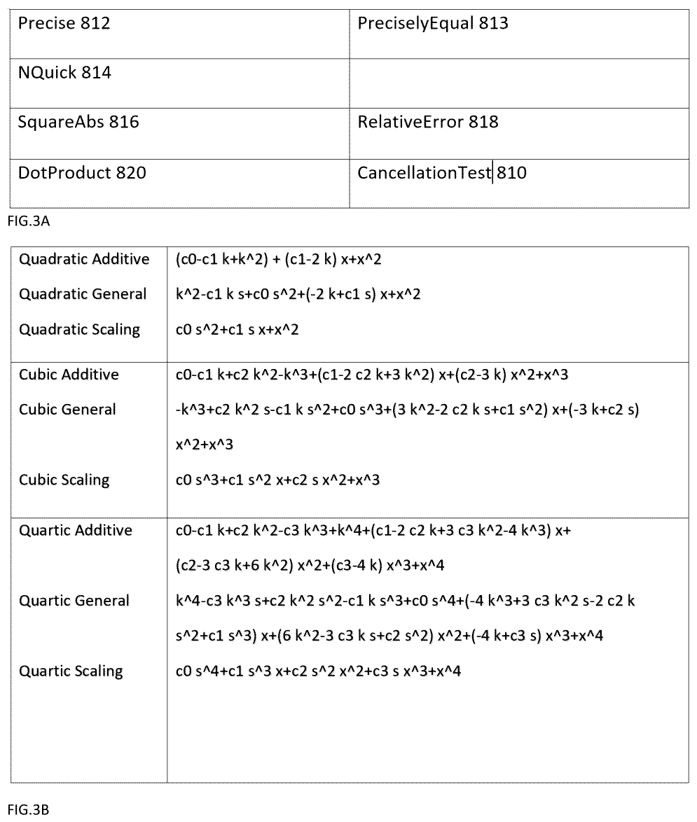

CR3: Quadratic Primary Cancellation Rule: All quadratic equations, a0+a1*x+a2*x\hat{ }2, can be converted, without changing the roots, to c0+c1*x+x\hat{ }2, where c0=a0/a2 and c1 is a1/a2. The primary (first) root solution, requires both Precise(812)[−c1], called RootSum, and Precise(812)[Sqrt[c1\hat{ }2−4*c0)]], called the quadratic RootDifference. Precise(812) evaluates an exact expression to a precise result, and is described later within FIG. 3A. The first root, or “primary” root, is given by (RootSum+RootDifference)/2 or (RootSum-RootDifference)/2; then, using the CR2 rule above, Add and Subtract Magnitude Cancellation Rule, take the result of largest magnitude, to obtain a full precision result of the one primary root. But, what if c1 or c0 are non-zero and only precise, then evaluation of the RootDifference, itself, can suffer from unavoidable massive cancellation. What is the worst-case cancellation if the c1 or c0 are only precise to floating point precision? Suppose the “+RootDifference” is chosen, then this solution is (−c1+Sqrt[1−4*c0])/2. Consider the similar and equivalent cancellation of (−c1)*(1+Sqrt[1−4*c0])/c1. Only the 1+Sqrt[1−4*c0] can suffer cancellation, so consider it. This has massive cancellation when 4*c0 is approximately 1. If the floating-point precision is six decimal digits, then Sqrt[1−4*c0] will be .000000x, where x and all additional digits are unknown. Now, Sqrt[.000000x] is .000x, and, after adding 1, the result is 1.000x, or about 3 decimal digits. Thus, the number of digits of precision is halved, for worst case.

### CR4: [Removed.]

CR5: Reverse Cancellation Rule: This CR5 rule, Reverse Cancellation Rule, is unusual because it finds an already known value. Suppose C is set to A+B, where A and B are precise, but significant cancellation occurs for A+B. Now suppose we do manage to precisely find C, but have misplaced the precise value of A. In this case, the value of A can always be precisely found by subtracting B from C, deriving from the significant cancellation of A+B, using above CR2.

CR6: Predominate Precise Summation Rule: Consider a summation of precise terms. If one term's absolute value is much larger than the sum of the other absolute values, then no significant cancellation can take place. If, say, the larger term is 6 and the other terms are −2 and −1, then the loss is less than a decimal digit. Let u represent unknown decimal digits of a 7 decimal digit precision number, then 6.000000u-2.000000u-1.000000u=3.00000u, for any u.

CR7: Quadratic Delta Double Precision Rule: This CR7 rule, namely Quadratic Delta Accuracy Rule, is derived directly from the CR3: Quadratic Primary Half Precision Rule. Suppose the quadratic's root difference is specified as Sqrt[u+delta], where u is considered exact, and delta is some constant expression. In effect, the u+delta value represents c1\hat{ }2−4*c0 discussed in CR3: Quadratic Primary Cancellation Rule, where, even with complete massive cancellation, only half of the precision is lost. Therefore, if delta is computed to twice the normal precision, then the full root value retains full normal precision. Although this rule is later referenced, there are ways to eliminate its necessity.

### DESCRIPTION OF THE INVENTION

Before detailing the cubic and quartic solutions, considerable background material is provided.

### FIG. 1A Polynomial Types (Prior Art)

Types: FIG. 1A Polynomial Types (Prior Art), shows the types of polynomials processed in this invention. Column 1 names the type of polynomial. Column 2 provides the polynomial format. The c0 to c3 values are the coefficients, where the digit of the coefficient name is the exponent of the unknown. Each coefficient represents an exact value or an expression representing an exact value. The coefficient of the highest power is always 1; this can always be achieved by dividing the highest order coefficient into all coefficients without affecting the polynomial's roots. Column 3 shows the negated sum of the polynomial's final roots. Columns 4 and 5 provide the definitions for offsets. To convert any final polynomial root to an intrinsic root, add the ToIntrinsic Offset, which is the negated sum of the roots divided by the degree of the polynomial. To convert an intrinsic polynomial root to a final root, add the CubicFinal Offset, which is the sum of the roots divided by the degree of the polynomial. Intrinsic roots are fundamental to solving cubic and quartic posynomials. Note, this use of “Intrinsic Root” is specific to this document. And, Column 6 shows the number of possible, unique, root-pairs, taking two roots at a time. For example, for cubic polynomials, for roots {A,B,C}, the three pairs are {{A,B}, {A,C}, {B,C}}.

### Generic Split Process (010) of FIG. 1B

FIG. 1B, Introduction: The Generic Split Process (010) of FIG. 1B Generic Split Process shows two major sub-components, Intrinsic Calculator (020) and Final Calculator(050), which together, find the intrinsic and final roots; each of these components, in turn, also have two sub-components for setup and evaluation. This process is applicable to understanding both quadratic and cubic solutions.

FIG. 1B, Intrinsic Calculator (020): The Intrinsic Calculator (020), of FIG. 1B Generic Split Process, finds the precise Intrinsic roots , root-pair sums (of Intrinsic roots), and root-pair differences for passing to the Final Calculator(050). The Intrinsic Setup (030) performs arbitrary or high precision arithmetic to evaluate key intrinsic values to floating point precision, from the coefficients of the polynomial. The Intrinsic Evaluator (040) only requires floating point arithmetic to find the Intrinsics: intrinsic roots, sums of intrinsic roots, and root-pair differences, with guaranteed results almost of full floating-point precision. All root-pair sums and differences are correctly associated to a pair of intrinsic roots.

FIG. 1B, Final Calculator (050): The Final Calculator (050), of FIG. 1B Generic Split Process, also is a two-step process. It finds the precise final roots by adding the CubicFinal Offset to each intrinsic root, and it does this, all without cancellation, which is often a difficult process. The root-pair differences, found earlier within the Intrinsic Calculator (020), are, of course, unchanged but are correctly associated with each pair of two roots. The Final Setup (060) performs some arbitrary precision arithmetic to find precise coefficient values as floating-point values, and the Final Evaluator (070) computes the final roots and root-pair sums from the floating-point values.

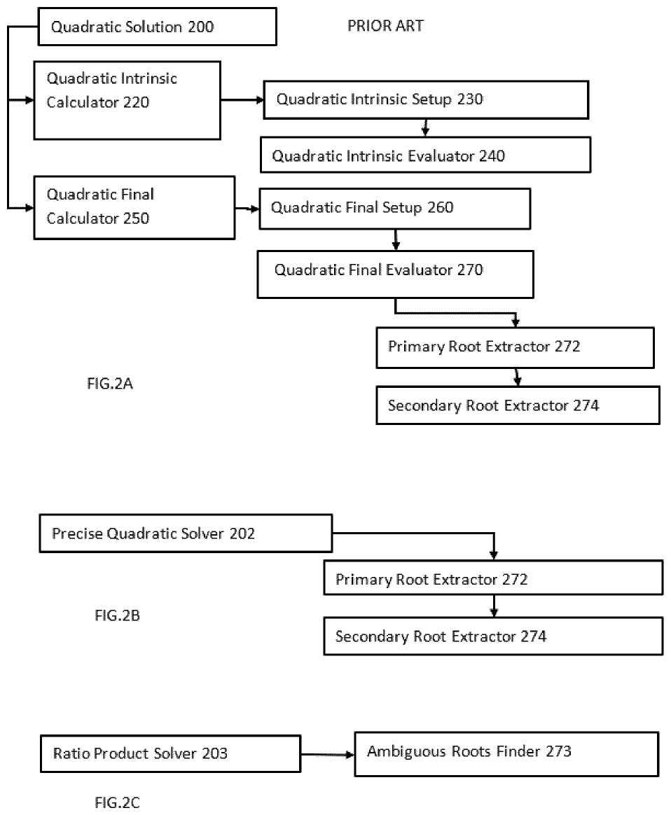

### Quadratic Solving: FIG. 2A, FIG. 2B, FIG. 2C

FIG. 2A, FIG. 2B, FIG. 2C: FIG. 2A Quadratic Solution (Derived from Prior Art): FIG. 2A shows precise quadratic equation solving but viewed from the innovative aspect of FIG. 1B Generic Split Process. Thus, although the component breakdown is new, its actual computation steps are essentially the same as the prior art.

FIG. 2A, Quadratic Solution (200): This Quadratic Solution (200) of FIG. 2A Quadratic Solution (Prior Art), encapsulates the solution. As with FIG. 1B Generic Split Process, two main sub-components are utilized: the Quadratic Intrinsic Calculator (220) and the Quadratic Final Calculator (250). Several prefixes help describe the different types of variables; these prefixes are only used for the quadratic solution to help in understanding: “p” for precise float, “i” for Intrinsic, “f” for final.

FIG. 2A, Quadratic Intrinsic Calculator (220): The Quadratic Intrinsic Calculator (220), of FIG. 2A Quadratic Solution (Prior Art), corresponds directly to the Generic Intrinsic Calculator (020) of FIG. 1B Generic Split Process, and therefore includes the following two parts: Quadratic Intrinsic Setup (230) and Quadratic Intrinsic Evaluator (240).

FIG. 2A, Quadratic Intrinsic Setup (230): The Quadratic Intrinsic Setup (230), of FIG. 2A Quadratic Solution (Prior Art), sets up key precise values for the later Quadratic Intrinsic Calculator (240), which computes the intrinsic variables. The piDiscriminant requires the Precise (812) function of FIG. 3A, for expression evaluation of (c1\hat{ }2−4*c0). Then, piRootPairDifference, which is the ambiguously signed difference between the two roots, is easily computed by taking the square root of the piDiscriminant. The Precise (818) function is also used to evaluate coefficients of the quadratic.

FIG. 2A, Quadratic Intrinsic Evaluator (240): The Quadratic Intrinsic Evaluator (240), of FIG. 2A Quadratic Solution (Prior Art), computes the precise intrinsic roots, piPlusRoot and piMinusRoot, using floating point operations applied to the piDiscriminant and piRootPairDifference computed by the Quadratic Intrinsic Setup (230); see NQuick (814) of FIG. 3A. The piPlusRoot is found as piRootPairDifference/2, and piMinusRoot is the same, but negated. Note that the sum of roots, piPlusRoot+piMinusRoot, is clearly zero, as required for intrinsic roots. Of course, if the discriminant nearly falls on the negative axis, then, due to branch-cut ambiguity, the piRootPairDifference is ambiguous; but it doesn't matter, because both intrinsic roots are still found, perhaps in a different order.

FIG. 2A, Quadratic Final Calculator (250), of FIG. 2A Quadratic Solution (Prior Art), corresponds to the generic Final Calculator (050) of FIG. 1B, and prepares the final root-pair sums and the final roots. The following two processes are called: Quadratic Final Setup (260) and Quadratic Final Evaluator(270).

FIG. 2A, Quadratic Final Calculator (250), of FIG. 2A Quadratic Solution (Prior Art), corresponds to the generic Final Calculator (050) of FIG. 1B, and prepares the final root-pair sums and the final roots. The following two processes are called: Quadratic Final Setup (260) and Quadratic Final Evaluator (270).

FIG. 2A, Quadratic Final Setup (260): The Quadratic Final Setup (260), of FIG. 2A Quadratic Solution (Prior Art), uses Precise (812) of FIG. 3A, described below, applied to coefficients ‘c1’ and ‘c’ of the quadratic polynomial. The product of final quadratic roots is pfRootProduct=Precise (812) [c0]. The sum, pfRootSum, of the final quadratic roots is Precise[−c1]. The pfIntrinsicOffset (see Intrinsic Offset column in FIG. 1A Polynomial Types (Prior Art)) is computed as pfRootSum/2.

FIG. 2A, Quadratic Final Evaluator (270): The Quadratic Final Evaluator (270) of FIG. 2A, finds both final and precise quadratic roots by using, as necessary, alternative code paths, to avoid cancellation. Two methods are called: First, the Primary Root Extractor (272) to obtain the first, primary, root, and then the Secondary Root Extractor (274) to obtain the second, secondary, root.

FIG. 2A, Primary Root Extractor (272): The Primary Root Extractor (272), shown in FIG. 2A, finds the primary root of the quadratic. The pfRootOffset, as shown in the diagram, is added to each of the intrinsic roots. First, pfPlusRoot=(piPlusRoot+pfIntrinsicOffset) and then pfMinusRoot=piMinusRoot-pfIntrinsicOffset. If pfIntrinsicOffset is zero, or piPlusRoot is zero, then both the results are precise, and processing is complete. If both results are equal, then both final roots are precise, and processing is complete. Otherwise, whichever result has a larger magnitude has no cancellation and becomes a precise primary root, as indicated by CR2: Add and Subtract Magnitude Cancellation Rule. If the original coefficients are exact, then the returned primary root is precise.

FIG. 2A, Secondary Root Extractor (274): Secondary Root Extractor (274), of FIG. 2A, provides the secondary root after the primary root was found by the above Primary Root Extractor (272). When the Primary Root Extractor (272) above returns only one root, then, if the pfRootProduct is available as it is when the c0 coefficient can be evaluated to a precise value, the second root is found by dividing the known root from Primary Root Extractor (272) into the pfRootProduct. This method guarantees that the product of the roots is equal to the pfRootProduct.

FIG. 2A, Directed Root-Pair Differences: when returning quadratic roots, as in R1 and R2, the calculated root-pair difference can be returned as a directed root-pair difference. For example, if the difference is specified as R1-R2, then make sure R1 minus the root-pair difference is R2!

FIG. 2B, Precise Quadratic Solver (202): FIG. 2B shows the Precise Quadratic Solver (202). When working with cubic and quartic equations, quadratic solutions are sometimes required, but sometimes the input values are only precise, and not exact. Up to three precise inputs are needed: the sum of the roots (sumN), the product of the two roots (productN), and the difference between the two roots (rootDiffN). If the unsigned difference between the roots, rootDiffN, is not available from the input, then it is computed as follows: c1N=−sumN, c0N=productN, rootDiffN=Sqrt[(c1N)\hat{ }2−4*1*c0N]. This expression can produce massive cancellation, even total cancellation, but by rule CR3: Quadratic Primary Cancellation Rule, only up to half the precision is lost on the final roots. Next the Primary Root Extractor (272) is called with the offset equal to −sumN/2, and the difference equal to rootDiffN/2. If the productN is available, then the second root is found using the Secondary Root Extractor (274) with the parameters of the first root and productN. If productN is not available, then the second root cannot be reliably and precisely found. The first root returned is assumed to be the root constructed with a negated difference; this may prove important in some applications, such as quartic solving when the directed root-pair difference (correct sign on the root-pair difference) must be correct for the two ordered returned roots. Therefore let the return of ordered roots be {r1,r2} with a returned difference of d, then r1−d equals r2. The routine should allow return of the root-pair difference, if not passed as a parameter.

FIG. 2C, Ratio Product Solver: FIG. 2C shows an alternative method to find quadratic roots, even when the inputs are only precise, and not exact. This method is useful for quartic solutions and includes two components: The Ratio Product Solver (203), and the Ambiguous Roots Finder (273).

FIG. 2C, Ratio Product Solver (203): Ratio Product Solver (203) takes three inputs: the product of the roots, the ratio of the roots, and the sum of the roots. An additional requirement is that for correct roots, when found, they can be summed together without total cancellation; that is, only about one decimal digit of precision of the sum of roots, is required. From these input requirements, two precise roots are found. The ambiguously signed roots are found by Ambiguous Roots Finder (273) [[ratio, product]; see below. But one or both signs, for the resulting two roots, may be incorrect. Now, if both roots are correct or both roots are negated, then aR1*aR2 precisely equals the product of the roots. If only one root is negated, then the product will point in the opposite direction. A simple dot product can determine the correct result: see DotProduct (820) of FIG. 3A, described below. If pointing in different directions, negate one of the roots; this means both are correct or both are negated. Regardless, at this point of processing, the aR1+aR2 is performed. This will be precisely equal to the input sum or precisely equal to the negated input sum. Again, a comparison or simple dot product test can be used to see if the aR1+aR2 points in the same direction as the input sum. If not, then negate both the aR1 and aR2 to obtain the correct and precise roots.

FIG. 2C, Ambiguous Roots Finder (273): the Ambiguous Roots Finder (273) of the Ratio Product Solver (202), takes the product and ratio of two roots and returns the two roots, but the returned roots are ambiguously signed. That is, each may need to be negated to become correct roots. The result roots, in order, are {Sqrt[product]/Sqrt[ratio], Sqrt[product]* Sqrt[ratio]}. The ordering is critical within the directed root-pair differences are returned. The first root returned is associated with the numerator of the ratio, as needed elsewhere in quartic root-pair differencing. The resulting Sqrt values are ambiguously signed: Don't worry, they are fixed by the Ratio Product Solver (203), as described above.

### Numeric Utilities FIG. 3A

FIG. 3A, Precise[expr], or Precise(812) [expr]: This utility function, Precise(812), as listed in FIG. 3A, takes an exact expression and evaluates the expression value to a specified floating point precision. Of course, arbitrary expressions may involve an arbitrary high amount of time. However, if expressions are composed of adds, multiplies and divides, of exact constants, then worst case results can be found without arbitrary precision-just high precision is required. Consider such expressions defining coefficients of a polynomial. Such coefficients can be reduced to two arbitrary precision evaluations, numerator and denominator, followed by one fast floating-point divide. For example, if the expression is (a/(b+c))+((d+e)/f), simple manipulation of these partial fractions yields (b*d+c*d+b*e+c*e+a*f) divided by (b+c)*f. The reduction of such expressions will yield numerators and denominators that consist of sums of multiplication expressions. Each of these multiplication terms can be quickly evaluated and utilized, as needed, if their result affects the final sum. This avoids a horrible situation of needing almost unlimited precision. Consider even the simple case of A+B+C, where all inputs are exact floating point and A=2\hat{ }10000, B=−(2\hat{ }10000), C=1. Normal evaluation would require 10000 binary digits of precision, but by using each term only if needed, the A+B is quickly determined to be exactly zero, and zero+C is simply C, which equals 1.

FIG. 3A, PreciselyEqual(813)[expr1,expr2, precision]: This utility function returns a Boolean; the Boolean is True if the two values are within some relative error. Equality of precise values sometimes needs careful testing. Of course, a precise zero value can only be precisely equal to another precise zero value. Therefore, a zero and non-zero are never equal. For two non-zero numbers, a specification can be used. Herein, precise values must meet the requirement of the precision parameter.

FIG. 3A, NQuick(814)[expr]: This utility function, NQuick (814), as shown in FIG. 3A, evaluates an expression using simple floating point arithmetic. Therefore, the result is not guaranteed to be precise. However, by limiting all values and operators to floating-point precision, the evaluation is very fast, particularly for implementations of hardware floating point. Note, if a square root or cube root is called, it should still return full floating-point precision, even if the square or cube root function requires some extra bits of precision during processing. In some cases, the result is always guaranteed precise. For example, for example if A and B are precise, then A*B is precise.

FIG. 3A, SquareAbs(816)[Expr]: This utility function, SquareAbs(816) listed in FIG. 3A, computes the square of the absolute value. When comparing magnitudes of complex values, the absolute value function is often used. However, instead of the absolute value, take the square of the absolute value, which eliminates the need to take a square root. For any complex value, the result is real and is the sum of squaring the real part and squaring the imaginary part. Of course, the use of SquareAbs means other values may need to be squared, but its still faster than a square root.

FIG. 3A, RelativeError (818): This utility function, RelativeError (818) of FIG. 3A, computes the relative error between and actual (true value) and expected value. If both inputs are zero, then zero error is returned; otherwise, if either, not both, is zero, then the error is infinite. Otherwise, both are non-zero, the error is Abs[actual-expected]/Abs[expected].

FIG. 3A, DotProduct (820): This utility function, DotProduct (820), computes a standard mathematical dot product given two complex values. A non-zero complex number is treated as a vector of its real and its imaginary parts. If two vectors are pointing in similar directions, then the result is positive, otherwise negative.

FIG. 3A, Cancellation Test (810): This utility function, Cancellation Test (810)of FIG. 3A, detects the amount of cancellation to determine if it is significant. This is done by comparing the magnitude of the complex floating point result against the magnitudes of both complex floating point inputs; if the magnitude of the result is much smaller, such as 1/4 the absolute value, than either of the magnitudes of both input values, then significant cancellation has occurred. Many other tests are possible, such as using interval analysis, but this simple test is fast.

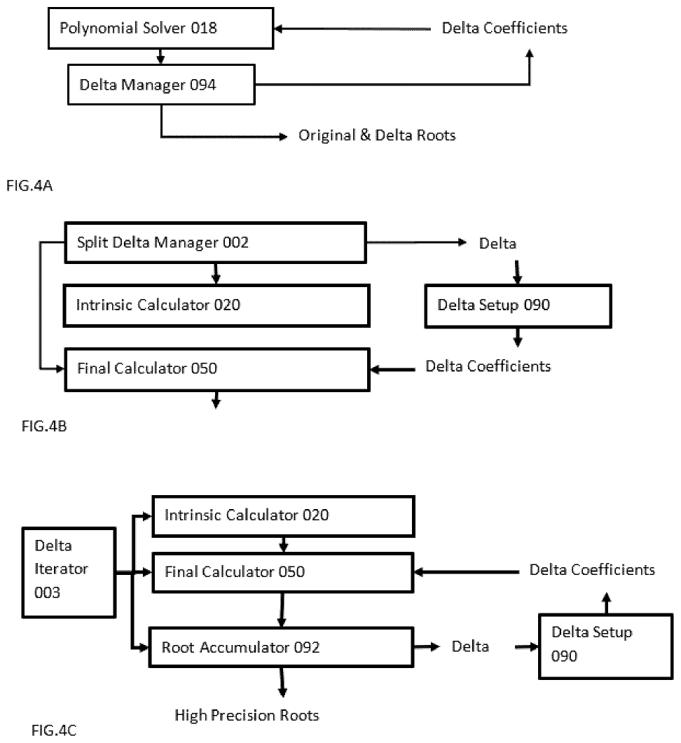

### Delta Polynomials FIG. 3B, FIG. 4A

FIG. 3B Delta Polynomials: FIG. 3B shows polynomials based on the original polynomials of FIG. 1A Polynomial Types (Prior Art), where the roots of the delta polynomials all have the same modification applied to the roots of the original polynomials. The additive deltas involve a single constant, k, which is added to all the roots of the original roots. The general delta form has roots scaled by a constant, s, and then the k-delta is added. Note that creating such polynomials is straightforward. For the curious, how were these forms generated? To create a quadratic additive delta polynomial, expand the root factor form of (x−(r1+k))*(x−(r2+k)) into k\hat{ }2+k*r1+k*r2+r1*r2+(−2*k−r1−r2)x+x\hat{ }2. Then for such coefficients of quadratic c0+c1*x+x\hat{ }2, apply simple replacement rules: r1+r2−>−c1, k*r1+k*r2−>−c1*k,−r1−r2−>c1, and r1*r2−>c0, and the result is as shown in the topmost formula. If all the roots of a polynomial are scaled by say ‘s’, then the resulting scaling polynomials are shown in FIG. 3B Delta Polynomials. But scaling the roots and root-pair differences doesn't require any polynomial processing: simply multiply the roots and root pair differences by ‘s’; no cancellation occurs. Note that ‘s’ can be complex, which results in rotation and magnitude scaling.

FIG. 3B Delta Polynomials, Goals: the goal of delta processing is to compute precise roots of the delta polynomial, given only the original polynomial and its roots. Of course, given the original polynomial's root-pair differences and root-pair sum, the same can be found for the delta roots. Most importantly, the amount of processing is far less than calculating the results for the original polynomial. For most applications, such as solving cubic polynomials, each of the resulting delta roots must be matched, that is, associated, with the original root which is transformed by the delta process.

FIG. 4A, Standard Delta Process, Introduction: FIG. 4A shows a method of delta processing which almost works with traditional polynomial processing methods, but fails on many accounts. The purpose of the description is to only show the difficulties of this straightforward process; this process is not suitable for robust processing. Note that it fails to properly associate the original roots to corresponding resulting delta roots, even for additive delta processing, and each delta process requires another complete polynomial solution.

FIG. 4A, Polynomial Solver (018): any process to find the roots of a polynomial.

FIG. 4A, Delta Manager (094): this component controls the processing and accumulates the roots of the original polynomial and the delta roots. First the Polynomial Solver (018) is called to find the original roots. Then a delta polynomial is constructed by substitution of coefficients as proscribed by FIG. 3B. Then the Polynomial Solver (018) is called to return results for the delta polynomial. In general, this results in returning both the original roots and the delta roots. But associating an original root with to the correct delta root is hard. Why? Consider a simple quadratic polynomial with roots q1 and q2, and suppose the delta solution for adding ‘v’ to the roots, produces qa and qb. The problem is easy when say q1 and q2 are very different, such as 1 and 2. But what if q1 and q2 are almost equal to 1 (not quite), and the delta is −1? Both resulting delta roots are extremely tiny, and when small enough, are indistinguishable due to minor numeric errors. Because correctly associating the original roots to the delta roots is so important, this method is inferior to other methods discussed.

### Split Delta Process FIG. 4B

FIG. 4B, Split Delta Process: this shows the Generic Split Delta Process (002), which is used to quickly find roots of a polynomial and any of its possible delta polynomials, and then associates the roots of the delta polynomial to the original polynomial's roots, all while avoiding the effects of numeric cancellation. The diagram is like the Generic Split Process (010) of FIG. 1B, with the addition of the Delta Setup (090). See the FIG. 1B description for Intrinsic Calculator (020) and Final Calculator (050).

FIG. 4B Split Delta Process, Split Delta Manager (002): In FIG. 4B, the Split Delta Manager (002) calls upon the previously described Intrinsic Calculator (020) to find the Intrinsics of the original polynomial, including the intrinsic roots (where roots always sum to zero) and usually the root-pair differences and intrinsic root-pair sums. With the Intrinsics, and after the Delta Setup (090) is called, the Final Calculator (050) solves any delta polynomial or the original polynomial. Note that the Intrinsic Calculator (020) is called only once, no matter how many delta polynomials are processed.

FIG. 4B Split Delta Process, Delta Setup (090): The Delta Setup (090) creates the delta polynomial coefficients per FIG. 3B. But the Delta Polynomial has the same intrinsic roots and root-pair differences as the original polynomial; so all that arbitrary precision calculations and floating point processing of the Intrinsic Calculator (020) do not need to be reevaluated for the delta polynomial, only the Final Calculator (050) needs to be reevaluated. Now if the delta specification includes scaling by ‘s’ (see FIG. 3B), then before other operations, all Intrinsic data (roots, root-pair sum and differences) of the original polynomial must all be scaled by s. Re-evaluation of the delta polynomial requires arbitrary precision only to re-calculate the coefficients of the delta polynomial.

FIG. 4B Split Delta Process, Delta Setup (090), Delta Specification: Consider a delta specification, for (s*u+k), where u is the final root of the polynomial, s is the delta scaling by a complex value, and k is a complex delta value. Adjust the coefficients of the original polynomial as per FIG. 3B and the roots of the new polynomial are scaled by s and then with an additional addition of k. Often, intrinsic roots and root-pair sums and differences will also be needed: Simply multiply the root-pair difference by “s”, without adding “k”; for roots and root-pair sums, scaling followed by addition is required. Also, as an alternative to s*u+k, s*(k/s+u) can be implemented by using k/s as the delta, and then multiplying the final roots and differences by the value s; therefore, the additive delta can replace the general delta. Additive and general deltas are very much the same.

FIG. 4B Quadratic Split Delta Processing: Consider the trivial implementation of delta processing for a quadratic equation as a prelude to the cubic delta iteration. Recall the FIG. 2A description and components of quadratic polynomial solving. That is, for the Intrinsic Calculator (020), the root sum, root product and root-pair difference are calculated within the Quadratic Intrinsic Calculator (220). The root-sum is found by evaluating (−c1) of the quadratic form in FIG. 1A using Precise (812) of FIG. 3A. Similarly, the root-pair product is similarly found by evaluating c0 of the quadratic form.

FIG. 4B Quadratic Split Delta Processing, continued: Delta Setup (090) of FIG. 4B Split Delta Process, calculates the delta polynomial coefficient formulas per FIG. 3B Delta Polynomials for the quadratic polynomial. Given that the root-pair difference for the original polynomial is identical to the delta polynomial, all the necessary intrinsic data is available. The Final Calculator (050) is implemented simply: the delta coefficients of the newly created delta polynomial are evaluated to precise floating-point and are trivially converted to the delta root sum and delta root product and the floating-point implementation of the Precise Quadratic Solver (202), as described in FIG. 2B, produces the final delta roots. Note that the association to the original quadratic roots is instant: the root which was found by adding the root-pair difference for the original root is associated with the delta root which also was found by an addition. Likewise, for subtracting the difference. Of course, the two processes may involve different code paths: e.g. for the original roots, perhaps the first root found by the Primary Root Extractor (272) requires addition and for the delta root, the primary root is found by subtraction. In such a case, the original primary root is associated to the secondary root of the delta polynomial. Note, that if the delta specification is the general delta form and includes ‘s’, then the Intrinsics are all multiplied by the complex value ‘s’, which scales and rotates all Intrinsics.

Compare the results for FIG. 4A Standard Delta Process and FIG. 4B Split Delta Process. p Clearly, the Split Delta Manager produces faster results by eliminating multiple calls to the Intrinsic Calculator (020). And, as will be seen later, split delta processing, associating original polynomial roots and the delta roots is instant, is straightforward not only for the quadratic polynomials but also cubic polynomials.

FIG. 4C Delta Iteration: Formulaic solutions can be used to iterate root values to any precision. FIG. 4C Delta Iteration shows a process for achieving results for roots of arbitrarily high precision. Just as with the Delta Roots, the Intrinsic Calculator (020) need only be called once; each repeat of the Final Calculator (050) increases precision by nearly the underlying floating-point precision. However, there is a catch. Because the delta applies to all roots, and typically only one root is iterated at a time, the process described usually needs to be repeated for each root. First process the intrinsic and final values for the original polynomial. Save the Intrinsics, as they will be needed again and again. For each final root needing more precision, set its arbitrary precision accumulator to that original final root. Note that any final root which is exactly zero, is already completed and has infinite precision and no additional processing is appropriate.

FIG. 4C Delta Iteration. iteration: Now iterate as needed. Pick any final root accumulator needing more precision, set its accumulator to infinite precision, and set the delta to that value, negated, and remember which intrinsic root is being iterated. Compute the new final roots using the Final Calculator (050). Now, with the Root Accumulator (092), for the iterating accumulator (at infinite precision), if the new root is zero, then the iterating accumulator is correct already! Otherwise, add the new final root to its associated accumulator. After addition, only the last several decimal digits are in doubt. The selected root's accumulated value will increase precision by almost the floating-point precision for each iteration. If sufficient precision is achieved, then terminate. A nice peculiarity of this method is that even though each successive infinite precision delta has several lowest-order digits in doubt, the next iteration overwrites the incorrect delta digits and extends the precision. Note that if two or more roots initial accumulators that are almost equal, then they can be simultaneously improved. This is easy to detect. Add the finite precision of each delta root result to the associated infinite precision accumulator: If this adds additional known non-zero bits to the associated accumulator, then the resulting accumulator is superior. However, in most cases, the finite precision delta root will cause loss of precision to the accumulator. Most applications will not benefit from trying to improve multiple roots with the same delta iteration.

FIG. 4C Delta Iteration, Root Accumulator (092): See above description for actions of Root Accumulator (092)

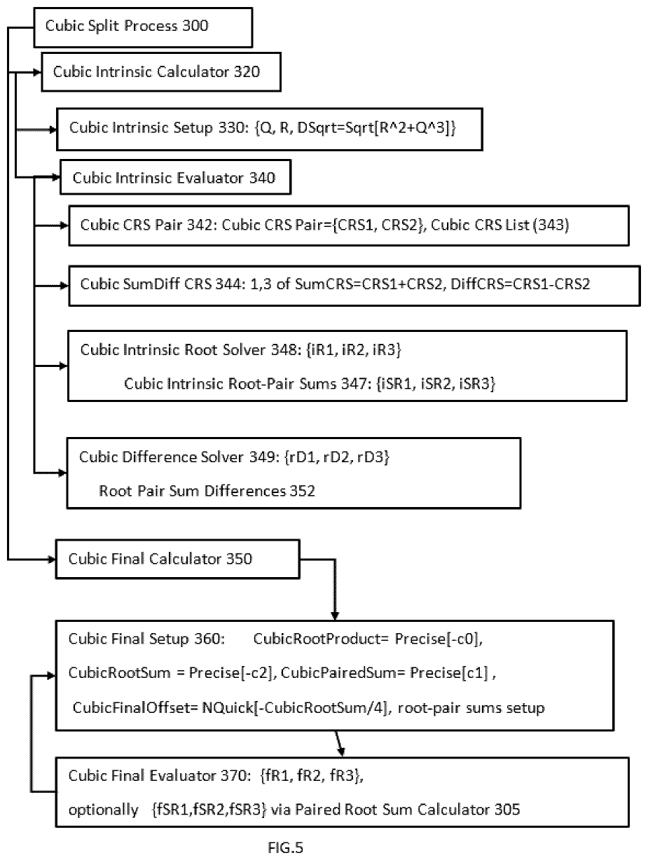

### Cubic Split Process, FIG. 5

FIG. 5: The Cubic Split Process (300) of FIG. 5 shows components for augmented cubic formulaic equation solving. This diagram corresponds to a cubic implementation of FIG. 1B Generic Split Process. In the Cubic Split Process (300), the historical formulas are modified with additional code paths and code branching to avoid numeric cancellation. As with the Generic Split Process (010) of FIG. 1B Generic Split Process, two major components are needed: the Cubic Intrinsic Calculator (320), and the Cubic Final Calculator (350). Both the indicated Intrinsics and Final Results are typically returned. Delta processing and iterative delta processing work the same as described earlier for a split process; refer to the earlier discussion.

FIG. 5, Cubic Split Process: The Cubic Intrinsic Calculator (320) computes the cubic Intrinsics, as diagrammed in the same figure, using the sub-components of Cubic Intrinsic Setup (330) and Cubic Final Calculator (350). Note that when processing the Intrinsics of a polynomial, the original polynomial or delta polynomial may be used; for example, if the delta polynomial is the cubic additive form of FIG. 3B, Delta Polynomials, then the Intrinsics are identical to the original polynomial's Intrinsics.

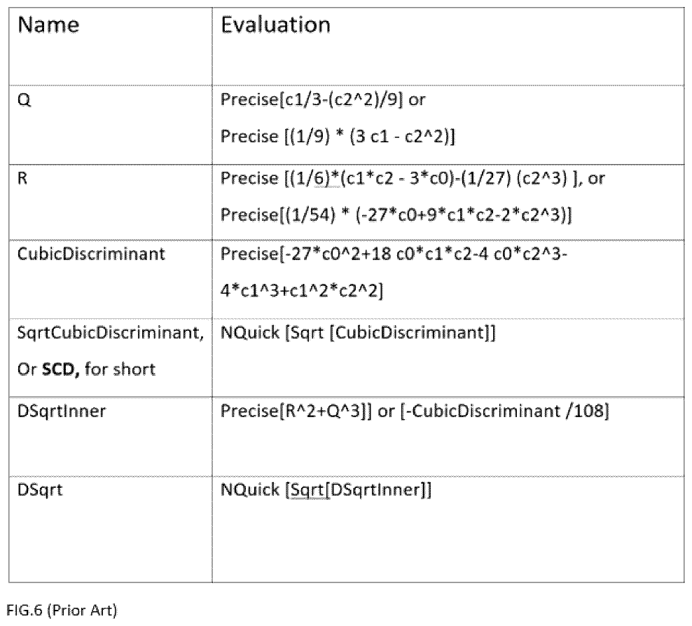

FIG. 5, Cubic Split Process, Cubic Intrinsic Setup (330): In FIG. 5, the Cubic Intrinsic Evaluator (340) finds the precise values for the traditional key intrinsic variables: {R, Q, and DSqrt}, and optionally, if desired, SqrtCubicDiscriminant. Typically, the previously described Precise (812) of FIG. 3A is utilized for evaluating exact numeric expressions. See FIG. 6, Cubic Intrinsic Setup for the evaluated formulas. As shown, these key intrinsic values are derived from the cubic polynomial's coefficients. Up to three values require arbitrary-precision evaluation. In some cases, DSqrt can be calculated directly as Sqrt[R\hat{ }2+Q\hat{ }3], when no cancellation occurs for the addition; otherwise, the formulas for R and Q are substituted within the R\hat{ }2+Q\hat{ }3 and arbitrary precision arithmetic is utilized. The use of the intermediate CubicDiscriminant in FIG. 6, Cubic Intrinsic Setup, allows for the use of the SqrtCubicDiscriminant.

FIG. 5, Cubic Split Process, Cubic Intrinsic Evaluator (340): In FIG. 5, the Cubic Intrinsic Evaluator (340) need only use floating-point precision to find the Intrinsics: intrinsic roots and root pair differences. See the previously described NQuick (824) of FIG. 3A. Inputs are the key values Q, R, DSqrt, and optionally SCD derived from FIG. 6 Cubic Intrinsic Setup (330) (Prior Art). The process is complicated by numerous potential chances for cancellation; if cancellation would occur, then an alternate process must be used, as described later. Each of the many shown subcomponents, as shown in FIG. 5 Cubic Split Process, are typically executed in order, with results used in the next step; however, the only requirement is that the inputs to each component are computed prior to usage.

FIG. 5, Cubic Split Process, Cubic CRS Pair (342): In FIG. 5, Cubic Split Process, the Cubic CRS Pair (342) computes intermediate processing values for cube root values named CRS1 and CRS2. The first method, called Cubic CRS Pair, produces the pair {CRS1, CRS2}. A second method, called Cubic CRS List, uses the Cubic CRS Pair method but computes two more pairs; thereby, producing a list of three Cubic CRS Pair; amazingly, any pair of the three pairs, can be used as the Cubic CRS Pair, but by having all three pairs, other powerful actions can be taken.

FIG. 5, Cubic CRS Pair (342): We begin with the basic method named Cubic CRS Pair which produces a single pair of {CRS1, CRS2}. Consider two values, kernel1 and kernel2. First, set kernel1=R+DSqrt, and then kernel2=R−DSqrt. For R and DSqrt; see FIG. 6 Cubic Intrinsic Setup (330)(Prior Art). If both kernels, kernel1 and kernel2, are zero, then two choices: CRS1 and CRS2 are set to zero with continuation to the next stage of processing Cubic SumDiff CRS (344), or set all intrinsic roots, sums, and differences to zero and exit the entire Cubic Intrinsic Evaluator(340). Otherwise, continue. Name the kernel with the larger absolute magnitude kernelN, where N is 1 or 2 corresponding to the N of the larger kernelN value (N equal 1 or 2). This kernel will have no cancellation, per the previously described rule CR2: Add and Subtract Magnitude Cancellation Rule. Take any one of the three complex cube roots of kernelN and call it CRSN, where N is the previously chosen, above, 1 or 2. The other CRS value is found by dividing the CRSN into −Q. For example, if kernel1 has a larger complex magnitude (i.e., absolute value) set CRS1 to any cube root of kernel1, and CRS2 is set to −Q/CRS1. This completes a method called Cubic CRS Pair. Note that only one complex cube root is required.

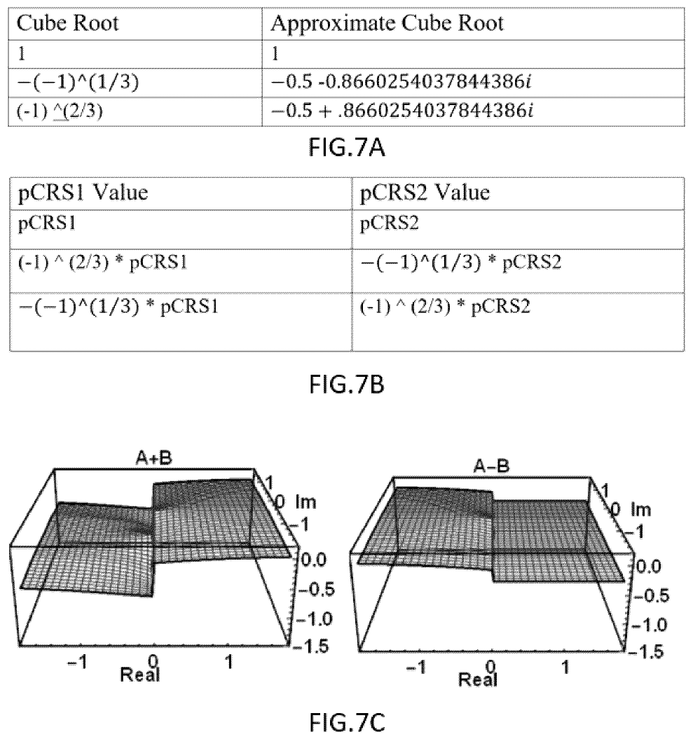

FIG. 5, Cubic CRS List (343): Now begin another method, the Cubic CRS List (343) method, which takes the result pair, {CRS1,CRS2} from the above Cubic CRS Pair method, and produces, sequentially, two more CRS pairs for a total of three pairs. See FIG. 7A Cube Roots of Unity, shows cube roots of unity, which are used to quickly find the other two CRS pairs; by using the ordering of FIG. 7B Mulitpliers for PCRS Pairs, the ordering of the computed intrinsic roots will match those prior art historical formulas.

FIG. 5, Cubic SumDiff CRS (344): the Cubic SumDiff CRS (344) finds the sum and difference of values CRS1 and CRS2. Naturally, either operation can potentially produce massive or total cancellation. If multiple pairs of CRS1 and CRS2 were produced in Cubic CRS List (343) method, then each pair is processed by this method. First set SumCRS=CRS1+CRS2 and then the difference, DiffCRS=CRS1−CRS2. If either CRS1 or CRS2 is zero, then the sum and difference have no cancellation and are used directly without further processing, per CR1: Add and Subtract Zero Cancellation Rule. Otherwise, the larger in magnitude of SumCRS and DiffCRS has no cancellation, per the previously described rule CR2: Add and Subtract Magnitude Cancellation Rule; the larger is used as is. The other value, with possible cancellation, uses an alternative code path. Now consider the alternative code path to avoid cancellation of the smaller magnitude result.

FIG. 5, Cubic SumDiff CRS (344), alternate code: Consider a simpler description which uses a different nomenclature: let's use A and B, as in A=CRS1 and B=CRS2. Then, for the alternative SumCRS, the numerator and denominator are 2*R and ((A−(−1)\hat{ }(1/3)*B)*(A+(−1)\hat{ }(2/3)*B)), respectively. The latter is equivalent to A\hat{ }2−A*B+B\hat{ }2. The funny cube roots, −(−1)\hat{ }(1/3) and (−1)\hat{ }(2/3), are cube roots of unity, and are shown in FIG. 7A Cube Roots of Unity. For the alternative code path for DiffCRS, the numerator and denominator are: 2*DSqrt and ((A+(−1) \hat{ }(1/3) *B)*(A−(−1)\hat{ }(2/3)*B)), respectively. The latter is equivalent to A\hat{ }2+A*B +B\hat{ }2. The critical issue is the use of mathematical identities to find reasonable alternative paths; both alternatives require only adds and multiplies and one division. And, so, cancellation is avoided, even as they are evaluated using all floating-point precision. For the curious, consider the derivation of the alternative formula for SumCRS. The mathematical identity is (A\hat{ }3+B\hat{ }3)=(A+B) *(A\hat{ }2−A*B+B\hat{ }2), or (A+B)=(A\hat{ }3+B\hat{ }3)/(A\hat{ }2−A*B+B\hat{ }2). The numerator, (A\hat{ }3+B\hat{ }3) equals (CRS1\hat{ }3+CRS2\hat{ }3), which equals Kernel1+Kernel2, which equals (R+DSqrt)+(R−DSqrt) which equals, simply, 2*R. For the denominator, the choice to verify and use ((A−(−1)\hat{ }(1/3)*B)*(A+(−1)\hat{ }(2/3)*B)) instead of (A\hat{ }2−A*B+B\hat{ }2) is motivated by having only two multiplies instead of three. The DiffCRS alternative is similarly derived.

FIG. 5, Cubic SumDiff CRS (344), visualization: Only for those interested in visualization of the associated amount cancellation error, FIG. 7C Decimal Digits Lost, shows the decimal digits, of relative precision, which are lost when processing A+B and A−B using the above-described methods; only about ½ decimal digit is lost. When following the above formalization, visualization of loss of decimal digits-of-precision requires another equivalent formalization of the primary and alternative formulas. All results show decimal digits lost. For example, if the graph indicates ½ digit lost, and the original precision was 16, then 15.5 digits remain. The first goal for this visualization, is to find formulas that have the same cancellation properties as the original SumCRS cancellation and its alternative formula's cancellation, but with the cancellation terms having only one complex variable that tests all possible cases. Consider the original SumDIff, A+B, rewritten as B*(C+1), where C equals A/B. Although A/B may have one additional roundoff error, (C+1), has the equivalent cancellation. For DiffCRS, we have B*(C−1). The real and imaginary axes define complex values for C, and then 1 is added. Note, for this graph if A+B doesn't cancel, then the more difficult identity action is performed. For the alternative formula, only the denominator can have cancellation and it again can be similarly rewritten. The A-B Decimal Digits Lost can be visualized in the same way.

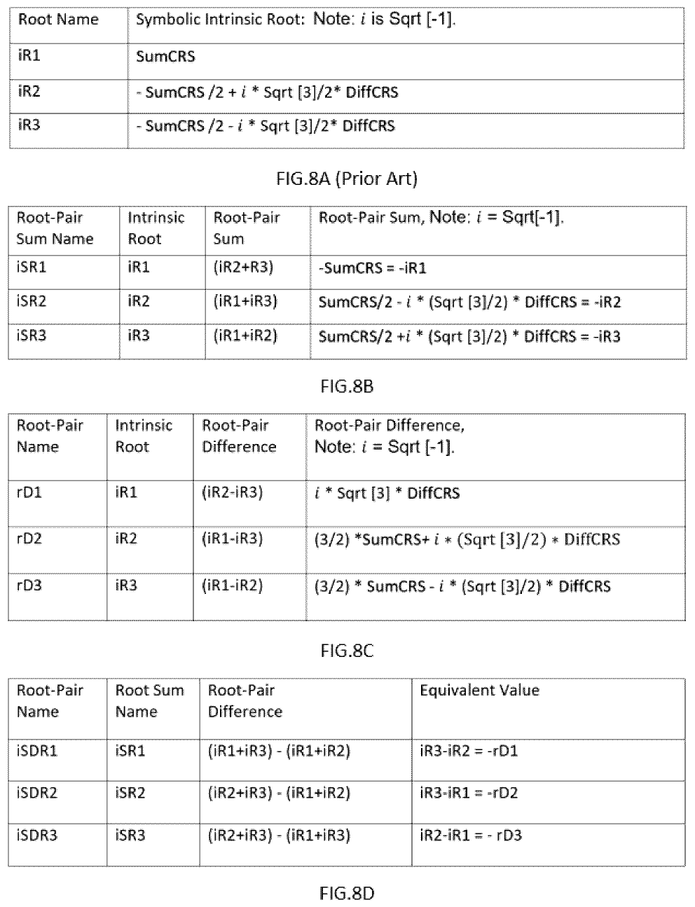

FIG. 5, Cubic Intrinsic Root Solver (348): this component finds the three intrinsic roots, {iR1, iR2, iR3}, as defined by FIG. 8A Traditional Cubic Intrinsic Roots (Prior Art). Although these parts of the formulas appear in prior art, the formula parts have been, historically, embedded as part of more complicated formulas. Three augmented methods of cancellation-free evaluation are shown.

FIG. 5, Cubic Intrinsic Root Solver (348), Cubic Intrinsic Product method: The first method is called the Cubic Intrinsic Product method. See FIG. 8A Traditional Cubic Intrinsic Roots (Prior Art). Because iR1 expression is a single term, it clearly has no cancellation, but either the iR2 or iR3 expression can suffer massive cancellation. If either SumCRS or DiffCRS is zero, then, of course, no cancellation occurs, and the roots are correct as is, as per CR1: Add and Subtract Zero Cancellation Rule. Otherwise, continue onward. Either of the evaluations, as shown, of iR2 and iR3, can suffer massive cancellation. But not both, as per CR2: Add and Subtract Magnitude Cancellation Rule. If, for the formulaic results, both iR2 and iR3 have equal magnitude, then they both are precise, and we are done; otherwise continue. But one of these two root expressions, the result with the larger magnitude, will not suffer cancellation and is non-zero; so, use it and call it the Known Intrinsic Root. Recall, at this point in processing, that SumCRS is non-zero and is equal to root iR1. But in the case where iR2 or iR3 is unknown due to cancellation, the missing root can be quickly found by taking the product of SumCRS, which equals iR1, and the just computed Known Intrinsic Root, and dividing this product into the IntrinsicRootProduct which equals ((−(27 c0−9 c1 c2+2 c2\hat{ }3)/27), or, equivalently, simply divide into (2*R), where R was already precisely computed in FIG. 6 Cubic Intrinsic Setup (330)(Prior Art). Alternatively, if two of the intrinsic roots are known, regardless of the method of solving, then this method can be applied.

FIG. 5, Cubic Intrinsic Root Solver (348), Triple Intrinsic Root CRS method: A completely different implementation for intrinsic roots is called the Triple Intrinsic Root CRS method, which requires that all three SumCRS values, one for each CRS set of pairs, which can be calculated in the Cubic Sum Diff CRS (344) component, are available. Simply take the three values of SumCRS as the three intrinsic roots and keep their sequential ordering as described, for the iR1, iR2 and iR3 roots which match the same roots calculated by the Cubic Intrinsic Product method, above.

FIG. 5, Cubic Intrinsic Root Solver (348), Hybrid Intrinsic Root CRS method: The hybrid method uses a little of both above methods. The first root is the SumCRS. Additional two roots are found by methods shown above in the Triple Intrinsic Root CRS method and Cubic Intrinsic Product method. The last intrinsic root is found by dividing the product of the two already known intrinsic roots into the product of all three roots. What is the product of all three intrinsic roots? Simply find the exact expression of the product by converting the polynomial to its intrinsic form: See the “ToIntrinsic Offset” in FIG. 1A and apply it using the additive delta process of FIG. 3B.

FIG. 5, Cubic Intrinsic Root-Pair Sums (347): The Cubic Intrinsic Root-Pair Sums(347), of FIG. 5 Cubic Split Process, finds the associated intrinsic root-pair sums, {iSR1, iSR2, iSR3}, as shown in FIG. 8B Cubic Root-Pair Sums. But wait, a quick comparison to the symbolic formulas of FIG. 8A Traditional Cubic Intrinsic Roots (Prior Art), shows that the intrinsic root-pair sums are the negation of the intrinsic roots! Wow. For example, in line two, for iSR2 associated with iR2, the value of iR1+iR3 is simply−iR2! What creates this simplicity? Simple: The intrinsic roots sum to zero. Not all applications may need root-pair sums, and these values need not be directly created, but they can be created on-the-fly, as needed, by a simple negation of the associated intrinsic root. Or, equivalently, create the Root-Pair Sums first, and derive the intrinsic roots by negation. The ordering of calculation could be reversed. Creating the intrinsic Root-Pair Sums before the Intrinsic roots is almost identical to the Cubic Intrinsic Root Solver (348) method except that the signs are negated.

In FIG. 5, Cubic Split Process, Cubic Root Difference Solver (349): The Cubic Root Difference Solver (349), of FIG. 5 Cubic Split Process, finds the three root-pair differences, {rD1, rD2, rD3}. The formulas for these are shown in In FIG. 8C Cubic Root-Pair Differences. The symbolic formulas are derived from the formulas of FIG. 8A Traditional Cubic Intrinsic Roots (Prior Art) using subtraction. But why, for example, is rD2 not named iD2, to follow the convention for intrinsic roots and intrinsic root-pair sums? Because these root-pair differences are the same for both intrinsic roots and the corresponding polynomial's final roots, called {fR1, fR2, fR3}. Although direct subtraction of the intrinsic roots will usually work to find root-pair differences, massive or total cancellation may also occur. At least three methods exist for quickly finding all precise root differences. Methods are fast and produce precise values: but as indicated below the second method, Triple Root Pair CRS method, has a correctly signed result and is therefore clearly superior.

FIG. 5, Ambiguously Signed Discriminant method for Cubic Root Difference Solver (349): The first implementation method for Cubic Root Difference Solver(349), is called Ambiguously Signed Discriminant method. FIG. 8C Cubic Root-Pair Differences, the evaluation of the formula for rD1 value clearly has no cancellation. Evaluate the formulas for rD2 and rD3. If either SumCRS is zero or DiffCRS is zero, all differences are now precise, as per CR1: Add and Subtract Zero Cancellation Rule. Otherwise, continue. As per CR2: Add and Subtract Magnitude Cancellation Rule, either rD2 or rD3, or both, are precise because the same value was added and subtracted to a common base value, (3/2)*SumCRS. Of rD2 and rD3, the one with a larger magnitude is precise, and call it Known Difference. Recall, at this point in processing, that DiffCRS, and therefore RD1 itself, is non-zero. Now, the unknown difference, which may have cancellation, is alternatively found by dividing the product of rD1 times Known Difference into SqrtCubicDiscriminant, which was defined in FIG. 6 Cubic Intrinsic Setup (330) (Prior Art). Of course, every square root has two possibilities; one is the negation of the other. This means that the sign in front of this last found difference is ambiguous. For example, for rD2, (iR3−iR1) might be the result instead of (iR1−iR3). Although this may be adequate for some applications, the next method quickly computes all results with the correct sign.

FIG. 5, Triple Root Pair CRS method for Cubic Root Difference Solver (349): The second implementation method for Cubic Root Difference Solver(349), a completely different method for Cubic Root Difference Solver(349), is called the Triple Root Pair CRS method and it returns the correctly signed differences, per FIG. 8C Cubic Root-Pair Differences. First calculate all CRS pairs using the Cubic CRS List (343) of FIG. 5. Now, for each pair of {CRS1, CRS2} calculate the sum and difference with the Cubic SumDiff CRS (344). Simply take the three values as the three DiffCRS values and multiply by “i*Sqrt[3]”, where ‘i’ is the imaginary axis representing the Sqrt[−1]; but the middle difference, rD2, must be negated to obtain the correct sign! Why? the multiply by “i*Sqrt[3]” assumes the root is the first (or third) of three roots. This method works for rD1 and rD3 because their results are identical whether they are the first root. However, rD2, if the first root, is equal to rD3−rD1, and that is incorrect as seen in FIG. 8B Cubic Root-Pair Differences. In any case, after the multiply of all three, and then negating the rD2 result, all three differences are precisely correct.

FIG. 5, The Hybrid Difference Solver method for the Cubic Root Difference Solver (349): The hybrid method uses a little of both above methods. The first root is i*Sqrt[3]* DiffCRS. One of the two remaining roots, the second known difference, is found as described in the Triple Root Pair CRS method, which was just described. Take the product of the two known roots and divide it into SqrtCubicDiscriminant, which was defined in FIG. 6 Cubic Intrinsic Setup (330) (Prior Art). Of course, the sign of the result is ambiguous.

In FIG. 5 Root Pair Sum Differences (352): FIG. 8D shows how to trivially calculate the difference between the sums of intrinsic root pairs. This relationship means that finding the intrinsic root-pair differences of the paired sum of roots, {fSR1, fSR2, fSR3}, requires only the negation of the appropriate intrinsic root of the original polynomial with roots of {iR1, iR2, iR3}.

FIG. 5 the Cubic Final Calculator (350): using the Intrinsics and coefficients of the original polynomial (or delta polynomial) this component finds the precise final cubic roots, {fR1, fR2, fR3} and associates each of these roots with the correct table row of all figures between FIG. 8A Traditional Cubic Intrinsic Roots (Prior Art) through FIG. 8C. The Cubic Final Setup (360) and Cubic Final Evaluator(370), both in FIG. 5, are subsequently called.

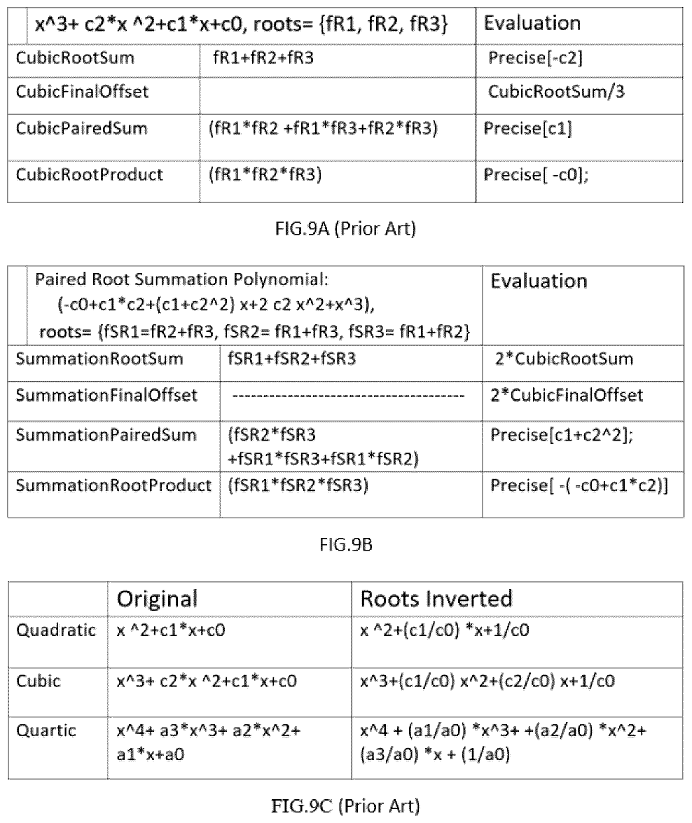

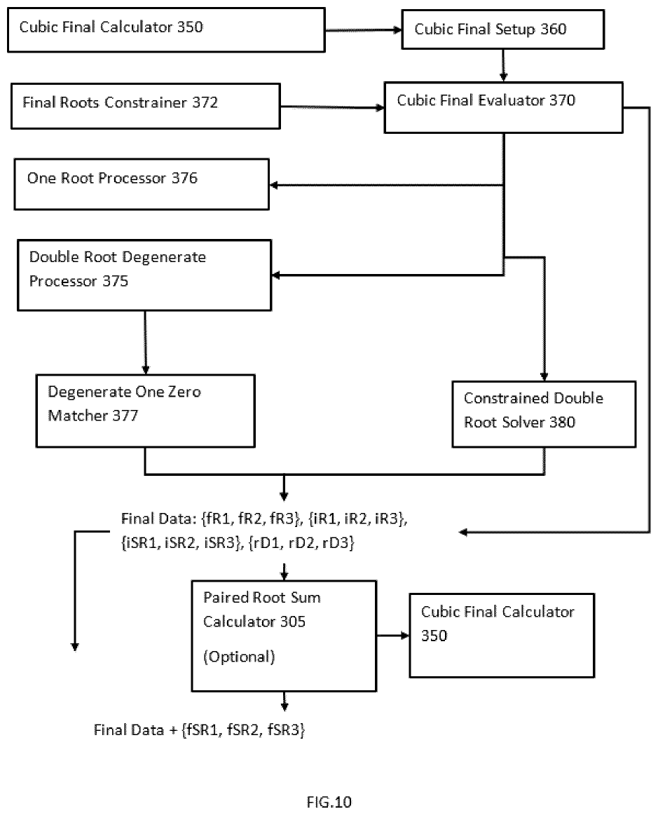

FIG. 5, FIG. 10, Cubic Final Setup (360): this component precisely determines the coefficients of the polynomial from the exact expressions representing the coefficients. See FIG. 9A Cubic Polynomial Identities (Prior Art) which shows the meaning of CubicRootSum, CubicFinal Offset, CubicPairedSum, and CubicRootProduct. With these values, together with the intrinsic roots and root-pair differences, the final roots can be precisely calculated with Cubic Final Evaluator (370), described below. Also, optionally, consider finding the sum of all unique pairs of final roots of the SummationRootProduct, which equals Precise[−(−c0+c1*c2)], as shown in FIG. 9B Paired Root Summation Identities; its application is described later to provide quick methods for finding cubic root-pair sums.

FIG. 9C: Root Inversion (PRIOR ART): This easy-to-understand figure shows how to find coefficients of a polynomial (quadratic, cubic, or quartic) whose roots are the inverse of the original polynomial. Root inversion is a powerful method which is useful for cubic and quartic processing.

FIG. 5, Cubic Final Calculator (350): this component is the last step in the cubic solution. In FIG. 10, at the top of the diagram, the Cubic Final Setup (360) first evaluates simple expressions of the coefficients of the cubic polynomial; see FIG. 5. Next, as shown in FIG. 10, the Cubic Final Evaluator (370) finds the precise three final cubic roots, {fR1, fR2, fR3} and associates these values to the corresponding rows of FIG. 8B Cubic Root-Pair Differences, and other FIG. 8 tables. Also, see FIG. 5, which shows its related components. Input consists of the Intrinsics calculated by the Cubic Intrinsic Setup (330) in FIG. 5. The initial output is the three final roots {fR1, fR2, fR3}, but with a little more effort, the optional calculation of paired sums of roots, {fSR1, fSR2, fSR3} are calculated as shown at the bottom of FIG. 10 Cubic Final Evaluator.

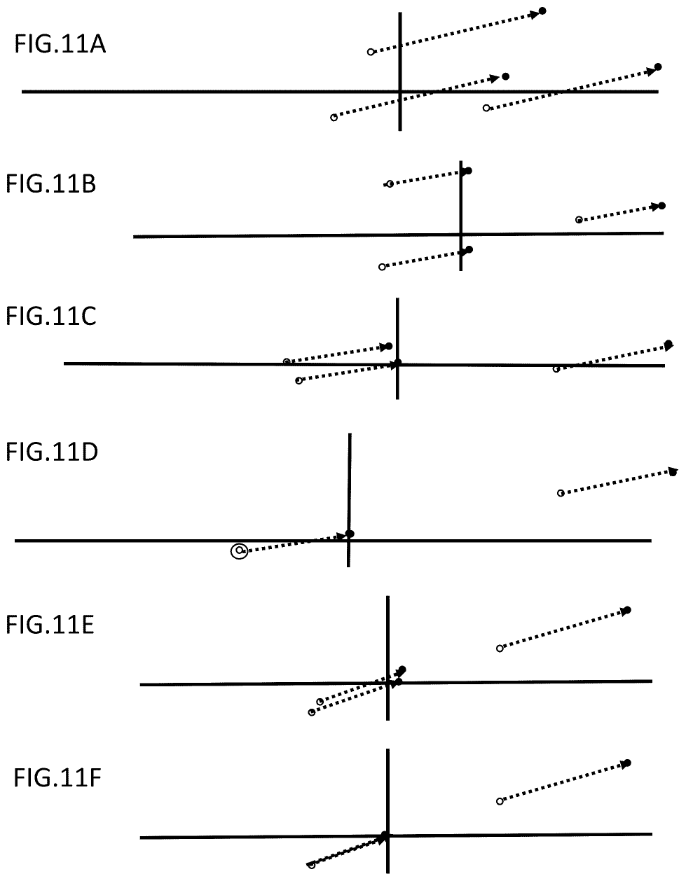

FIG. 11, FIG. 11A thru FIG. 11F, Cubic Root Topologies: these diagrams illustrate the possible cubic root topologies which can be encountered as the intrinsic roots are transformed into the final roots by the addition of the same constant. The common offset, shown as dotted line, translates the intrinsic roots {iR1, iR2, iR3}, shown as circles, into the final roots {fR1, fR2, fR3}, as shown by large dots, by adding the Cubic Final Offset of FIG. 9A Cubic Polynomial Identities (Prior Art), to the intrinsic roots. These six figures are further described later, along with the components to process each. Together, they indicate all possible final root processing topologies. The intrinsic roots, shown as circles, always add to zero, although the diagram is only approximate.

FIG. 10, Cubic Final Evaluator (370): The rest of the figure shows the Cubic Final Evaluator (370), which finds precise results for any cubic polynomial, including the Paired Root Summation Polynomial of FIG. 9B Paired Root Summation Identities. First the Final Roots Constrainer (372) is called three times, once for each addition of the same constant, Cubic Final Offset, to each intrinsic root. The detailed implementation of this Final Roots Constrainer (372) is described later; but briefly, the result of each call is either a precise final root value, or an indication that too much numeric cancellation occurred. If all roots are found precisely, then the final roots, {fR1, fR2, fR3}, with the correct unchanged row association to root-pairs {rD1, rD2, rD3} are returned. See FIG. 11A Three Precise Final Roots. Note, that if all the final roots are zero, as in degenerate, then all the intrinsic roots must also be zero and no cancellation occurs; therefore, the processing of all zeros is completed. Otherwise, more processing is needed. If all coefficients of the cubic are zero, then all roots, root-pair sums, root-pair differences are all zero and the routine can immediately return. Otherwise, at least one root has some cancellation. Of course, this can only happen if the added offset is non-zero. If at least one root has experienced cancellation, then all precisely known (non-cancelling) roots are non-zero! Why? To produce a non-cancelling zero is impossible if the offset is non-zero. The remaining processing assumes that the precisely known root(s) as determined by the Final Roots Constrainer (372), are non-zero. If only one root fails the constraint test, then the One Root Processor (376) is called whether the unknown root is zero or non-zero: see below. Next, if two roots failed the constraint, then if there is a zero root (as in c0==0), the Double Root Degenerate Processor (375), or, if c0!=0, then the Constrained Double Root Solver (380) is called. Additional work is required if the final root-pair sums are desired, and this is done by the Paired Root Sum Calculator (305) which may again call the Cubic Final Calculator (350). The Paired Root Sum Calculator (305) is described later.

FIG. 10 Final Roots Constrainer (372): the Final Roots Constrainer (372) is called by the Cubic Final Evaluator (370) to check for significant cancellation when adding the final offset to the intrinsic roots to produce the final roots. The floating-point input consists of: operand1, operand2, and the operationResult, where the already computed operation to produce the operationResult was addition or subtraction. Additionally, an optional predetermined constant or input parameter, called the ConstraintMultiplier value, controls the amount of numeric cancellation that is acceptable. The chosen method and ConstraintMultiplier value must be compatible with the chosen method of implementation within Constrained Double Root Solver(380), described below. Here is one simple test method called the Constrained Magnitude method, but anything similar will work.

FIG. 10 Final Roots Constrainer (372), Constrained Magnitude: To pass the test, the absolute value of the operationResult must be least equal to the ConstraintMultiplier times the maximum of the absolute values of both the operand1 and operand2. A ConstraintMultiplier of 0.25, or equivalently, ¼, is adequate for the ConstraintMultiplier value, and larger values, say up to ⅓, should also be okay. For example, adding 5 to −3 produces 2, which has an absolute value more than ¼ of the absolute value maximum input operand, which is 5; therefore, it passes the test. Since we are using complex numbers, where an absolute value requires a square root, a faster test is taking the square of the absolute value, which eliminates the square root in the absolute value function, and compare it against the square of the ConstraintMultiplier; consider the SquareAbs (816) method of FIG. 3A, previously described. Continuing the example, the largest input magnitude, squared, is 25, and the square of the result magnitude is 4. The square of the ConstraintMultiplier is 1/16. Here, as before, 4/25 is greater than 1/16, and the cancellation loss is insignificant. A ConstraintMultiplier value of 0.25 or ¼, is adequate, but slightly larger fraction may be okay, but a value of 0.25 produces only a worst-case loss of about one additional decimal digit, which should be more than tolerable when, say, working with 16 decimal digits in standard double precision floating point.

FIG. 10, One Root Processor (376): called when one root is unknown, which could be zero, or not. If c0 of the original cubic polynomial is zero (see FIG. 11C), then the last unknown root must be exactly zero; otherwise, the unknown root is found by dividing the product of the two precise and already known, and guaranteed non-zero, roots into the CubicRootProduct of FIG. 9A Cubic Polynomial Identities (Prior Art). This latter case is indicated in FIG. 11B. In either case, the association of all final roots to the intrinsic roots an intrinsic data is immediate. See FIG. 11B One Unknown Final Root.

FIG. 10, Double Root Degenerate Processor (375): this is called when two roots fail the constraint test and c0 is zero. If c1 is also zero, then the two final unknown roots are exactly zero, as diagrammed in FIG. 11F. In this case the one non-zero root is immediately associated, and the now two intrinsic roots which cause the zeroes are associated arbitrarily to either of the two final zero roots. Otherwise, there is only one final root which is zero. See FIG. 11F. In this case, we can quickly find the final root values: Let fRZero (of unknown index) be the zero final root, and the other unknown root is set to the CubicPairedSum/fRKnown and called fRNonZero. Why CubicPairedSum/fRKnown? Because the only non-zero term in CubicPairedSum is the product of fRKnown times the non-Zero unknown root. Next, if desired, the fRNonZero and fRZero can be matched to the correct root difference using the Degenerate One Zero Matcher (377), described below.

FIG. 10, c1!=0, Degenerate One Zero Matcher(377): this component, Degenerate One Zero Matcher(377), is called by the Double Root Degenerate Processor(375) when exactly one final root is zero and the two non-zero roots are known. For this, the input consists of the original fRKnown root and its index, fRKnownIndex, and the second known root, now called fRNonZero, of unknown index. And, there is also the zero root, fRZero, with its unknown index. The goal is to match fRNonZero and fRZero root to the correct indices for the intrinsic tables of FIG. 8A to FIG. 9B. Of course, matching two values to two indices can only be done in two ways. This matching is always doable whenever the root-pair differences have been computed with the correct sign, such as when using the Triple Root Pair CRS method of Cubic Difference Solver(349) of FIG. 5; if another method was used that has a ambiguously signed difference, then the correct sign is not known which, which, in rare cases, may lead to an error. First, why is there a difficulty matching? Suppose the three roots are {1, 10\hat{ }−1000, 0}; and the latter two roots suffer total cancellation. Now, consider the details for correctly associating the two.

FIG. 10 Degenerate One Zero Matcher (377), Association: The two newly found roots, one final zero root called fRZero, and the other final root a non-zero root called fRNonZero, must still be associated with the correct intrinsic roots and root-pair differences. Let fDKnown be the root-pair difference for fRKnown based on the association specified by fRKnownIndex; the fDKnown is the directed difference between the two other roots fRZero and fRNonZero. Now, fDKnown must closely match, to a small number of round-off errors, either fRNonZero or −fRNonZero, and this can be used to find which of two rows in FIG. 8B Cubic Root-Pair Differences are associated with each root. Why? Because, because fDKnown represents the difference between fRZero==0 and fRNonZero, and depending upon the order of roots, the sign can be switched.

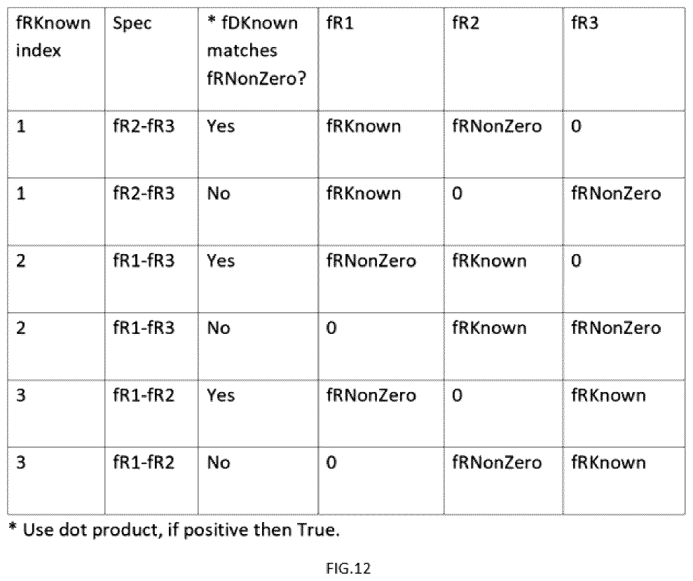

FIG. 12, FIG. 10, Degenerate One Zero Matcher (377), the FIG. 12 Degenerate Table shows the results for setting the final roots {fR1, fR2, fR3} when one of two final unknown roots is zero. This table assumes root pair differences are in the same order and meaning as described for table in FIG. 8C Cubic Root-Pair Differences. The fRKnownIndex input parameter determines the meaning of this index's root pair difference: it's the difference between the unknown zero root and fRNonZero. For example, suppose the index is 2, implying fRKnown is fR2, and the difference, fDKnown, must be (fR1−fR3). If fDKnown is approximately equal to fRNonZero, this implies fR1 matches fDKnown, and that fRNonZero is fR1 and fR3 is zero, and the indices are 1 and 3 respectively. If fDKnown is almost equal to minus fRNonZero, then the indices are reversed, as shown in the next line of the table. If vector Dot Product of fDKnown and fRNonZero is greater than zero, then it matches, where the vector for a root consists of its real and imaginary values. Another test is to subtract fRNonZero from fDKnown: If the magnitude of the result is smaller than the magnitude of the input (since both are the same magnitude, use either input), then it matches. There are probably many other comparisons of fDKnown and fRNonZero that would work, but these methods are simple. The bottom line is that the correct association is made.

FIG. 10 Degenerate One Zero Matcher (377), With no Root Pair difference: if there is no full precision difference available, use the difference which is found by subtracting the two intrinsic roots. But you will not know which root is exactly zero, so perhaps set both to numbers smaller than fRNonZero. Of course, root-pair differences are simple to calculate with formulaic solutions of root-pair differences!

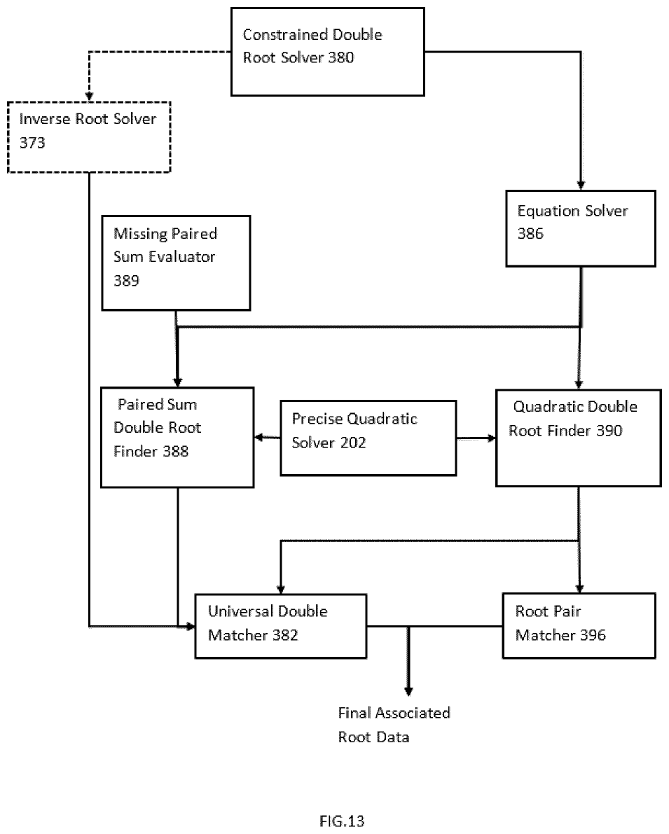

FIG. 10, FIG. 13, Constrained Double Root Solver (380): the Constrained Double Root Solver (380) was shown in FIG. 10, but FIG. 13 shows inner components. This component is called when two roots fail the constraint test and the c0 coefficient is non-zero, which indicates all roots are non-zero. Many methods exist and are described, but only one of these many methods needs to be used. The foundation of success, for all these methods, lies in setting up the Final Roots Constrainer (372), described just above, so that whenever two roots have significant cancellation, and are not degenerate, then the two final roots are close together, as shown in FIG. 11E Two Unknown Final Roots. Refer to Final Roots Constrainer (372) in FIG. 10, described above. Notice that in FIG. 11E Two Unknown Final Roots, the two of the final roots are very small compared to the non-cancelling final root. Call either the Inverse Root Solver (373) or the Equation Solver (386).

FIG. 13, Universal Double Matcher (382): The Universal Double Matcher (382) is found in FIG. 13 Constrained Double Solver, is used to associate two final non-zero precise root values, called fRKA and fRKB, to the correct indices, for its corresponding intrinsic root and root difference. This is a universal method used for the roots obtained by the Constrained Double Solver(380), but it could also replace the Degenerate One Zero Matcher(377) shown in FIG. 10 Cubic Final Evaluator. However, depending upon the implementation for the Constrained Double Solver (380), specific solutions can sometimes be a better choice than this Universal Double Matcher (382). If only the final roots are needed, then there is no need to correctly associate to the index for the roots, and this method is not needed. Briefly, this method is very similar to Degenerate One Zero Matcher (377) of FIG. 10 Cubic Final Evaluator, except that there is no zero root. But recall that the zero value was not used to form the dot product in the Degenerate One Zero Matcher (377); instead, the difference between the known root and zero was used to compare against the difference, fDKnown. Therefore, the difference between fRKA and fRKB, as in (fRKA−fRKB), is used in the dot product with fDKnown. In root values in the FIG. 12 Degenerate Table, substitute fRKA as fRNonZero and fRKB as zero. The remaining discussion of the Universal Double Matcher (382) provides some additional background and analysis.

FIG. 13, Universal Double Matcher (382), Continued: Suppose one root, fRKnown and its index, fRKnownIndex, is known. This leaves two remaining indices, xIndex and yIndex. Also, the precise values of the two remaining roots, {fRKA, fRKB}, are known. The goal is to associate {fRKA, fRKB} to the correct indices {xIndex, yIndex}. Of course, the fRKnown root is already associated via the fRKnownIndex. Remember that the imprecise results from cancellation roots, {fRA, fRB}, are being replaced by the precise {fRKA, fRKB}. First, suppose the two intrinsic roots needing association with fRKA and fRKB are iA and iB. Find their difference (iA-iB) as iAMinusiB by direct subtraction (if some precision remains after cancellation) or, even better, use the calculated directed root-pair differences which were calculated during intrinsic processing. In particular, the Cubic Intrinsic Difference Solver (349) should use the Triple Root Pair CRS method to obtain the correct sign for the difference. Similarly, we can subtract the fRKA and fRKB values, as (fRKA−fRKB), to obtain a difference. If nearly total or total cancellation occurs, the result will still be adequate because both roots can then be considered identical so the algorithm will work. Now, taking each complex value, (iA−iB) and (fRKA−fRKB), as a vector, take the dot product of the two differences. If the result is positive, then associate iA to fRKA and iB to fRKB; otherwise, the opposite. Of course, all these intrinsic roots are non-zero, or otherwise the original use of Final Roots Constrainer (372) would have produced precise results. In summary, matching two roots is dependable and simple, and many methods can be used.

FIG. 13, Inverse Root Solver (373): one method for finding two unknown non-zero roots, is the Inverse Root Solver (373), which precisely computes the missing two final roots by using the roots of a polynomial having the inverse roots of the original polynomial. In the diagram, the component uses a dotted outline because another method for the Constrained Double Root (380), namely the Equation Solver (386), is likely to be faster; none-the-less, for completeness this Inverse Root Solver (373) is described. This component is called when the Final Roots Constrainer (372) already has found only one precise final root, called the fRKnown and its fRKnownIndex. The Final Roots Constrainer (372) can use the suggested ConstraintMultiplier, this ensures the necessary inversion is correct. At least one more known final root is required so that the product of the two known roots, divided into the CubicRootProduct, produces the third root. Essentially, at least one of the unknown roots will not cancel while processing the inverse polynomial. See FIG. 9C Inverted Roots Polynomial (Prior Art) for the inverse polynomial, which is solved only up to finding the largest magnitude root.

FIG. 13, Inverse Root Solver (373), Method: This component calculates the Intrinsics of the inverted polynomial using some method, such as the Cubic Intrinsic Calculator (320) of FIG. 5 Cubic Split Process. Then the Cubic Final Calculator (350) is called. Therefore, the Cubic Final Evaluator (370) of FIG. 10 Cubic Final Evaluator is called, but its processing is greatly simplified. That is, after the Cubic Final Evaluator (370) calls the Final Roots Constrainer (372) three times, the largest magnitude (inverted) root, is the only root needed; it will not cancel. This root is simply inverted to become a root for the original polynomial and becomes the second known final root, called fRKA. The third root is found by dividing the product of fRKA times fRKnown into the CubicRootProduct. The second largest magnitude root will also likely past the constraint test. Now consider the why this works. Of the original polynomial's intrinsic roots, {iR1, iR2, iR3}, one of these intrinsic roots, called iRKnown is associated with fRKnown: fRKnown equals iRKnown plus the cubic Cubic FinalOffset specified in FIG. 1A Polynomial Types (Prior Art). Let's call the other two original intrinsic roots iRA and iRB, and they correspond to the cancelled final roots. Due to significant cancellation to both when adding the offset in the Final Roots Constrainer (372), we know that iRA and iRB are approximately the same value and on the opposite side of the origin of the complex plane, as compared to iRKnown. Now the magnitude of the intrinsic iRKnown=fRKnown−IntrinsicRootOffset, is almost twice that of iRA and iRB in order that all intrinsic roots sum to zero. And now, after adding the Cubic Final Offset, fRA and fRB, which have significant cancellation error, are much smaller than even the small iRA and iRB. On the other hand, fRKnown must have grown larger from the addition of the Cubic Final Offset. Therefore, both roots fRA and fRB are tiny compared to fRKnown; and fRA and fRB are not precise. All this means, if the inverted roots are found using the inverted roots polynomial of FIG. 9C Inverted Roots Polynomial (Prior Art), then the final two missing roots will be much larger compared to the inverted fRKnown root. We also know that at least the larger of the two inverted roots cannot experience cancellation caused by adding the inverted offset to the largest intrinsic root. This follows from the fact that the inverted intrinsic roots must sum to zero. Therefore, take the largest inverted final root, which is the precisely correct and invert it to obtain the second precise final root of the original polynomial, called fRKA. The third missing root, fRKB, is found by dividing the two product of the two, now known, original final roots, fRKnown and fRKA, into the original polynomial's CubicRootProduct. Thus, the two final roots are fRKA and fRKB are precise. If matching them to the correct index is not important, then processing is complete. Otherwise, the Universal Double Matcher (382) can be used; its usage was previously described.

FIG. 13 Equation Solver (386): The Equation Solver (386) offers additional, alternative, methods for finding the missing two roots. With two missing roots, the natural solution is to solve a quadratic equation to obtain the missing two roots, as developed in the Paired Sum Double Root Finder (388), which requires one arbitrary precision calculation. A more complicated approach is to use a quadratic to obtain two candidate solutions for one of the roots and determine a correct candidate; refer to the Quadratic Double Root Finder (390), which requires no additional arbitrary precision results. The methods are fast and reliable. The calculation of one arbitrary precision result for the Paired Sum Double Root Finder (388) might be slow if coefficients of the polynomial are complicated functions; therefore, the best mode is likely the Quadratic Double Root Finder (390), despite its complexity. All these methods utilize the Precise Quadratic Solver (202) component, described in section for FIG. 2B Precise Quadratic Solver (202). Descriptions for Paired Sum Double Root Finder (388) and Quadratic Double Root Finder (390) are now described.

FIG. 13 Paired Sum Double Root Finder (388): this component assembles parameters for, and then calls the previously described Precise Quadratic Solver (202) to precisely compute the two missing roots. Three values must first be determined for the Precise Quadratic Solver (202). First, the difference (perhaps ambiguously signed, it doesn't matter) between the two unknown roots has already been calculated by the Cubic Intrinsic Setup (330). Second, the product of the two unknown roots is easily found by dividing the single known root, which is non-zero, into Cubic Root Product defined in FIG. 9A Cubic Polynomial Identities (Prior Art). Thirdly, finally, the sum of the missing roots is found by calling the Missing Paired Sum Evaluator (389), described next. (Of course, if the sum of the root pairs was calculated through some other process, then the specific sum of the missing pair result can be directly used.) Once these three values are found, then the previously described Precise Quadratic Solver (202) will produce the precise values for the two unknown roots. Finally, some technique, such as the Universal Double Matcher (382) is called, if desired, to associate the newly found roots to their intrinsic roots and differences, as shown at the bottom of the FIG. 13 Constrained Double Solver (202). If the root-pair difference is not available, then the precise quadratic solver can still produce the two final roots, albeit with some loss of precision.

FIG. 13 Missing Paired Sum Evaluator (389): this component determines the sum of the two missing final roots for Paired Sum Double Root Finder (388). To compute the missing sum of two unknown roots, three precise values are needed. Let RA and RB be the unknown final roots, and let RK, previously calculated, be the known final root. The three root pair sums are defined as RKPlusRA=RK+RA, RKPlusRB=RK+RB, and RAPlusRB=RA+RB. We seek a precise evaluation of RAPlusRB; but both RA and RB endured cancellation and therefore their sum is imprecise. However, because RK is much larger than both RA and RB, the rule CR6: Predominate Precise Summation, previously discussed, ensures that RKPlusRB and RKPlusRA are both precise. The SummationRootProduct, is shown in FIG. 9B Paired Root Summation Identities, was described as an optional setup value in the description of Cubic Final Setup (360). This SummationRootProduct is equal to the product of RKPlusRA*RKPlusRB*RAPlusRB; therefore, RAPlusRB, the desired value, is precisely computed as the SummationRootProduct divided by RKPlusRA*RKPlusRB. The computed RAPlusRB is returned. But why is RK so much larger than both RA and RB? Well, while adding the final offset, RK suffered no cancellation and grew bigger, and both RA and RB suffered severe cancellation and are much smaller. This completes processing for Paired Sum Double Root Finder (388).

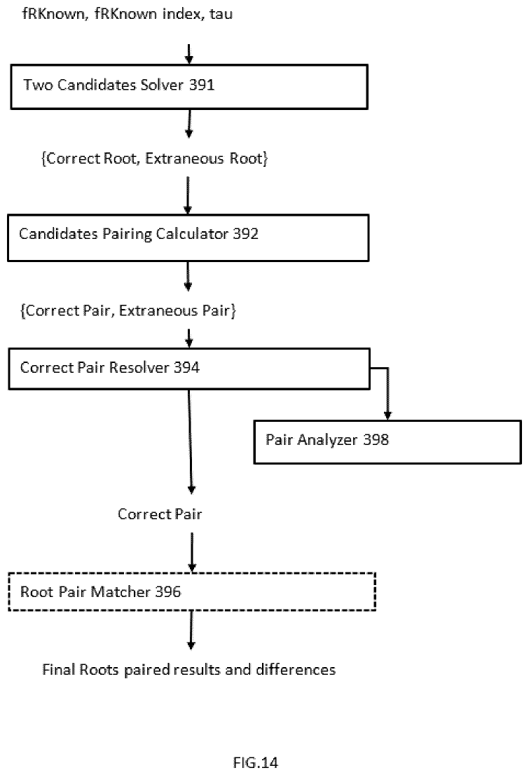

FIG. 14: this figure shows internal components of the Quadratic Double Root Finder (390), which is another implementation of Equation Solver (386), which finds the two missing roots. Input consists of root-pair differences, the final root, fRKnown, including its index fRKnownIndex, into the corresponding table row in FIG. 8B Cubic Root-Pair Differences. Call the two unknown roots fRA and fRB. Also, because degenerate zeroes have been processed, all final roots are guaranteed to be non-zero. Let tau be the previously calculated root-pair difference of fRA and fRB, as found in FIG. 8B Cubic Root-Pair Differences using the fRKnownIndex. Now, tau can be ambiguously signed, as described in the Cubic Difference Solver (349). (Of course, if tau is zero, it means that the two missing roots are exactly equal; for efficiency, a special case function could be easily developed that is slightly faster by using zero in place of tau in all the formulas). FIG. 14 shows internal processing components of the Quadratic Double Root Finder (390), where each result feeds into the next stage to finally produce the missing roots and perform the association to the intrinsic roots and root-pair differences. Only two of the three polynomial identities for coefficients, CubicPairedSum and CubicRootProduct, of FIG. 9A (Prior Art) are utilized. Importantly, this method does not use additional arbitrary precision calculations! The solution proceeds from the top of FIG. 14 to the bottom of the diagram. These internal components, of FIG. 14, are now described.

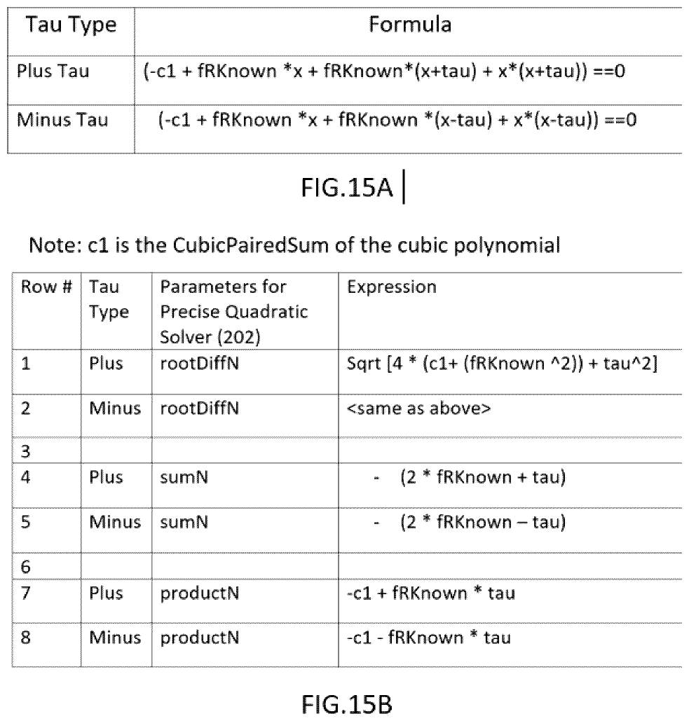

FIG. 15A Tau Equations: This table is needed for other components of FIG. 14. Using the CubicPairedSum identity of FIG. 9A, two equations are shown, which are utilized later for describing the Two Candidates Solver (391). The fRKnown value is a known precise final root. The tau value is the ambiguously signed difference between the two unknown roots. The c1 value is the coefficient of the cubic, as shown in FIG. 1A Polynomial Types, Prior Art, is the actual CubicPairedSum. The ‘x’ value may or may not be a valid cubic root: see the discussion which follows.

FIG. 14 Two Candidates Solver (391): The first step, shown in FIG. 14 Quadratic Double Root Finder, is the Two Candidates Solver (391), which uses the CubicPairedSum, as one of the three Cubic Polynomial Identities of FIG. 9A Cubic Polynomial Identities (Prior Art). Input also includes the known final root, fRKnown, and tau. From the known values, the cubic polynomial identity is populated with three roots: fRKnown, x, and either x+tau or x−tau. One of the identities is then solved for x. See FIG. 15A Tau Equations for the two possible equations: both of these quadratic equations, in x, are theoretical valid. If the coefficients were exact, then either equation could be used, but the coefficients are only precise. Note that the equation of FIG. 15A, Tau Equations, and therefore the sign of tau, is chosen to avoid cancellation, as described later. The result of solving the quadratic equation are two root value solutions for x, called x1 and x2. One of the values, x1 or x2, is another precise final root of the original polynomial, now called either fRA or fRB; the other x result value is an extraneous root that is not valid, and is discarded. To solve the quadratic for both x values, x1 and x2, the precise root pair difference, precise root sum and precise root product values must be found, as needed by the previously described Precise Quadratic Solver (202). Consider FIG. 15 B Tau Key Values which is used to construct these three parameters, rootDiffN, sumN and productN, for the Precise Quadratic Solver (202). If tau is computed from the differencing of intrinsic roots, instead of a precise formulaic result, then its precision is very poor if the two Intrinsics (of the missing roots) suffer massive cancellation.

FIG. 15B Tau Key Values, Column Headings: this table shows expressions for the three critical parameter values for both the +tau (Plus) and −tau (Minus) equations, as needed by the Precise Quadratic Solver (202). The first column, titled ‘Row #,’ is simply used for referencing the rows in the table. The second column, ‘Tau Type’, specifies that the value is for either the Plus Tau or Minus Tau of FIG. 15A Tau Equations. The third column provides the name of the parameter value as needed for the Precise Quadratic Solver (202). The last column ‘Expression’ provides a formula for the parameter value. Let's explore whether the three key values can be precisely found using either the +tau or −tau formula group. Amazingly, one-of, but not necessarily both, the +tau or the −tau formulas can be precisely evaluated!

FIG. 15B Tau Key Values, Rows 1, 2: Now consider Rows 1 and 2 of FIG. 15B Tau Key Values, which shows the same expression for the rootDiffN, whether using Plus or Minus the tau value. So use either the +tau or −tau equation. Now the rootDiffN of a quadratic equation (x\hat{ }2+b*x +c) is Sqrt[(b\hat{ }2−4*c); use either branch of the square root as the sign doesn't matter. Recall that c1 is the sum of three pairs of products: c1=fRKnown*fRA+fRKnown*fRB+fRA*fRB. Thus, every term in the rootDiffN expression in column 3, involves either the product of two roots, or the tau\hat{ }2 term. But, fRA, fRB and tau, due to constraints of the Final Roots Constrainer(372), must be tiny compared to the fRKnown. Therefore, the fRKnown\hat{ }2 term is vastly larger than all other terms combined. And, if one term predominates, then there can be no significant cancellation, as reflected in the CR6: Predominate Precise Summation rule. Therefore, the rootDiffN is always without significant cancellation for both +tau and −tau equations.

FIG. 15B Tau Key Values, Rows 4,5: Now consider rows 4 and 5 of FIG. 15B Tau Key Values. Again, tau is insignificant compared to fRKnown, and the sumN (named in the 3rd column) will always be precise per the CR6: Predominate Precise Summation rule.

FIG. 15B Tau Key Values, Rows 7,8: Finally, in lines 7 and 8, a value is either added or subtracted from c1; they cannot both cancel due to the CR2: Add and Subtract Magnitude Cancellation rule: note which formula works, 7 or 8, and use the result of larger magnitude. If 7 is precise, then use the Plus Tau method; otherwise, the Minus Tau method. Therefore, find the other two required formulas from the FIG. 15B Tau Key Values table, appropriately for either plus tau or for minus tau (see column header “Tau Type”). Thus, the three precise parameters are found and passed to the Precise Quadratic Solver (202) to obtain the two quadratic roots; the result are two precise candidate solutions in x, called x1 and x2. One value is one of the missing roots, the other value is extraneous. Also, remember whether the +tau or −tau formulas were used, as it will be needed later.

FIG. 14 Candidates Pairing Calculator (392): this component pairs both x1 and x2 values from the Two Candidates Solver (391), to find another associated potential root value. That is, x1 produces another root, called x1T, and x2 produces another root, called x2T. One of these root values, shown with suffix T, will be the candidate for the second final root. Therefore, using the Cubic Root Product Identity of FIG. 9A Cubic Polynomial Identities, this second root, x1T or x2T, is found by dividing the CubicRootProduct by the product of x1 and the fRKnown, and the result is called x1T. Similarly, for x2, the value x2T is produced. At this point, one of the two pairs, pair1={x1, x1T} or pair2={x2, x2T} contains the two sought-after final roots to the cubic; the other pair is not useful.

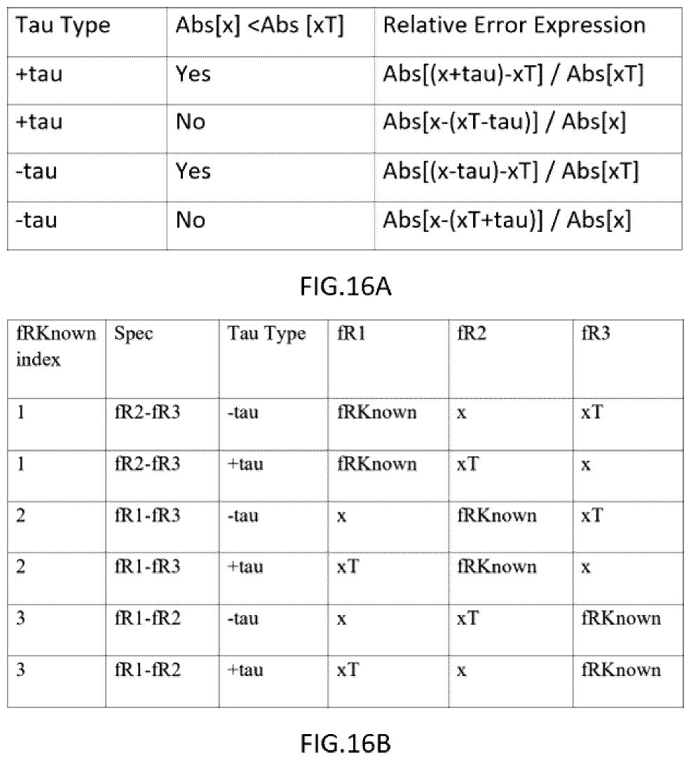

FIG. 16A Paired Test Table: this table indicates a simple method to return relative error values. The pair of values {x, xT} in the table refers to either of the paired values, pair1={x1, x1T} or pair2={x2, x2T}. If the Plus Tau parameters were used in construction, then both pair1 and pair2 relate to the first two +tau lines, similarly for Minus Tau parameters, the next two lines are utilized. For each pair, first determine if Abs[x]<Abs[xT], then column 2 specifies which row to use; for example, use the first of the two rows if “Yes”. Next evaluate the expression; if the denominator is zero, then return +Infinity. The simple expression determines if the two values, {x, xT}, differ by tau.

FIG. 14 Pair Analyzer (398): this component returns a relative error value for either candidate pair, namely {x, xT}, for {x1,X1T} and {x2,x2T}. It tests whether the paired root values differ by the appropriately signed tau. See FIG. 16A Paired Test Table, which shows which of four expressions to evaluate to return the result which has no cancellation for the correct roots. Using the first and second columns, determine which of the four expressions in the last column should be used. The first column refers to whether the Plus Tau or Minus Tau equation was used for Two Candidates Solver (391); see FIG. 15A Tau Equations. The second column refers to a test to find the smaller magnitude of x and xT. Adding or subtracting tau to produce the larger magnitude value, eliminates cancellation error, at least on the correct pair of roots. The last column is a standard relative error expression with a numerator defined as the absolute value of the difference from the expected result, and the denominator the absolute value of the expected result.

FIG. 14 Correct Pair Resolver (394): this component determines which candidate pair, {x1, x1T} or {x2, x2T}, contains the pair comprising the precise two final roots, now called {fRKA, fRKB}, which were originally found to have too much cancellation by Final Roots Constrainer (372). For each of the two pairs, the Pair Analyzer (398), in FIG. 14, returns an error value. The pair with the smaller error is the correct pair of roots representing {fRA, fRB}.

FIG. 14 (Optional) Root Pair Matcher (396), and FIG. 16: this component associates the two final roots, x and xT, found in the Correct Pair Resolver (394) to the correct root-pair intrinsic roots; it can be used with the Quadratic Double Root Finder (390) as indicated in FIG. 13 and expanded in FIG. 14. Note, too, that this component is optional unless all intrinsic roots need correct association to final roots. Refer to FIG. 16B Double Root Matching Table to determine how to associate roots; this table is like the previously described table in FIG. 12 Degenerate Table, which was used when one of the double roots is zero. This algorithm should use results from the Cubic Difference Solver (349) that returns the differences with the correct sign. Otherwise, almost as good, difference the associated intrinsic roots; this can suffer massive cancellation, but only when the final roots are almost equal; and so massive cancellation has no serious consequence. For example, implement the Cubic Difference Solver (349) using Triple Root Pair CRS method. Suppose the final two roots fR2 and fR3 are found as x and xT from one of the pairs in Correct Pair Resolver (384). Does fR2 equal x or xT, and similarly for fR3? Based on the type of tau equation and the index of fRKnown, the FIG. 16 table shows the x and xT values setting the final values. Of course, the Universal Double Matcher (382), part of in FIG. 13 Constrained Double Solver, also works well and is fast, to find the correct association.

Best Method of Constrained Double Solver (380): At least three methods are available, as shown in FIG. 13. The Inverse Root Solver (383) requires considerable effort to find roots of the inverse polynomial. Now consider the two solutions of the Equation Solver (386). The Quadratic Double Root Finder (390) is complicated, but fast, and requires no other arbitrary precision calculations. On the other hand, the Paired Sum Double Root Finder (388) requires one, usually simple, arbitrary precision calculation, and a very simple process. Note that the Paired Sum Double Root Finder (388) will suffer some loss of precision (never losing more than half of precision) when the precise root-pair difference, ambiguously signed or not, is constructed by subtraction of the appropriate intrinsic roots; instead, just never do this, and use one of the precise methods for finding root-pair differences! However, the Quadratic Double Root Finder (390) is fast, and is always good choice, and probably the best in most circumstances.

FIG. 5, FIG. 10, Paired Root Sum Calculator (305): At the bottom of FIG. 5, is the Paired Root Sum Calculator (305). and FIG. 10, an optional Paired Root Sum Calculator (305) adds the singular constant SummationFinalOffset, of FIG. 9B Paired Root Summation Identities, to the original polynomial's FIG. 8B Cubic Intrinsic Root-Pair Sums, {iSR1, iSR2, iSR3} to produce the paired sums of {fSR1=fR2+fR3, fSR2=fR1+fR3, fSR3=fR1+fR2}. The output from this Cubic Final Evaluator (370) operating on the original polynomial, plus the Paired Root Summation Polynomial of FIG. 9B Paired Root Summation Identities, provides the necessary input to find the {fSR1, fSR2, fSR3} output. Details follow.

FIG. 5 Paired Root Sum Calculator (305) continued: FIG. 9B Paired Root Summation Identities shows the construction of a polynomial, the Paired Root Summation Polynomial, whose roots are the sums of each pair of final roots of the original polynomial. The final roots are called {fSR1, fSR2, fSR3} and are associated with the FIG. 8B Cubic Intrinsic Root-Pair Sums. Of course, as an exact cubic polynomial, these roots, consisting of paired sums of roots, can be solved by any cubic solver for the Paired Root Summation Polynomial. That's a lot of work. However, the entire Intrinsics re-processing of the Paired Root Summation Polynomial, is not required: See the description of FIG. 8B Cubic Intrinsic Root-Pair Sums for trivial calculation of the sum of intrinsic roots, which are the intrinsic roots of the paired root summation polynomial; as shown, simply negate the intrinsic roots to obtain the paired sums of intrinsic roots! Similarly, the description of FIG. 8D Intrinsic Cubic Root-Pair Differences of Sums, shows that the intrinsic difference between these paired sums is also trivial; simply negate the intrinsic differences of the original polynomial.

FIG. 5 Paired Root Sum Calculator (305), Conclusion: Thus, through simple negation of an original intrinsic root iSR1 is simply the negation of iR1, and so on. Thus, all the intrinsic root input for Cubic Final Calculator (350) of FIG. 5 Cubic Split Process is trivially found. To find the correctly associated final {fSR1, fSR2, fSR3}, the correct coefficients of the Paired Root Summation Polynomial of FIG. 9B are sent to the Cubic Final Calculator (350) of FIG. 5 Cubic Split Process with the {fSR1, fSR2, fSR3}. The correct association is found as described earlier for the original polynomial.

### Cubic Univariate Processing

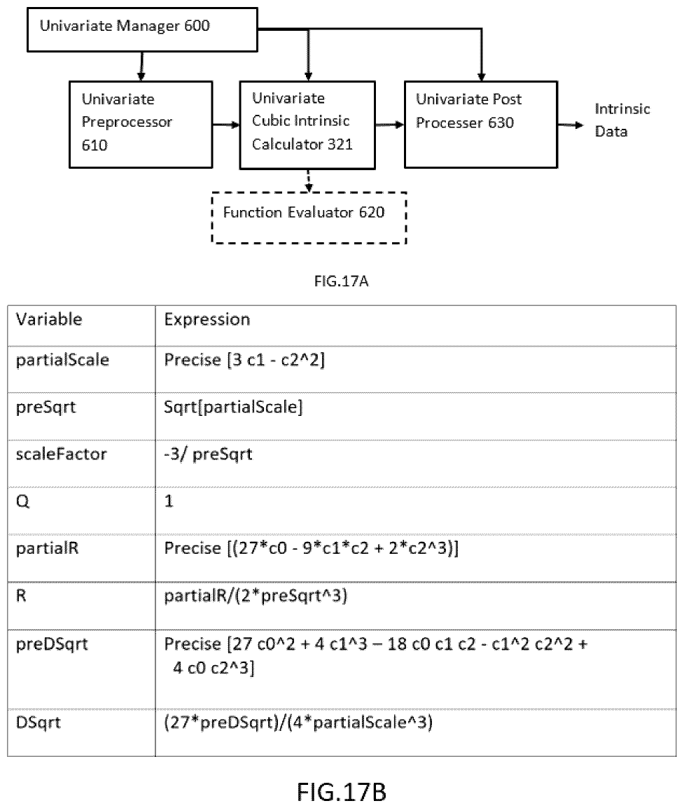

FIG. 17A Cubic Univariate Intrinsic Scaling: this diagram shows a method to process intrinsic values, for the Cubic Intrinsic Calculator (320), using a single variable. Recall, the Cubic Intrinsic Setup (Prior Art), described earlier, to produce Q, R, and DSqrt, where DSqrt is the Square Root of R\hat{ }2+Q\hat{ }3; therefore, DSqrt can derived from Q and R, and the original formulas are really bivariate forms of R and Q. A Univariate formula is typically based on either R or Q set to a constant, such as the value one. This results in a univariate complex function which can be visualized in 2D for all complex input values. To see the advantage of a complex univariate function, consider that each variable has two axes, a real and imaginary axis. In a univariate form, visualizing the final relative error is easy: it's a two-dimensional mapping where each location, result value, is the relative precision error; thus, a 2D visualization can be easily used to find errors in the program. For visualizations and debugging, the univariate approach offers some advantages.

FIG. 17A Cubic Univariate Using Approximating Functions: There is, of course, the elegance of finding and using a univariate solution. Any simplifications, using univariate formulas, is offset by the complications of the exact expressions after scaling to eliminate one variable. However, univariate functions, even those of this complexity, can be approximated with Pade or simple Taylor Series approximations. However, such approximations might be overkill compared to the numerically stable arithmetic described earlier for the Cubic Intrinsic Calculator (320) component.

FIG. 17A Univariate Manager (600): this component sequences three components: Univariate Preprocessor (610) to pre-scale the polynomial, the Generic Cubic Intrinsic Calculator (321) to find the cubic Intrinsics for the scaled polynomial, and the Univariate Post Processor (630) to obtain unscaled Intrinsic roots and differences, so as to return the same results as the Cubic Intrinsic Calculator(320).

FIG. 17A, Univariate Preprocessor (610): this component scales the roots of the polynomial so that one of the two intrinsic variables, say Q or R, is eliminated. Scaling consists of multiplying by a non-zero complex value. Of course, the actual roots are, at this point, are unknown, but scaling the polynomial's coefficients does the trick of scaling the roots. Critically, the scaling factor for Univariate Preprocessor (610) must be an exact expression. For example, to eliminate R or Q, we can consider making R a function of Q, or vice versa. Even simpler, scaling can convert R or Q to a constant, such as a value equal to one. See the Cubic Scaling entry of FIG. 3 Delta Polynomials, which shows the new cubic polynomial when all roots are scaled by ‘s’. The Cubic polynomial is needed here. What value of ‘s’ causes Q, which equals (1/9) (3*c1−c2\hat{ }2), to exactly equal the value 1? This value of ‘s’ is used to scale the polynomial and equals-3/Sqrt[3*c1−c2\hat{ }2]. If the 3*c1−c2\hat{ }2 is zero, it's a degenerate case and Q is zero, and the result is univariate without any scaling, and appropriate optimized solutions are obvious. If non-zero, then appropriate values for scaling, R, and even DSqrt are easily found from their usual formulas. FIG. 17B shows the typical setup of Q, R and DSqrt for a univariate version of Cubic Intrinsic Setup (330) for forcing Q to value 1; this table is easily generated once the pre-scaling is determined as −3/Sqrt[3*c1−c2\hat{ }2]. Similarly, the value of R can be scaled to 1 and the appropriate setup using the standard formulas will produce a similar setup sequence. Note, the scaling factor for R to become 1, is found by symbolically simply solving for R==1, for the unknown ‘s’ in the Cubic formula of FIG. 17B Scaling Polynomials. Although DSQRT can also be converted to a constant, but the scaled coefficients are likely to be much more complicated.

FIG. 17A Generic Cubic Intrinsic Calculator (304): this component is either the previously described Cubic Intrinsic Calculator (320) or an optimized version, Univariate Cubic Intrinsic Calculator (321) of FIG. 17A.

FIG. 17A, Univariate Cubic Intrinsic Calculator (321): Instead of Generic Cubic Intrinsic Calculator (304), an optimized Univariate Cubic Intrinsic Calculator (321) can be used: Several optimizations can be made because there is one less variable (Q , R, or possibly DSqrt). For example, if Q is scaled to become a constant, then the machinations to find the Q variable are eliminated, but at the cost of much more complicated scaled coefficient expressions for other values. Of course, these optimizations are dependent upon which variable is converted to a constant. The Univariate Cubic Intrinsic Calculator (321) can also be modified to call a Function Evaluator (620) to evaluate specific expressions, described next.

FIG. 17A Function Evaluator (620): this optional component can sometimes simplify numeric expressions of a single variable. For example, if Q is scaled to 1, Sqrt[R\hat{ }2+1] can be implemented as a univariate function. Typically, such functions would be implemented with polynomials or rational polynomials. By making approximating functions for say CRS1 and CRS2, the remaining calculations for intrinsic roots and root-pair differences can be achieved as described earlier. Of course, depending upon many factors, the Univariate implementation may or may not be an improvement on the purely algebraic solution already described. In practice, the implementation would pre-compute the approximating function for say Q=1 or R=1.

FIG. 17A Univariate Post Processor (630): After the intrinsic roots and root-pair differences are found, the Univariate Post Processor (630), of FIG. 17A, divides the resulting intrinsic roots and root-pair differences by the same scaling factor. The result from all univariate processing is the same as the earlier described component, Cubic Intrinsic Calculator (320).

### Generic Cubic Processing

FIG. 17A, Best Mode: very little is gained by using the optional Function Evaluator (620). Indeed, the whole need for univariate processing is best reserved for debugging and visualization.

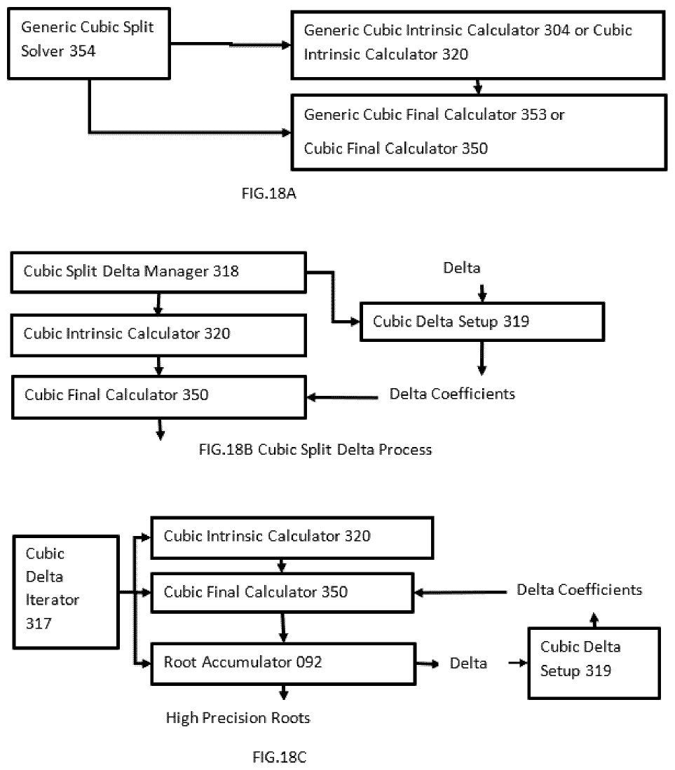

FIG. 18A Generic Cubic Split Solver (354): This component is a generalized version of the previously described Cubic Split Process (300) of FIG. 5 and may call functions that include some non-formulaic methods. For example, instead of using the previously described, formulaic, Cubic Intrinsic Calculator (320), a Generic Cubic Intrinsic Calculator (304) is used, which may not have any formulaic processing. Similarly, a Generic Cubic Final Calculator (353) could be used in place of the formulaic Cubic Final Calculator (350).

FIG. 18A Generic Cubic Intrinsic Calculator (321): this component is any cubic solver which finds Intrinsics, such as the intrinsic roots, the intrinsic root-pair sums, or the root-pair differences. For generic processing, like the described formulaic process, the original cubic polynomial is converted to its intrinsic cubic polynomial. Also, the generic case, of course, encompasses both the previously described formulaic solution and other formulaic solutions. Also, the augmentations previously discussed for historical methods, can be added to a general-purpose method. As described earlier, the Cubic Difference Solver (349), is used when two root-pair differences are already known by any means. Similarly, if two intrinsic roots are found by any means, then using the methods of the Cubic Intrinsic Root Solver (348) will find the third intrinsic root. This is sufficient to make other alternative solutions much easier. If all three intrinsic roots are known, then all differences can be easily found because two root-pair differences can always be directly found by differencing of the intrinsic roots, and the third root-pair is found using the Cubic Difference Solver (349). If three intrinsic roots are found, they can themselves be used to find the intrinsic root-pair sums by simply negation! E.g., if the three intrinsic roots are iR1, iR2 and iR3, then −iR1 must equal iR2+iR3 because iR1+iR2+iR3==0. However, the original Cubic Intrinsic Calculator (320) is a better approach, for simplicity and guaranteed worst-case performance.

FIG. 18A Generic Cubic Final Calculator (353): with the three intrinsic roots, and the original polynomial coefficients, the previously described Cubic Final Calculator (350) can produce the three precise final roots and correctly associate the final roots to the intrinsic roots, trivially. Of course, non-formulaic methods can be included, as indicated by the word “Generic”. From the original polynomial, the intrinsic roots are converted to the final roots by adding −c2/3: See FIG. 1A, prior art. Recall that at least one final root is precisely found when adding the final constant to the intrinsic roots. For the case of two precise final roots, the third final root is trivially found by dividing the product of the two known roots into the negated c0 coefficient. For the generic case, when only one final root is precise, life is hard. One traditional approach, is to simply raise the precision of the entire process, beginning with the Generic Cubic Intrinsic Calculator (321). However, it's not clear how much extra precision is required. Therefore, the purely formulaic solutions of the Cubic Final Calculator (350) are much superior.

FIG. 18B Cubic Split Delta Process Diagram: Delta processing can use either the previously described standard delta processing of FIG. 4A or split delta processing in FIG. 4B; split delta processing will be much faster due to the one-time calculation of intrinsic roots. Cubic delta processing can utilize the same components for FIG. 4B, with each generic component replaced by its cubic equivalent, as shown in FIG. 18B.

FIG. 18B Cubic Split Delta Manager (318): this component simply manages cubic delta processing as would the more generic process, Split Delta Manager (002), previously described.

FIG. 18B Cubic Delta Setup (319): this component simply sets up cubic delta processing as would the more generic process, Delta Setup (090), previously described.

FIG. 18C: Cubic iterative delta processing can utilize the components for FIG. 4C, with each generic component replaced by its cubic equivalent, as shown in FIG. 18C, Cubic Delta Iteration.

FIG. 18C, Diagram for Cubic Iterative Delta Processing: this process can utilize the components for FIG. 4C, with each generic component replaced by its cubic equivalent, as shown in FIG. 18C, Cubic Delta Iteration.

FIG. 18C Cubic Delta Iterator (317): this component performs the same as the delta iterator (003) of FIG. 4C but adapted to cubic processing.

### Historical Quartic Polynomial Processsing

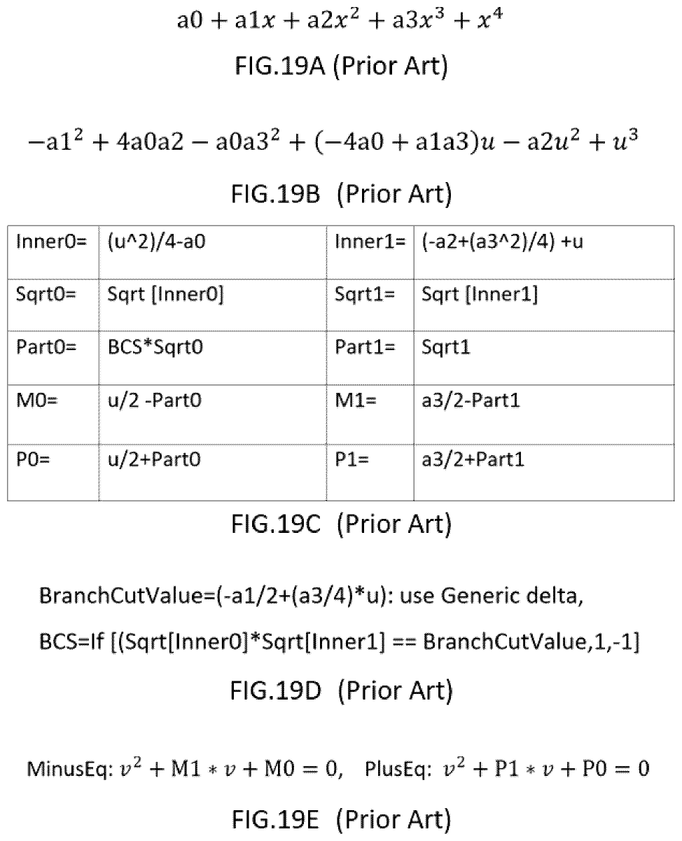

FIG. 19A-FIG. 19E, Historical Prior Art: These figures show the prior art gathered from several sources. These formulas are theoretically correct, but require extensive augmentation to be practical, as will be described.

### Quartic Polynomial Processsing

FIG. 19A Quartic Polynomial (Prior Art): this shows the definition of a quartic polynomial, where each coefficient is an expression evaluating to a constant value. This is the same as in FIG. 1A Polynomial Types (Prior Art).

FIG. 19B Derived Cubic (Prior Art): The historical method, prior art, of finding roots of the quartic polynomial begins by forming a derived cubic polynomial, of one unknown, variable u, from the coefficients of the original quartic equation; the derived cubic polynomial is shown in FIG. 19B Derived Cubic (Prior Art). Note: as needed later, to find delta polynomials for the derived cubic, pass the coefficients of the delta polynomial of FIG. 19B Derived Cubic (Prior Art) into the corresponding coefficients {c0, c1, c2} of FIG. 3 Delta Polynomials. Delta processing is critical to numerically stable solving of quartic equations.

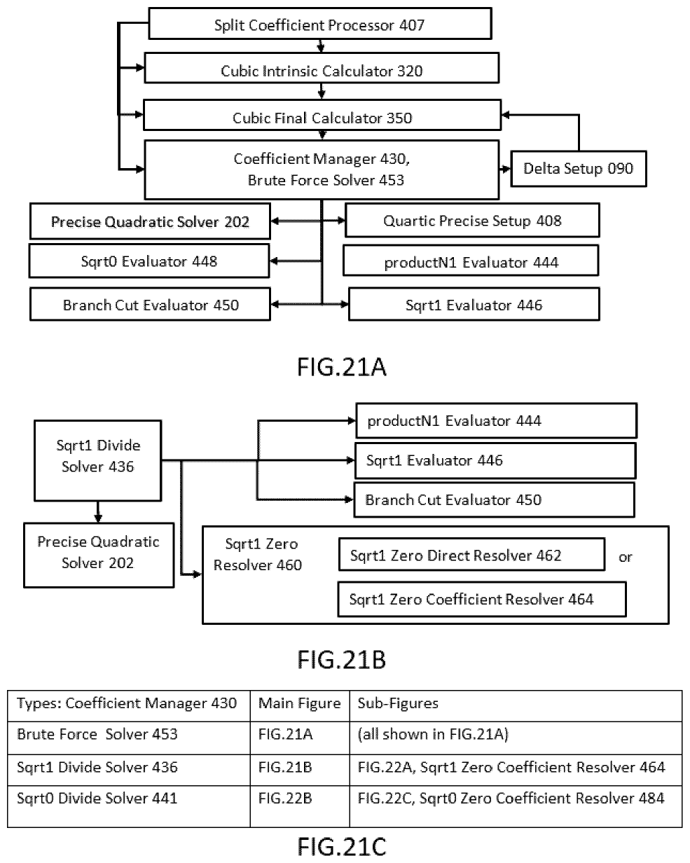

FIG. 19C Quadratic Coefficients (Prior Art): this shows the construction of the expressions to define the quadratic coefficients, {M0, M1, P0, P1}, and partial results thereof. Let “u” be a root of the derived cubic polynomial. The Inner0 and Inner1 values are constructed from the same u root of the Derived Cubic Polynomial of FIG. 19B Derived Cubic (Prior Art). Sqrt0 and Sqrt1 are the square roots of the shown formulas for Inner0 and Inner1; pick either branch cut for the square roots, and a BCS value will correct the branch cut for Part0. M0 uses a BCS value (−1 or 1) to modify the Sqrt0 value, and similarly for P0. BCS (branch cut sign) is described in FIG. 19D Branch Cut Sign (Prior Art). The u value is, of course, any one of the three roots of the derived polynomial of FIG. 21B Derived Cubic (Prior Art). Note, although the BCS value, as used, only is part of the definition M0 and P0; However, instead of modifying the Sqrt0 value, the BCS value could also be similarly used to modify Sqrt1. You choose, and the BCS value will fix, if needed, the sign of the other Sqrt. Note, that the whole purpose of BCS is to ensure that the branch-cut of the square roots for Sqrt0 and Sqrt1 work correctly together, even when taking a numerically unstable Sqrt of a value infinitesimally close to the minus real axis, where round-off errors can negate the resulting Sqrt value and switch its sign.

FIG. 19D Branch Cut Sign: this value, shortened to BCS is {+1 or −1} or {True, False}, is determined for usage in the expressions of FIG. 19C Quadratic Coefficients. The BCS value is defined by using a choice based on the product of Sqrt0 and Sqrt1, as shown. General Cubic Delta processing, as shown in FIG. 3 Delta Polynomials, is sometimes needed to eliminate numerical cancellation when computing the formula for the BCS value; this new processing is described later.

FIG. 19E Quartic Roots from Quadratics: the final root solutions of the two quadratic equations, MinusEq and PlusEq, produces the four final quartic roots, with possibly massive or total cancellation resulting, in possibly, total loss of precision. Not all prior art discusses the proper BCS value which, in effect, makes sure the branch cuts for the Sqrt0 and Sqrt1 root are compatible; this is done by negating the sign (same as multiplying by −1), as necessary, of one of the Sqrt values.

### M0P0EQ and M1P1EQ

The m0p0EQ and m1p1Eq are quadratic equations that define four roots which are used to form a coefficient set of {M0, P0, M1, P1}. Because these equations use the precise, but not exact, u-root from the derived polynomial, there is no simple way to precisely find the roots. Instead, the new process of delta processing is used. The u-root is any root of the derived cubic polynomial, but both equations use the same u-root.

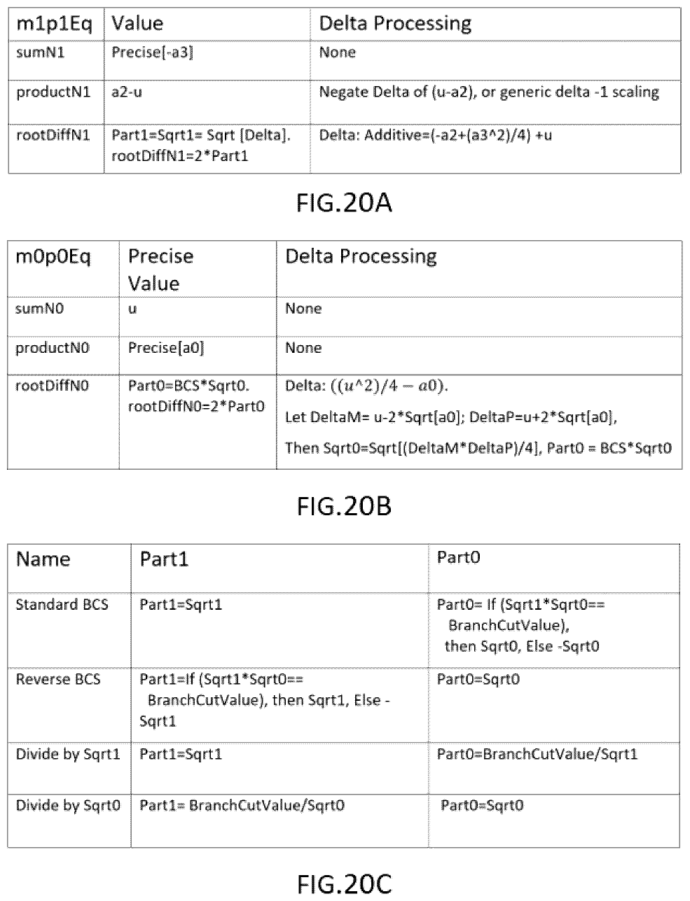

FIG. 20A, m1p1Eq Quadratic: this shows the input, which defines an implied quadratic equation, (a2−u)−a3*x+x\hat{ }2==0, whose roots are {M1, P1}. The ‘u’ value is any root of the derived cubic of FIG. 19B Derived Cubic. The quadratic roots are the M1 and P1 values of FIG. 19E, Quartic Roots. Column one specifies the three parameters for the Precise Quadratic Solver (202); e.g., sumN1 is the sumN parameter. The second column specifies the expression value of the parameter. The third Column specifies the type of cubic delta process, if any, required. RootDiffN1 is the Sqrt1 of FIG. 19C Quadratic Coefficients. Note that rootDiffN1 can be computed with half precision using the square root of the quadratic discriminant, as Sqrt[b\hat{ }2−4*c] for x\hat{ }2+b*x+c; where b=(−a3) and c=(a2−u). However, this half precision cuts the final root precision in half, and the use of delta processing, as described later, is therefore recommended. See FIG. 20C for possible branch cut selection of Sqrt1.

FIG. 20B, m0p0Eq Quadratic: this shows the input which defines an implied quadratic equation: a0−u*x+x\hat{ }2==0, whose roots are {M0, P0}, and u is a root of the Derived Cubic of FIG. 19B Derived Cubic; use the same ‘u’ root as in FIG. 20A, m1p1Eq Quadratic. Columns are as defined for the above FIG. 20A m1p1Eq Quadratic. RootDiffNO is the Sqrt0 of FIG. 19C Quadratic Coefficients. Note that rootDiffN0 can be computed with half precision using the square root of the quadratic discriminant, as Sqrt[b\hat{ }2−4*c] for x\hat{ }2+b*x+c; where b=(−u) and c=(a0). However, this half precision cuts the final root precision in half, and its use is not recommended. Consider the cubic delta processing for rootDiffN0, of FIG. 20B m0p0Eq Quadratic. Here, because of the squared term, the numerically unstable expression, (−4*a0+u\hat{ }2) is not directly usable in a delta process for ‘u’. Several solutions are possible, as described in the Coefficient Manager (430), as described later. See FIG. 20C for possible branch cut selection of Sqrt0.

FIG. 20C, BCS Usage: this shows four ways to determine Part0 and Part1 of FIG. 19C Quadratic Coefficients, including the possible negation for Sqrt1 or Sqrt0 values from the rootDiffN1 and rootDiffN0 values of the previous FIG. 20A and FIG. 20B to produce the critical Parto and Part1 values of FIG. 19C, Quadratic Coefficients; rootDiffN1 and rootDiffN0 are the input Sqrt1 and Sqrt0 as used by FIG. 19D BCS: Branch Cut Sign. The Standard BCS and Reverse BCS rows of FIG. 20C, BCS Usage, implement a negation of at most one Sqrt value, so that Sqrt1*Sqrt0 precisely equals the BranchCutValue. Because the Sqrt1*Sqrt0 will always precisely equal either BranchCutValue or-BranchCutValue, only one decimal digit of precision is usually required of the BranchCutValue to pick the correct value. For example, take the DotProduct (820) of FIG. 3A Numeric Utilities, by treating the complex Sqrt values as vectors. If the result is positive don't negate either. The next two rows, Divide by Sqrt1 and Divide by Sqrt0, show simple alternatives. For Divide by Sqrt1, the more difficult Sqrt0 value never needs to be calculated, but special arrangements for a divide by zero must be made. Similarly, for Divide by Sqrt0, avoids the calculation of Sqrt1, but special arrangements for a divide by zero must be made. More on these methods later.

FIG. 21A shows the innards of the Split Coefficient Processor (407) component which finds precise values for the quadratic coefficients {M0, P0} and {M1, P1}, which are used as coefficients of MinusEq and PlusEq of FIG. 19E Quartic Roots. The coefficients of the quartic polynomial, see FIG. 19A Quartic Polynomial, are the input to the Split Coefficient Processor (407). The process may use both the previously described FIG. 1B Generic Split Process as well as FIG. 4B Split Delta Process. Delta processing is based on any root, u, from the Derived Cubic; any of the three roots can be used, but the computed delta roots, such as (u+c), must be associated with the correct original root, u, where c is the additive delta constant, as described for the Cubic Final Calculator (350) of FIG. 5. Note that the Coefficient Manager (430), described later, manages the several calls, as necessary, to implement the delta process for required delta results. After computing the coefficients for m1p1Eq of FIG. 20A and m0p0Eq of FIG. 20B, these same equations are precisely solved using the Precise Quadratic Solver (202) to yield the four quadratic coefficients, {M0, M1, P0, P1}, called the quadratic coefficients set.

FIG. 21A Split Coefficient Processor (407): in this component, the quartic coefficients are used to derive the exact coefficients of the Derived Cubic Polynomial, as indicated in FIG. 19B Derived Cubic Polynomial (Prior Art). The Split Coefficient Processor (407) sets up and drives the whole process. First the Cubic Intrinsic Calculator (320) is called to return the intrinsic u-roots of the derived cubic polynomial together with root-pair data. The Cubic Final Calculator (350) is called to obtain the final u-roots. Finally the Coefficient Manager (430) drives the delta process. Construction of the parameters for sum, product and difference can be done in several ways. See also FIG. 18A, which describes generic replacements for the standard formulaic solutions.

FIG. 21A Cubic Intrinsic Calculator (320): this component, previously described as part of FIG. 5 Cubic Split Process, processes the Derived Cubic Polynomial to produce the derived cubic Intrinsics, including Intrinsic Roots, and Root-Pair data.

FIG. 21A Split Coefficient Processor: the previously described Cubic Final Calculator (350), of FIG. 5 Cubic Split Process, processes the Intrinsics of the Derived Cubic Polynomial to produce its roots, with and without a delta offset; and is called multiple times as needed for delta values to produce the delta roots. The result is the cubic roots along with all the root-pair data and delta results. Thus, in addition to ‘u’, precise results are obtained for delta processing specified in the last columns of FIG. 20A, m1p1Eq Quadratic, and FIG. 20B, m0p0Eq Quadratic.

In FIG. 21A Delta Setup (090): the previously described Delta Setup (090) of FIG. 4A Split Delta Process (002), processes requests for setting up a delta polynomial for the delta process. The output is the exact delta modified coefficients for Derived Cubic Polynomial.

In FIG. 21A Precise Quadratic Solver (202): the previously described Precise Quadratic Solver (202) of FIG. 2B Precise Quadratic Solver (202), precisely solves quadratic equations with only the precise (not exact) inputs specified by FIG. 20A m1p1Eq Quadratic and FIG. 20B m0p0Eq Quadratic.

FIG. 21A Quartic Precise Setup (408): the Quartic Precise Setup (408) simply evaluates the exact quartic coefficients to floating point precision, using the previously described routine Precise (812). Additional precise results may also be processed, depending upon the implementation of the Coefficient Manager (430) with delta processing. The FIG. 21A, Split Coefficient Processor, shows a full precision implementation of the Coefficient Manager (430). The quadratic coefficients set, {M0, P0, M1, P1}, of FIG. 19C Quadratic Coefficients, are the result.

### Coefficient Manager

FIG. 21A Coefficient Manager (430), Brute Force Solver (453): this component finds the MinusEq and PlusEq quadratic coefficients, {M0, M1, P0, P1}, with full precision by calling delta processing evaluators which return the delta processing results. This version of the Coefficient Manager (430) is called the Brute Force Solver (453) because all evaluations are performed. Additionally, the routine returns the Part1 value (see FIG. 19C) which is the intrinsic part for M1 and P1, {iM1, iP1}, where iM1 =−Part1 and iP1=Part1; these values, together with root-pair differences of the derived cubic polynomial, make possible the calculation of quartic root-pair differences, as described later. Non-delta processing is performed directly, such as calculating the ProductNO as Precise[a0], as shown in FIG. 20B, m0p0Eq Quadratic. Other values are computed per FIG. 20A, FIG. 20B, and FIG. 20C. Up to four delta evaluators are used for delta processing, depending upon the choice of implementation of FIG. 20C, BCS Usage; these delta processing calls can be processed quickly after the initial cubic Intrinsics are processed by the Cubic Intrinsic Calculator (320). Decide on the BCS implementation, which determines the required delta processing; details on BCS processing are also provided below. Only one implementation is needed. When values for quadratic processing are completed, including BCS adjustments, two calls are made to the Precise Quadratic Solver (202) to obtain the four roots representing {M0, M1, P0, P1}; these roots are not the quartic roots, but only the four coefficient values. That is, using the computed results for FIG. 20A, the Precise Quadratic Solver (202) obtains the precise {M1, P1} coefficients. And, using the computed results for FIG. 20B, the Precise Quadratic Solver (202) obtains the precise {M0,P0} coefficients.

FIG. 20A, Implementations FIG. 21C: FIG. 21C shows the three main implementations of the Coefficient Manager (430) of FIG. 20A, and the figure references. The first implementation was already introduced as the Brute Force Solver (453) of FIG. 21A, which evaluates {Sqrt0, Sqrt1, Branch Cut Value}, among others. For this implementation, the branch cut correction is simply performed as described for the Standard BCS mode or Reverse BCS mode of FIG. 20C. Of course, for this, the Branch Cut Value only needs a couple of digits of precision. This implementation suffers from the minor difficulty of utilizing a square root value when using Precise (812) to evaluate an expression. The second possible implementation is the Sqrt1 Evaluator (431), which only needs to evaluate the Sqrt1 and the BranchCutValue, and the awkward Sqrt0 calculation is avoided by setting the Sqrt0 to the BranchCutValue/Sqrt1, where the BranchCutValue must have full precision: see the 3rd row of FIG. 20C, “Divide by Sqrt1”. In the rare case that the Sqrt1 value is exactly zero, see the Sqrt1 Zero Resolver (460) of FIG. 21B. Finally, in the last row of FIG. 21C, the Sqrt0 Evaluator (431) is very similar to Sqrt1 Evaluator (431), except that the roles of Sqrt0 and Sqrt1 are reversed so that Sqrt0 is found by BranchCutValue/Sqrt1. Neither Sqrt1 Evaluator (431) nor Sqrt0 Evaluator (431) require a BCS fix up; therefore, upon completion, for these latter two evaluators, Part0 is directly set to Sqrt0 and Part1 is directly set to Sqrt1. Now consider the full implementation of the Coefficient Manager (430).

FIG. 20A, m1p1eq: the table of FIG. 20A shows the input for calculating the {M1, P1} values. As previously described the Precise Quadratic Solver (202) needs three inputs: the sum of the roots, the product of the roots, and the difference between the roots. FIG. 20A shows the three inputs to precisely solve the m1p1Eq to produce {M1, P1} values.

FIG. 21A productN1 Evaluator (444): this component finds the productN1 value of FIG. 20A m1p1Eq Quadratic. The delta required is (u−a2) for the productN1 value of second column; after forming the delta result, negate the (u−a2) delta-root result to produce the needed productN1 value of (a2−u).

FIG. 21A, Sqrt1 Evaluator (446): this component finds the Sqrt1 value of FIG. 20A m1p1Eq Quadratic. The delta required is ((−a2+(a3\hat{ }2)/4)+u); take the Sqrt of the resulting delta value for the Sqrt1; don't worry about which branch cut to use as it will be compensated later to be compatible with the branch cut of Sqrt0.

FIG. 21A, Sqrt0 Evaluator(448): this component finds the Sqrt0 value of FIG. 20B m0p0Eq Quadratic. The delta required is ((u\hat{ }2)/4−a0), which doesn't fit the template for additive or general delta processing of FIG. 3. Consider a delta of ((u\hat{ }2)−4*a0); if this can be found, then divide the value by 4 to obtain ((u\hat{ }2)/4−a0). Again, ((u\hat{ }2)−4*a0) is not a delta processing format. However, as shown for the Sqrt0, the last row of FIG. 20B m0p0Eq Quadratic, ((u\hat{ }2)−4*a0) equals the product of DeltaM=u−2*Sqrt[a0] and DeltaP=u+2*Sqrt[a0; take either branch cut of Sqrt[a0]. Either DeltaM or DeltaP has no cancellation and is directly calculated per use of CR2: Add and Subtract Magnitude Cancellation Rule to determine which, due to cancellation, needs simple additive delta processing, and do it. Now, with both values determined, the Sqrt0 value is the Sqrt[DeltaM*DeltaP/4]; pick either branch cut of the Sqrt. Although this method produces a precise result, it is encumbered by taking the square root of a0 and using it within possibly arbitrary precision evaluations of the delta process; this defeats the simplicity of using ‘high precision’ instead of ‘arbitrary precision’. Why? a square root is typically an infinite progression of digits. However, if only the final coefficients are needed, the Sqrt[0] need only be computed to twice the final desired precision per CR7: Quadratic Delta Double Precision Rule. However, in this quick method, the Sqrt0 a parameter of FIG. 21B m0p0Eq Quadratic Input, will not necessarily be precise, and should not be used for later processing. Numerically better methods for Sqrt0 Evaluator (448) are described later.

FIG. 21A, Branch Cut Evaluator (450): this component determines the BranchCutValue, of FIG. 19D Branch Cut Sign, using delta processing methods. The BranchCutValue equals (−a1/2+(a3/4)*u)). This is precisely and straightforwardly found using general delta processing. Of course, additive delta processing is also possible with the necessary post-scaling, as described elsewhere.

### Sqrt1 Divide Mode

FIG. 21B, Sqrt1 Divide Mode, shows a different full precision implementation of the Coefficient Manager (430) where the Sqrt0 value is not calculated using delta processing; the Coefficient Manager(430) here is renamed to the Sqrt1 Divide Solver(436) for an implementation. Recall FIG. 20C BCS Usage. The “Divide by Sqrt1” method is utilized which involves a simple divide to find the Sqrt0 value; also, the BCS adjustment is automatically done by this same divide.

FIG. 21B, Sqrt1 Divide Solver (436): this component replaces the Coefficient Manager(431) of FIG. 21A. It performs all the work to find quadratic coefficients, with full precision by calling delta evaluators, but without the need to call the more difficult Sqrt0 Evaluator (448). Non-delta processing is performed directly, such as calculating the productNO as Precise[a0], as shown in FIG. 20B m0p0Eq Quadratic. As shown, three previously described evaluators are called. However, the Sqrt0 Evaluator (448) is not called because the Part0 value, of FIG. 19, is set to the BranchCutValue divided by Sqrt1, as indicated by the “Divide by Sqrt1” mode in FIG. 20C, BCS Usage. But wait, there is a special case. What if Sqrt1 is zero, which makes the divide by Sqrt1 meaningless. In such a special case, call either of the methods of the Sqrt0 Zero Direct Resolver (460) to obtain Part0 and Part1. Now use these resulting Part0 and Part1 values as the root pair differences, along with the corresponding root-pair sums and products and make the two calls to the Precision Quadratic Solver (202) to find {{M0,P0},{M1,P1}}. As in regards to the evaluators, the productN1 Evaluator (444) and Sqrt1 Evaluator (446) were previously described. Later, below, find the description for Branch Cut Evaluator (450).

FIG. 21B, Sqrt1 Zero Resolver (460) & Best Mode: this component is called only when Sqrt1 (for the specific u root under consideration) is zero. Two different implementations are provided: Sqrt1 Zero Direct Solver (462) or Sqrt1 Zero Coefficient Solver (464), the former is likely far faster as it involves only one simple call to Precise (812) of FIG. 3A Numeric Utilities. Choose an implementation. The parameters for each method are described. For all cases of Inner1 equal zero (e.g., Sqrt1 equals 0), Part1 equals 0, and the resulting Sqrt [Inner0] can use either of the Sqrt branch cuts and Part0 equals this Sqrt0 value. Of the two methods described, the first one, Sqrt1 Zero Direct Resolver (462) is simpler and faster.

FIG. 21B, Sqrt1 Zero Direct Solver (462): this component is used when Sqrt1 is zero. Using Precise (812), of FIG. 3A Numeric Utilities, evaluate Inner0=Precise[1/16 (−16 a0+a2\hat{ }2−2*a2*a3\hat{ }2+a3\hat{ }4)]. Then Part0=Sqrt0=Sqrt[Inner0], and Part1=0. Consider saving and reusing the resulting Part0 value when processing all three sets of {{M0, P0},{M1, P1}}, one for each u root. Derivation: Consider. If Sqrt1 is equal to zero it implies that Inner1, of FIG. 19C Quadratic Coefficients, equals (u−(a2−(a3\hat{ }2)/4)) also equals zero, which implies u exactly equals (a2−(a3\hat{ }2)/4); therefore when Inner1 is zero, with substituting (a2−(a3\hat{ }2)/4) for u, we have Inner0=(u\hat{ }2)/4-a0=Precise[-a0+1/64 (−4 a2+a3\hat{ }2)\hat{ }2], after substituting (a2−(a3\hat{ }2)/4) for u. Remember, this is the Inner1 value, so you must take its Sqrt to obtain Sqrt0. Part0 is set to either +Sqrt [Inner1] or −Sqrt [Inner1]. The sign doesn't matter because the correct roots are always chosen for this root-pair difference. QED.

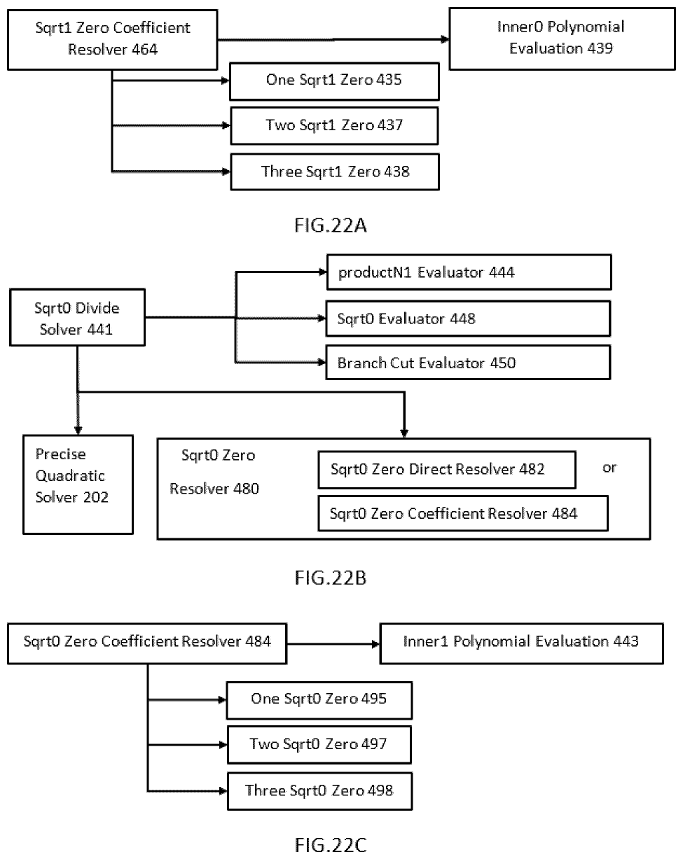

FIG. 22A, Sqrt1 Zero Coefficient Resolver (464): this component is an alternative to Sqrt1 Zero Direct Resolver (462). It is a much more complicated method for eliminating the divide by zero in the Sqrt1 Divide Solver (436). See FIG. 22A, Sqrt1 Alternate Resolver, immediately following, for details on this component.

FIG. 22A, Sqrt1 Alternate Resolver, shows the internals of Sqrt1 Zero Coefficient Resolver (464), which is used when Inner1 is zero, and therefore Inner1 cannot be used as a divisor. This approach is not usually recommended as a replacement for Sqrt1 Zero Direct Resolver (462) but is included for completeness. However, if all three Derived Cubic Polynomial u-roots are being processed to compute three sets of coefficients, {{M0,P0}, {M1,P1}}, then this method might be a useful choice. Let ZeroCount equal the number of Inner1 values which are zero (up to 1 per u root). If ZeroCount is zero, this method is never needed or invoked! Otherwise, first find precise coefficient values for a specially constructed polynomial, called Inner0 Polynomial, by calling Inner0 Polynomial Setup (439), and then dispatch to a zero method based on whether ZeroCount is one, two or three: One Sqrt1 Zero(435), Two Sqrt1 Zero (437), and Three Sqrt1 Zero(438), respectively. The returned values are {{u1Part0,u1Part1}, {u2Part0,u2Part1}, {u2Part0,u2Part1}}. As parameters, include all three Inner1 values from FIG. 19C, called {u1Inner1, u2Inner1, u3Inner1}: one result for each u root of the Derived Polynomial of FIG. 19B, Derived Cubic Polynomial. Also, where the Inner1 value is non-zero, the corresponding Sqrt0 values are computed by dividing the BranchCutValue/Sqrt[Inner1].

FIG. 22A, The Inner0 Polynomial Evaluation (439), of FIG. 22A Sqrt1 Alternate Resolver, uses the Precise(812) method, of FIG. 3A Numeric Utilities, to evaluate the coefficients of the Inner0 Polynomial. Let's construct the coefficients of the Derived Cubic polynomial of FIG. 19B. Remember that the Derived Cubic Polynomial has roots {u1, u2, u3}. Now, take the coefficient expressions of the Derived Cubic Polynomial of FIG. 19B, calling them {c0, c1, c2}, and insert these coefficient values into the corresponding {c0, c1, c2} values of the Cubic Squared Roots Polynomial of FIG. 9B, namely: (−c0\hat{ }2+(c1\hat{ }2−2 c0 c2) x+(2 c1−c2\hat{ }2) x\hat{ }2+x\hat{ }3). The result is again a cubic polynomial with roots of this new polynomial equal to {u1\hat{ }2, u2\hat{ }2, u3\hat{ }2}; call this polynomial the Derived Cubic Squared Polynomial. Then the required cubic polynomial, the Inner0 Delta Polynomial, is finally found by using the cubic general delta form of FIG. 3B Delta Polynomials, where k=(−a0) and s=(1/4), applied to the Derived Cubic Squared Polynomial. The k and s values are found in the delta expression of Sqrt0 of FIG. 20B m0p0Eq Quadratic. The coefficients of the Inner0 Polynomial are then called {c0Inner0, c1Inner0 and c2Inner0}; the coefficients are evaluated using the previously described Precise (812) of FIG. 3A Numeric Utilities. Call these cubic coefficient precise values as {c0Inner0N, c1Inner0N and c2Inner0N}. The roots of this cubic are ((u\hat{ }2)/4−a0), once for each u roots. For cases 1 to 3 of Inner1 equal to zero, call the appropriate component as shown in FIG. 22A Sqrt1 Alternate Resolve. Note: this Inner0 Polynomial is never directly solved; instead, the coefficients are sufficient to find the roots.

FIG. 22A, One Sqrt1 Zero (435): this component is used when there is one Inner1 which is zero and two Inner1 which are non-zero. Arbitrarily, without loss of generality, let u1Inner1 be the Inner1 zero value. Then u2Inner1 and u3Inner1 are non-zero, and u2Part0=u2Sqrt0 and u3Part0=u3Sqrt0 are already known by dividing the BranchCutValue by u2Part1=Sqrt[u2Inner1] and u3Part1=Sqrt[u3Inner1], respectively. If u2Sqrt0 equals zero, then u3Sqrt0 is also zero, which is only caused by a BranchCutValue equal to zero; in such a case, the u1Inner0 value is equal to −c2Inner0N created by Inner0 Polynomial Evaluation (439), implying u1Part0=Sqrt[u1Inner0], and u1Part1 is, of course, zero. Otherwise, the u1Inner0 equals coInner0N/(u2Sqrt0*u3Sqrt0). In either case, reference FIG. 9A Cubic Polynomial Identities. Take either Sqrt branch cut for u1Part0=u1Sqrt0=Sqrt[u1Inner0], and u1Part1, is of course, zero.

FIG. 22A, Two Sqrt1 Zero(437), Introduction: in this case, there are two Inner1 which are zero, and one non-zero, Arbitrarily, without loss of generality, let u1Inner1 be the non-zero value. Then u2Inner1 and u3Inner1 are zero, and u1Part0 equals u1Sqrt0 is already known by dividing Sqrt u1Inner1 into the BranchCutValue. u2Part1 and u3Part1 are found to be zero by taking the Sqrt of zero, as in Inner2==Inner3==0. Note that u2Sqrt0 and u3Sqrt0 are yet unknown, but equal, because their associated roots are equal. Why? Because u2Inner1 equals u3Inner1 (both zero). For the remaining discussion set u1Part0 to BranchCutValue/u1Part1u1.

FIG. 22A, Two Sqrt1 Zero(437), u1Part0 Equal Zero: This is a very special case. If u1Part0, the only known Part0, is zero, then the BranchCutValue must also equal zero; in such a very special case, the missing u2Inner0 and u3Inner0 values are equal to-c2Inner0N/2 because −c2Inner0N is the sum of all three roots: Refer to FIG. 9A Cubic Polynomial Identities.

FIG. 22A, Two Sqrt1 Zero(437), u1Part0 Non-Zero: Now set u2Part0=u3Part0=Sqrt[u2Inner0] (use either Sqrt branch cut but use same value for both), and u2Part1=u3Part1=0 by assumption of this case. With u1Sqrt0 non-zero, by assumption, then u2Inner0 and u3Inner0 are equal. and equal to one of the square roots of c0Inner0N/u1Inner0, but which branch cut of the square root? Now consider another value, the desired unknown u23Inner0 which is equal to both unknowns u2Inner0 and u3Inner0. Let u23Inner0Squared define the unknown product (u23Inner0*u23Inner0). But the actual true value of u23Inner0Squared is easily found by (c0Inner0N/u1Inner0), where u1Inner0 is previously computed, and, −c0Inner0N is the product of u1Inner0*u23Inner0Squared-see CubicRootProduct of FIG. 9A Cubic Polynomial Identities. Therefore, let u23Inner0Ambiguous=Sqrt[U23Inner0Squared] is one of the two possible square roots of u23Inner0Squared: pick one. We need to determine the sign, e.g. branch cut, of u23Inner0Ambiguous =Sqrt[u23Inner0Squared]. Let sumInner0 be the sum of all the three Inner0 root values, {u1Inner0, u23Inner0Ambiguous, u23Inner0Ambiguous}. To avoid cancellation, two separate cases arise for finding the correctly signed u23Inner0Ambiguous; these two cases are described below. Once found, call this correctly signed u23Inner0Ambiguous, as U23Inner0True, which is either u23Inner0Ambiguous or −u23Inner0Ambiguous. This fix-up is described below as Case 1 of Group Case 2 (438) or Case 2 of Group Case 2 (438): After executing the appropriate method, described next, the final values u2Part0 and u3Part0 are set to one of the square roots of u23Inner0True, and u2Part1 and u3Part1, are set, of course, to zero. But now, here are the descriptions of the two methods to complete the process of finding u23Inner0True from u23Inner0Ambiguous.

FIG. 22A, Case 1 of Two Sqrt1 Zero(437): Consider the case where Abs[u23Inner0Ambiguous]>Abs[u1Inner0], where u1Inner0 was previously constructed and the sign of u23Inner0Ambiguous makes no difference due to the absolute value; the precise value for both of the equal and missing Inner0 roots, namely u2Inner0 and u3Inner0, can be found as u23Inner0True=(sumInner0−u1Inner0)/2, where sumInner0 was described above in Two Sqrt1 Zero(437). Note that sumInner0 is equal to u23Inner0True+u23Inner0True+u1Inner0. And subtracting u1Inner0 from times the larger u23Inner0True can have no significant cancellation: subtracting a much smaller magnitude from a large number does not cause significant cancellation.

FIG. 22A, Case 2 of Two Sqrt1 Zero (437): Otherwise, the only other case of Group Case 2 (438), where Abs[u23Inner0Ambiguous] is less than or equal to Abs[u1Inner0], uses an alternative method to avoid cancellation. Now, c1Inner0N is the sum of the paired root products, per CubicPairedSum of FIG. 9A Cubic Polynomial Identities. Let's subtract c1Inner0N from its definition value and see if it produces nearly zero. Substituting u23Inner0Ambiguous, whose sign is still in doubt, for both u2Inner0 and u3Inner0, we have TestZero=(c1Inner0N−(u1Inner0*(u23Inner0Ambiguous+u23Inner0Ambiguous)+(u23Inner0Ambiguous*u23Inner0Ambiguous)), which should, if the unknown sign is correct, be nearly zero. Let's substitute u23S=-u23Inner0Ambiguous for u23Inner0Ambiguous in the same expression and call the resulting expression value MinusTestZero. If MinusTestZero is closer to zero than the TestZero, then u23Inner0True is set to u23S; otherwise, u23Inner0True=u23Inner0Ambiguous. The missing u2Part0 and u3Part0 is then the square root of u23Inner0, with u2Part1=u3Part1=0.

Three Sqrt1 Zero(438), FIG. 22A, Case Three Sqrt1 Zero(438): For Three Sqrt1 Zero(438), there are three Inner1 zero values. But that means that all Inner1 delta roots for uInner1, for u={u1,u2, u3}, are zero, and equal! In this case, all three u values, {u1,u2,u3}, must also be equal to the same value because all three {u1,u2,u3} are equal. Therefore, all three Inner0 values are also equal, and must sum to −c2Inner0N, a polynomial identity CubicPairedSum, of FIG. 9B Paired Root Summation. Therefore, each Inner0 is equal to same value, −c2Inner0N/3. All three missing Part0 are set to Sqrt[−c2Inner0N/3], and all three Part1 equal 0.

### SQRT0 Divide Mode

FIG. 22B: this figure is analogous to FIG. 21B, except that names are changed: In FIG. 22B, Sqrt0 is swapped with Sqrt1, Part0 is swapped with Part1, and Inner1 is swapped with Inner0. Any other minor changes are noted in the descriptions below.

FIG. 22B, Sqrt0 Divide Solver(434): this component is analogous to Sqrt1 Divide Solver(436) of FIG. 22A and the Brute Force Solver (453) of FIG. 21A. Here, Sqrt0=Part0 is directly computed. That means that Sqrt1 and Part1 are computed as the BranchCutValue/Sqrt0, unless Sqrt0 is zero. The key issue is what to do when Sqrt0 is zero, and no divide is possible.

FIG. 22B, Sqrt0 Zero Resolver(480): this component resolves any issue when Sqrt0 is zero and the division cannot take place, and is implemented by merely calling either Sqrt0 Zero Direct Solver(482) or Sqrt0 Zero Coefficient Solver(484), the former is likely faster as it involves only one Precise(812) evaluation. The parameters for each method are described. For all cases of Inner0 equal zero, Part0 equals 0. What does it mean that Sqrt0 is zero? It means Part0 and −Part0 are zero. Now Part0 is the root-pair difference of coefficients M0 and P0. For example, M0=4*5 and P0=10*2 will cause Part0 to be zero.

FIG. 22B, Sqrt0 Zero Direct Resolver(482): this component is analogous to Sqrt1 Zero Direct Resolver (462) of FIG. 21B. The Sqrt0 Zero Direct Resolver(482), of FIG. 22B Sqrt0 Divide Mode, is used for the Sqrt0 Divide Solver(441). Derivation for Zero Divide: Consider. If Sqrt0 is equal to zero it implies that Inner0, of FIG. 19C Quadratic Coefficients, which equals (u\hat{ }2)/4−a0 also equals zero, which implies u equals −2Sqrt[a0]or 2Sqrt[a0], but which Sqrt branch cut should be used? Pick one the branch which is closest to the u-root. Then Inner1, is found by substituting the u in the expression ((−a2+(a3\hat{ }2)/4)+u), and evaluating with Precise(812).

FIG. 22B, Sqrt0 Zero Coefficient Resolver(484): this component is almost identical to Sqrt1 Zero Coefficient Resolver(464) of FIG. 21B, except in the construction of the Inner1 Polynomial constants. The construction is simpler, as described next. Note, that the implementation of Sqrt0 Zero Coefficient Resolver (484), including {One Sqrt0 Zero(495), Two Sqrt0 Zero(497), Three Sqrt0 Zero(498)} is analogous to corresponding components in Sqrt1 Zero Coefficient Resolver(464) of FIG. 21B.

FIG. 22C is analogous to FIG. 21A, except that names are changed: In FIG. 22C, Sqrt0 is swapped with Sqrt1, Part0 is swapped with Part1, and Inner1 is swapped with Inner0. Any other minor changes are noted in the descriptions below. The Sqrt0 Zero Coefficient Resolver (484), of FIG. 22C, is almost identical to Sqrt1 Zero Coefficient Resolver(464) of FIG. 21B, except in the construction of the Inner Polynomial, herein called Inner1 Polynomial.

FIG. 22C, Inner1 Polynomial Evaluation (443): Lets construct the coefficients of the Inner1 Polynomial using the Derived Cubic of FIG. 19B Derived Cubic. Remember that the Derived Cubic Polynomial has roots {u1,u2,u3}. Now, take the coefficient expressions of the Derived Cubic Polynomial, calling them {c0,c1,c2}, and insert these coefficient values into the corresponding {c0,c1,c2} values of the Cubic Additive polynomial of FIG. 3B. The additive ‘k’ value is set to (−a2+(a3\hat{ }2)/4), as shown in the rootDiffN1 delta of FIG. 20A m1p1Eq Quadratic. This produces the Inner1 Polynomial constants. From the coefficients, using Precise(812), compute the precise coefficients as {cOInner1N, c1Inner1N and c2Inner1N}.

FIG. 22C, One Sqrt0 Zero(495): this component is analogous to One Sqrt1 Zero(435) of FIG. 22A, Sqrt1 Alternate Resolver with swaps between “0” and “1” named suffixes, as described above for FIG. 22C Sqrt0 Alternate Resolver.

FIG. 22C, Two Sqrt0 Zero(497): this component is analogous to Two Sqrt1 Zero(437) of FIG. 22A, Sqrt1 Alternate Resolver with swaps between “0” and “1” named suffixes, as described above for FIG. 22C Sqrt0 Alternate Resolver.

FIG. 22C, Three Sqrt0 Zero(498) : this component is analogous to Three Sqrt1 Zero(438) of FIG. 22A, Sqrt1 Alternate Resolver with swaps between “0” and “1” named suffixes, as described above for FIG. 22C Sqrt0 Alternate Resolver.

Best Mode for Coefficient Manager (430): Consider the above methods of the Coefficient Manager (430) as shown in FIG. 21C. All can work well. The original Brute Force Solver (453) of FIG. 21A has more delta processing, but doesn't require a resolver, such as needed in Sqrt1 Divide Solver (436) and Sqrt0 Divide Solver(441). However, both the Brute Force Solver (453) and the Sqrt0 Divide Solver(441) must deal with taking a Sqrt within a high precision evaluation using Precise(812). Therefore, using Sqrt1 Divide Solver (436) as the Coefficient Manager (430) is likely the best. For the Sqrt1 Divide Solver (436), Best Mode, which version of Sqrt1 Zero Resolver(460) should be used when Sqrt1 is computed as exactly zero? The Sqrt1 Zero Direct Resolver (462) involves only one Precise(812) evaluation, and is far less complicated. Also, for the Sqrt1 Zero Direct Resolver (462), the BCS correction is not explicitly needed (but the branch cut value is still used) because the dividing the branchcutvalue by Sqrt1 automatically corrects branch cut incompatibility.

Best Mode Delta Processing: Using the best mode of Sqrt1 Divide Solver (436), three delta values are required: the BranchCutValue of FIG. 19D, productN1 of FIG. 20A, and rootDiffN1 (as Part1) of FIG. 20A. The BranchCutValue obviously requires general delta processing because of the a3/4 scaling of u.

### Quick Quartic Processor

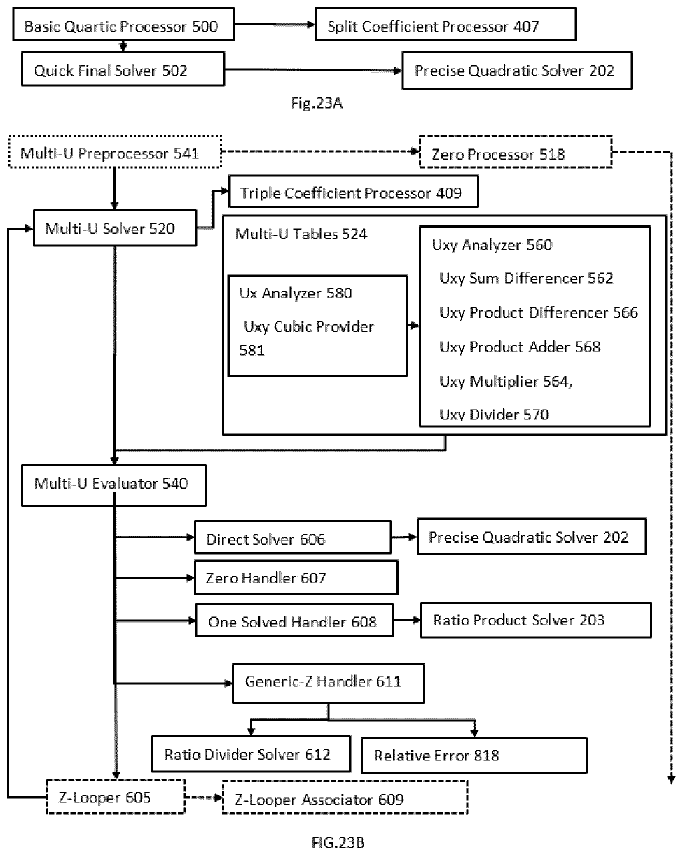

In FIG. 23A Quick Quartic Processor: the processing of the Basic Quartic Processor (500) is shown. The input is the coefficients of a quartic equation, and the output is the four roots of the quartic equation. The Basic Quartic Processor (500) passes the input to the previously described Split Coefficient Processor (407), which produces the {M0, M1, P0, P1} coefficients. Then, the Quick Final Solver (502) is called to produce the four quartic roots, at guaranteed half precision.

In FIG. 23A Quick Quartic Processor: the Quick Final Solver (502) takes the Coefficients, {M0, M1, P0, P1} as output from the Split Coefficient Processor(407), described above and calls the Precise Quadratic Solver (202), twice, to find the total of four final roots. The first call uses −M1 as the sumN parameter, and M0 as the productN parameter for the Precise Quadratic Solver (202). This guarantees that the final roots are ½ the precision of the {M1, M0} coefficients. Similarly, two roots are found using −P1 and P0 as parameters. See description of the Precise Quadratic Solver (202) explaining why only ½ precision −is assured whenever the root-pair difference is not provided.

### Multi-U Preprocessor (Optional Zero Processor)

FIG. 23B Multi-U Preprocessor (541): FIG. 23B diagrams processing of a quartic polynomial that results in full precision roots. At the top of the diagram, the optional Multi-U Preprocessor (541) is shown. This component checks to see if the a0 coefficient of the quartic is zero; if so, it reduces the equation by dividing through by x and solves the resulting cubic. The appropriate root-pair sums and differences of the zero are trivial, and other roots and root-pair data are found in solving the cubic. If a0 is non-zero, then the full quartic is solved using the FIG. 23B Multi-U Solver. Note that the FIG. 23B Multi-U Solver can be designed to handle these same zeroes, as described below, which might improve SIMD performance. Therefore, the Multi-U Preprocessor (541) is considered optional.

FIG. 23B Zero Processor (518): this component, at the top-right of FIG. 23A, is optional. It can be called when the quartic's a0 coefficient is zero. When used, it is done prior to all other quartic processing. When a0 is zero, the quartic degree is reduced by 1 by dividing by x. For example, x4+a3*x\hat{ }3+a2\hat{ }x2+a1*x+0 becomes x\hat{ }3+a3*x\hat{ }2+a2*x +a1. Similarly, the reduction to a quadratic, or linear is performed. Then the lower degree polynomial is solved, including root-pair sums and differences; then, finally, the previously eliminated zeros are added to the root list, together with its trivial calculation of root-pair sums and differences with the non-zero roots. This special case can also be fully handled within the full quartic process, which might improve parallel processing of quartics. Why? Because in a parallel system, all other threads will need to wait for this special case cubic solving code.

### Multi-U Processing

FIG. 23B Multi-U Solver (520): a complete quartic solution is provided by the Multi-U Solver (520): all correctly associated precise roots, and precise root-pair sums and differences are calculated. The input is the quartic polynomial. As shown in FIG. 23B, Multi-U Solve, the two main components are the Triple Coefficient Processor (409) and the Multi-U Solver (520). Also, an optional Z-Looper (605) can be added to loop through the Multi-U Evaluator (540) three times. The Triple Coefficient Processor (409) is called to return all three coefficient sets, {UxSet, UySet, UzSet} of quadratic coefficients, {M0, M1, P0, P1}. The six root-pair sums are obtained from the three sets as {−M1,−P1}. Then the Multi-U Evaluator (540) is called to process one set of quadratic coefficients using all three sets of quadratic coefficients to obtain precise roots and two root-pair differences. Although all six root-pair sums can be read directly from the three quadratic coefficients, if all six root-pair differences are needed, then the Z-Looper (605) is called. Processing all three quadratic coefficients allows the return of all root-pair differences and three sets of four quartic roots with different ordering of roots. Typically, only one set of roots is needed!

FIG. 23B Triple Coefficient Processor (409): based on a single u-root of the derived cubic polynomial, the Split Coefficient Processor(407), previously described, typically produces quartic coefficient results, one set of {M0,P0,M1,P1} coefficients. However, the Triple Coefficient Processor (409) produces a quadratic coefficients set for each of the three u-roots of the derived cubic polynomial, called {UxSet, UySet, UzSet}. The Split Coefficient Processor (407) actually, and almost, produces these same three sets because all u-roots are simultaneously processed during the delta process within Split Coefficient Processor (407). Therefore, the Triple Coefficient Processor (409), simply returns all three sets. Note, that if only the six root-pair sums (or root-pair products) are needed, two root-pair results can be trivially derived from each quadratic coefficient set, as in {−M1,−P1} for root-pair sums and {M0,P0} for root-pair products. Also, as described later, several more items may be returned for each of the sets, {UxSet, UySet, UzSet}, but these additional items are already produced as part of the normal process: See Uxy Sum Differencer(562), below.

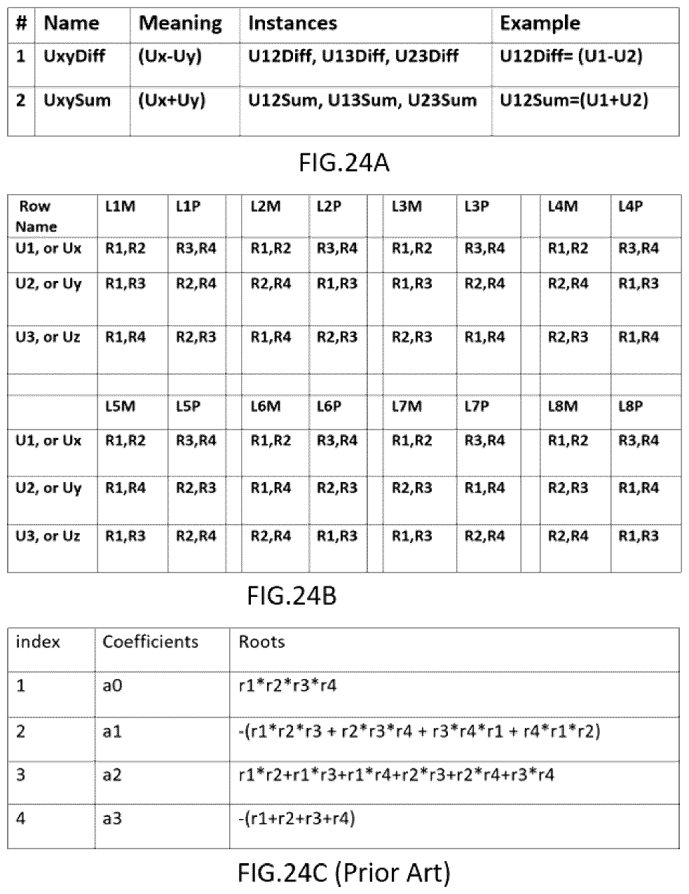

FIG. 24B Quartic Root Layouts, Part1: As a foundation to later discussion, consider FIG. 24B Quartic Root Layouts, which shows how the final roots can be laid out within the three quadratic coefficient sets. This layout is the foundation to achieving full precision. The four roots, e.g. {{R1, R2}, {R3, R4}}, are paired to the corresponding MinusEq and PlusEq equations. The roots for the Ux pairs always are named as {{R1, R2}, {R3, R4}} for all possibilities. The ordering within each pair is not shown: thus {R1, R2} is the same as {R2, R1}. Eight possible arrangements are possible. In general, you will never need to know the layout index, 1-8, but it is useful to understand. The key to understanding the relationships between two or more u roots, is found in FIG. 24B Quartic Root Layouts, which shows all eight possible quartic root layouts. The leftmost column specifies the three U roots, {Ux, Uy, Uz}, also called {U1, U2, U3} of the derived cubic polynomial. For each layout, there is a digit, 1 to 8, to specify the layout index, as in L1M and L1P, specifying the layout 1 roots embedded in the coefficients of MinusEq equation, ‘M’ suffix, and L1P for PlusEq equations, ‘P’ suffix, of FIG. 19E Quartic Roots (Prior Art), respectively. So, let LdUnM and LdUnP represent the two sets of two roots represented coefficients of MinusEq and PlusEq for layout index ‘d’ with root Un of the Cubic Derived polynomial. Each of the eight layouts has the same named roots for the U1 row. Thus, no matter the layout, these roots are named by their location in their MinusEq and PlusEq equations. In U3 (or Uz) rows contain roots for the UzMinusEq and UzPlusEq that are being evaluated.

FIG. 24B Quartic Root Layouts, Part 2: For any paired roots in the layout, the two roots are defined by the solution to corresponding MinusEq or PlusEq quadratic equation. In every Un row, for any layout, the LdM and LdP values, contain 2 pairs of 2 roots; in any given pairing of {LnUmM, LnUmP}, four distinct roots are indicated, {R1, R2, R3, R4}. In any specific layout (for one quadratic coefficient set), no pair of roots is ever repeated, and all possibilities are included; thus, the U1 pairs of {R1, R2} and {R3, R4} never occur for any U2 or U3 row. The quadratic coefficients for layouts are defined by these roots. For example, for layout 1, row U1, L1U1M: c1=−(R1+R2) and c0=R1*R2 as coefficients of quadratic U1MinusEQ. And L1U1P: c1=−(R3+R4) and c2=R3*R4, for coefficients of quadratic U1PlusEq. The L1U2 and L1U3 rows are filled, with choices meeting these rules: Layout 2 is the same as Layout 1 except root pairs in L2U2M and L2U2P are reversed and set to L1U2P and L1U2M, respectively. Layouts 3 and 4 are the same as layouts 1 and 2, respectively, except in the same fashion the root pairs of the U3 row are reversed. Finally, layouts 5 to 8 are the same as layouts 1 to 4, respectively, except entries for the U2 and U3 rows are swapped. The exact ordering of the layouts is immaterial.

FIG. 24B, Use of Quartic Root Layouts: For any given quartic, the actual layout number in the Quartic Root Layouts, of FIG. 24B Quartic Root Layouts, need never be determined! However, in this description, a particular layout number is sometimes indicated in the description when showing an example. E.g., layout 1 roots are often used as an example.

FIG. 24B, Note On Use of Uz: For most of the remaining discussion, the goal, for some Uz root is to find the roots and root-pair differences of UzMinusEq and UzPlusEq, FIG. 19E Quartic Roots, by utilizing results from UxSet and UySet quadratic coefficient sets, where x and y are unique and different from z. Thus, in general, results from {UxSet, UySet} are all used to find the roots and root-pair differences for UzMinusEq and UzPlusEq. Of course, the root-pair sums are also known from the UzSet of quadratic coefficients {UzM0, UzM1, UzP0, UzP1} as −UzM1 and −UzP1, respectively.

FIG. 23B Multi-U Tables (524): This component, shown underneath the Triple Coefficient Processor (409) simply collects together all the tables of data that can be derived from the three sets of quadratic coefficients returned by the call to the Triple Coefficient Processor(409). The tables can be considered virtual, with table elements created on-the-fly as needed. Not all tables are needed, as the table needs depend on the chosen method, which in this case is the Multi-U Evaluator (540).

FIG. 23B Ux Analyzer (580): this component is shown within the box surrounding Multi-U Tables (524) and includes two important tables derived from the quadratic coefficients. The Uxy Cubic Provider (581) is described after the description of FIG. 24A Uxy Cubic Data. The Uz Data Provider (582) is described below.

FIG. 24A Uxy Cubic Data, Uxy Cubic Provider (581): this table shows root-pair data derived for the u-roots of the derived cubic polynomial, and shows the data provided by the Uxy Cubic Provider (581), described below. Given a UzSet of quadratic coefficients for a Uz root, this table shows the root-pair sum and directed difference for two paired u-roots. Refer to methods of solving cubic equations. For the directed difference of the remaining two roots, refer to the Triple Root Pair CRS method of the Cubic Root Difference Solver(349). The FIG. 23B: the Uxy Cubic Provider (581) provides the data of FIG. 24A, Uxy Cubic Data, which was computed when solving for the roots of the derived cubic polynomial of FIG. 19B, previously described. The UxyDiff row of this table is critical to guaranteeing that quartic directed root-pair differences are precisely computable but is not needed to find the precise quartic roots. The UxySum row is not currently used. Details are provided later.

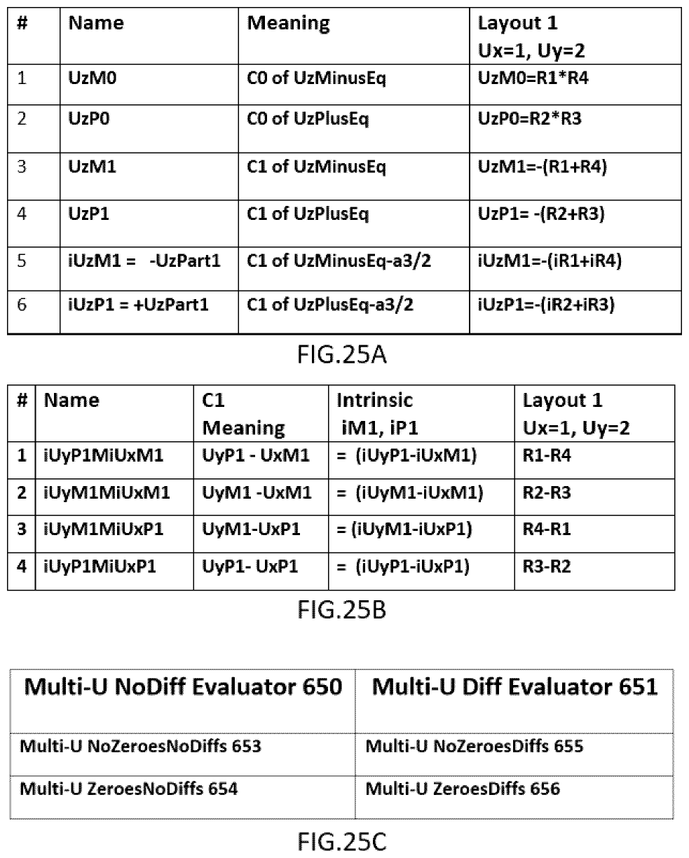

FIG. 25A Uz Data, Introduction: this figure shows nomenclature for the data provided by the Uz Data Provider (582)of FIG. 23B Multiple U Solver. The table only shows values constructed from the Uz root. Two additional tables are NOT shown for values similarly constructed for Ux and Uy; for example, in the first row, where UzM0 is described; for Ux and Uy, the nomenclature for this row is UxM0 and UyM0. To construct sample values for layout 1 (or any layout), look at FIG. 24B. For layout 1, the value for UxM0 and UyM0 are {R1, R2} and {R1, R3}, respectively, as shown in the L1M columns for Ux and Uy. Similarly, other sample values can be constructed. In actual practice, the actual determination which layout is not critical.

FIG. 25A Uz Data, Details: Rows 1 to 4 of the table values refer to c0 and c1 coefficients of UzMinusEq and UzPlusEq. Refer to descriptions of FIG. 21A through FIG. 22C for the methods used to calculate these coefficient values. Rows 5 and 6 refer to plus and minus the Part1 value for the specific Uz: see FIG. 19C, Quadratic Coefficients. The sum and products of possible final root pairings are shown with their nomenclature; these values are the same {M0, M1, P0, P1} coefficients already processed. But with three U-roots, each generating a quadratic coefficient, {M0, M1, P0, P1}, an expanded nomenclature is shown for the underlying U root as one of {Ux, Uy, Uz}. With layout 1, for example, UzM0 is the M0 coefficient derived from the Uz root. The co values refer to the c0 coefficient of a quadratic equation of FIG. 1A Polynomial Types and represents the product of two of the final four quadratic roots, specific to the root-solution of the associated MinusEq or PlusEq equation. Similarly, the C1 values are the negated sum of the same roots used to produce the c0 product value. In the last column, “Example”, the Uz created roots for UzMinusEq are assumed to be {R1, R2}, and the roots for UzPlusEq are {R3, R4}, as correlated to sample layout 1 of FIG. 24B Quartic Root Layouts.

FIG. 25A Uz Data, Intrinsic Partial Values: Note that because Uz can be one of three roots, for two equations, there are six C0 coefficient values and six C1 coefficient values. All are used to find the precise quartic roots, and their precise differences. Note that each of these coefficient values can have sub-components as defined in FIG. 19C Quadratic Coefficients (Prior Art). Consider rows 5 and 6 of FIG. 25A UzData, which shows the sum of two intrinsic roots. By dropping the a3/2 part of the C1 expression, the summation expression of any pair of intrinsic roots is instantly uncovered. Where forth comes a3/2? See the M1 and P1 values (which are really c1 values) found in FIG. 19C Quadratic Coefficients. {iM1, iP1} set: The intrinsic values, {iUxM1, iUyM1, iUzM1} and {iUxP1, iUyP1, iUzP1}, are referred to as a {iM1,iP1} set, and are critical to determining quartic root-pair differences, as described in FIG. 25B, UxySumDiffData, and from Uxy Sum Differencer (562).

FIG. 23B, Uz Data Provider (582): this component provides access to all the data in FIG. 25A, Uz Data. Note: the rows 5 and 6 of FIG. 25A are needed for finding quartic root-pair differences, in addition to the UxyDiff (row 1) of FIG. 24A. All other values are derived from the coefficients {M0, M1, P0, P1} for each u-root. The provider may access the table, or if the table is “virtual,” then the provider calculates the answer. This table shows 6 rows applicable to the UzSet, but the UxSet and UySet each create 6 more correspondingly constructed rows.

In FIG. 23B, Uxy Analyzer (560): this component performs additional analysis on the previously described UzData and xyCubicData, as mentioned for FIG. 24A, Uxy Cubic Data and FIG. 25A, UzData. Access is provided by the Uxy Cubic Provider (581) and Uz Data Provider (582), as just described. All needed results are fed into the Multi-U Evaluator (540) of FIG. 23B Multi-U Solver. Not all the sub-components can always produce precise results; but when a precise result cannot be computed, the necessary computations can be determined with a different sub-component.

In FIG. 23B, Uxy Analyzer (560), continued: Below, for operations involving ‘x’, for UxSet, and ‘y’, for UySet, u-root indices, {1,2,3}, sub-components can operate on the three needed possibilities for {x,y} u-root sets: {{1,2}, {1,3}, {2,3}}. If for example, {x,y} is {1,2}, then the other index is the ‘z’ index, as in index 3. The data is constructed from the results of only two of the three U-roots, Ux and Uy, and used to find the final roots in the UzMinusEq and UzPlusEq equations of the third U-Root, Uz! When processing all three u-roots via the component Z-Looper (605), of FIG. 23B, then the three sets of {x,y,z} could be:{ {1,2,3}, {1,3,2}, and {2,3,1}}. Many of the later tables show an example of roots based on Root Layout 1, with { x=1, y=2, z=3}. The Multi-U Evaluator (520) allows for many separate implementations, each requiring specific input data; the choice for implementation for the Multi-U Evaluator (540) determines which sub-components of the Uxy Analyzer (560) actually need to be implemented. Refer to the Multi-U Evaluator (540), described later.

FIG. 25 B, UxySumDiffData: this component analyzes quadratic coefficient relationships between the UxSet and UySet. It shows the ‘Meaning’ of the subtraction of one c1 coefficient from one c1 coefficient of a different u root. Amazingly, this subtraction, provides the difference between two roots. Which roots are differenced? It depends upon the root layout. What is the layout of roots in any case? Unknown. None-the-less, the results are useful, as described later. The x and y indices are the two indices remaining after the z-root index is specified. The M1 and P1 values should not be used as implied by the “C1 meaning” column because of possible cancellation. Instead, their intrinsic versions of C1 must be used, which do not include the −a3/2; if the intrinsic values are not available, then this table is not used. For the intrinsics (as {iM1,iP1} set) refer to the above paragraph “FIG. 25A Uz Data, Intrinsic Partial Values” rows 5 and 6.

FIG. 23B, Uxy Sum Differencer (562) Calculations: The Uxy Sum Differencer (562) is shown in FIG. 23B provides the data of FIG. 25B UxySumDiffData. Here, with two different U rows, say Ux and Uy, two precise root-pair differences are found from intrinsic part {M1,P1} root-pair sums for each u-root: {iM1,iP1} set. Since only the intrinsic part is required, instead of using {UxM1, UxP1, UyM1, UyP1}, only use {iUxM1,iUxP1, iUyM1, iUyP1} as needed; these values are produced as part of computing the {UxM1, UxP1, UyM1, UyP1} values. Of course, the subtraction of one coefficient from another may produce massive cancellation. Here, the “Intrinsic Meaning” column of FIG. 25B, UxySumDiffData, is utilized: Let A=minuend, and B=subtrahend. For example in row 2 let A=iUyM1 and B=iUxM1. Then if Abs[A−B] is at least as large as Abs[A+B], then A-B is the precise result. Otherwise, the precise result is (A\hat{ }2−B\hat{ }2)/(A+B). Now (A\hat{ }2−B\hat{ }2) equals (-UxyDiff), where UxyDiff is already computed in FIG. 24A, Uxy Cubic Data; this is easy to show by expanding (iUyM1\hat{ }2−iUxM1\hat{ }2), see below. Thus, the precise result is (−UxyDiff)/(A+B) whenever (A−B) suffers cancellation. The other row calculations are similarly resolved to precisely correct values. Note that because iUzM1 and iUzP1 utilize just the Part1 values from FIG. 19B, the construction of these values, for z={1,2,3}, requires only the Part1 values, and not the full coefficients.

FIG. 23B, Uxy Sum Differencer (562) Redundancies: For each U root, there are four values in the table of FIG. 25B. However, only rows 1 and 2 need be calculated, because rows 3 and 4 are the negation of rows 1 and 2.

FIG. 23B, Uxy Sum Differencer (562) Looping: If the process is iterated over all three U roots using the Zlooper (605), then all six root-pair differences for the quartic, are found, which may be sufficient for your application; if sufficient, considerable computation is saved because delta processing is limited to producing the Part1 value for all three roots. When roots and root-pair differences are required, then when processing the final roots, the Part1 values are saved so that they can be used for the intrinsic M1 and P1 values, e.g. {iUxM1, iUxP1, iUyM1, iUyP1}, which are needed for root-pair differencing.

FIG. 23B, Uxy Sum Differencer (562), Derivation: (iUyM1\hat{ }2−iUxM1\hat{ }2)==(Sqrt[(−a2+a3\hat{ }2)+Ux])\hat{ }2−(Sqrt[(−a2+a3\hat{ }2)+Uy])\hat{ }2==((−a2+a3\hat{ }2+Ux)−(−a2−a3\hat{ }2−Uy))==(Ux−Uy). QED.

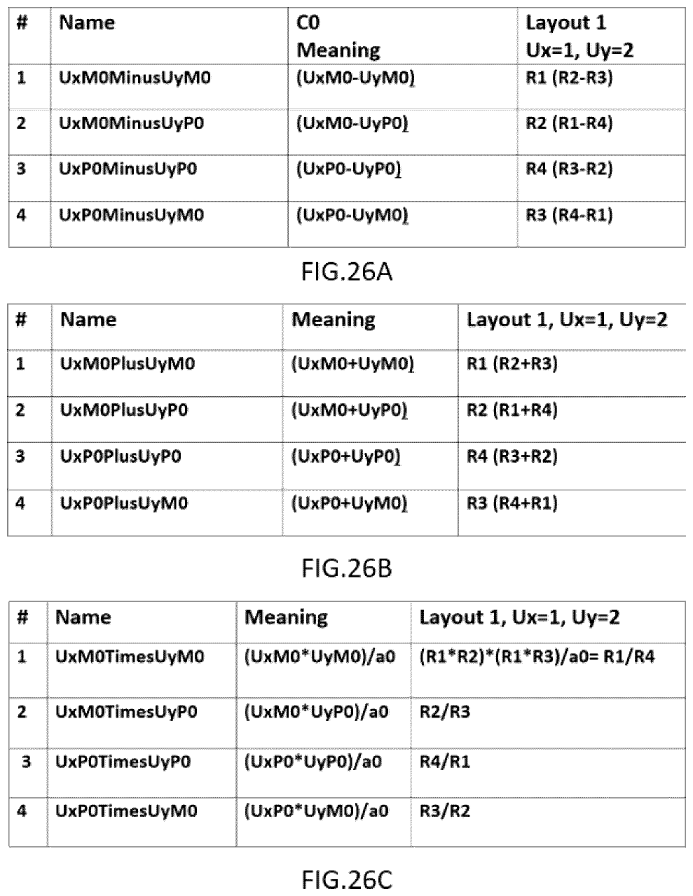

FIG. 23B, Uxy Product Differencer (566): this component applies subtraction to various M0 and P0 operand values and provides the data of FIG. 26A UxyProductDiffData.

FIG. 26A UxyProductDiffData: The table of FIG. 26A shows the results of differencing of various quadratic coefficients: a M0 and P0. This is like FIG. 25B, UxySum DiffData's which differenced M1's and P1's. The last column provides an example from layout 1. Other layouts are similar: The result is a root times the difference of two other roots. All expressions are easily calculated. However, unlike the UxySumDiffData results, some or all entries may have massive cancellation; none-the-less, the table values are easily calculated.

FIG. 23B, Uxy Product Adder (566): this component adds an M0 or P0 to a different u-root M0 or P0 and divides the result by a0, to provide data for FIG. 26B UxyProductAddData.

FIG. 26B, UxyProductAddData: this table shows the results of the Uxy Product Adder (566). The last column provides an example from layout 1. Other layouts are similar: The result is a root times the sum of two other roots.

FIG. 26A and FIG. 26B, Usage: Although, due to cancellation, it may seem that the tables FIG. 26A and FIG. 26B are all subject to cancellation during the subtraction or addition; however, there is a silver lining. If any row in FIG. 26A has cancellation, the corresponding row in FIG. 26B will NOT have cancellation, and vice-versa; the larger value from corresponding rows of the two tables, or anything nearly as large, does not have cancellation. For rows 1 and 3, you only need to check row 1 to determine which table has precise entries for rows 1 and 3. And similarly for row 2, to determine which table has valid entries for rows 2 and 4. Thus, for rows 1 and 3 and 2 and 4, one and only one of the tables will suffer cancellation.

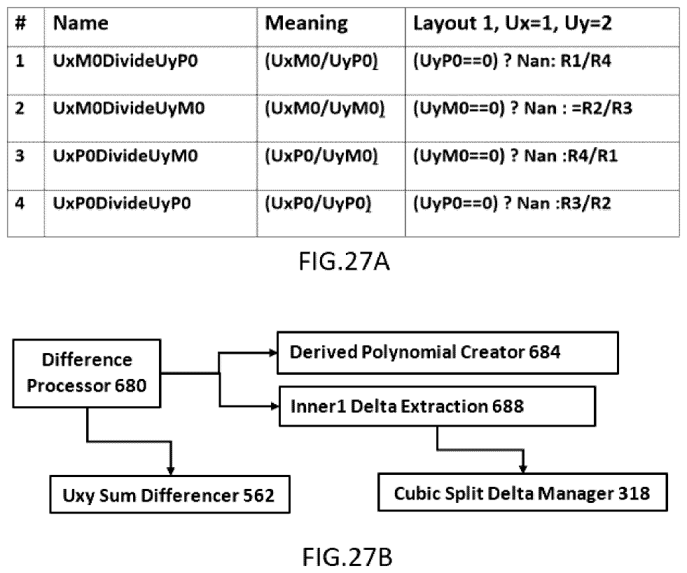

FIG. 23B, Uxy Multiplier (564): this component provides the data for FIG. 26C UxyMultiplyData. All product values always succeed in producing the precise ratio of roots, providing a0 is non-zero; of course, a0 is only 0 if there is a zero final root. See Uxy Divider (570) for FIG. 27A UxyDivideData, which doesn't have this problem. In general, the FIG. 27A UxyDivideData is better at producing the correct results because it doesn't involve the original coefficients.

FIG. 26C UxyMultiplyData: this table shows the results of multiplying two coefficients of the M0 and P0 forms from different u-roots. The last column provides an example from layout 1. Other layouts are similar: The result is a root divided by another root. Note that the table is 4 rows for each Ux, x={1,2,3}; thus, 12 rows are in effect. However, think of the four row table as applying to Uz. Thus, to process Uz equations, the Ux and Uy coefficients are used. Warning: note the division by a0 to produce simple results; do not use when there are zero roots in the quartic which is the only time a0 is zero.

FIG. 23B, UxyDivider (570): this component provides the data for FIG. 27A UxyDivideData. All values always succeed in producing the precise ratio of roots, provided the denominator is non-zero; a denominator of zero, such as UyM0 is row1, should produce Nan or something appropriate. For example, a divide by zero into a non-zero value might be Infinity, whereas a divide by zero into zero produces an indeterminate value. Note that row 1 is the inverse of row 3 and row 2 is the inverse of row 4.

FIG. 27A UxyDivideData: this table shows the division of one coefficient by another. The two coefficients are the M0 and P0 forms by different u-roots. The last column provides an example from layout 1. Other layouts are similar: The result is a root divided by another root. Of course, if there is a zero root, then watch out for divide by zero! The table entry for a divide by zero could be set to Nan. Note that these issues only arise when one or more roots are zero; see Zero Processor (518) to eliminate problems caused by one or more zeroes. In general, for Multi-U processing, zero roots are handled special-See Zero Handler (607) of FIG. 23B.

FIG. 23B, Quadratic Solvers: The Multi-U Evaluator (540) finds quadratic roots in three different ways. The Precise Quadratic Solver (202) of FIG. 2B was previously described with two or three parameters: The parameter for the directed root-pair difference can sometimes be precisely constructed from the other two parameters, as used herein. The previously described Ratio Product Solver (203) of FIG. 2C can produce precise results when the Precise Quadratic Solver (202) of FIG. 2B fails. A third method, the Ratio Divider Solver (612), of FIG. 23B, is described next.

FIG. 23B, Ratio Divider Solver (612): this component can be called within sub-components of the Generic-Z Handler(610) to return two precise root values, without any need for the root-pair difference. It is called when the roots are known to be relatively close: where the absolute value of the root pair difference is less than the absolute value of the root-pair sum. The parameters include a table rowIndexA (1 or 2) into the table UxyProductAddData of FIG. 26B; this method CANNOT be used if the required entry in the UxyProductAddData table has cancellation; however, this issue is erased by knowing the roots are relatively close together! And a second parameter, which must be non-zero, as the sum of the roots of the other equation: e.g. if seeking the roots from UzMinusEq, then the root sum of UzPlusEq is required. A second index is computed internally as rowIndexB=rowIndexA+2. The sum of the desired roots of the OTHER equation, Root Sum, is required; this value is non-zero. For example, suppose the rowIndexA is 1, and suppose rows 1 and 3 are associated with UzMinusEq (or you are at least assuming so), then divide the value in rowIndexA of the FIG. 26B by the root sum in the other equation, UzPlusEq (not UzMinusEq). Do the same for rowIndexB. Keep the order, {rowIndexA, rowIndexB}, of the values extracted using rowIndex. Returning the directed root-pair difference requires that FIG. 25B, UxySum DiffData, is available, as described earlier. If rowIndexA==2, then the directed distance is given row 2 of FIG. 25B, UxySumDiffData; otherwise by row 1 of the same table. Why does this work? First, the table UxyProductDiffData of FIG. 26A, contains a root times the root sum. Dividing by the root sum finds the root. Similarly, the other row contains the other root times the root sum.

FIG. 23B, Multi-U Evaluator (540): the Multi-U Evaluator (540) processes the three sets of quadratic coefficients returned by Triple Coefficient Processor(409) to return root-pair sums and the roots. Before calling the Multi-U Evaluator (540), tables can be pre-constructed using the Ux Analyzer(580) and UxyAnalyzer(560). However, these tables can be virtual, in that the entries can be trivially computed on-the-fly as needed. If so, then calling the Multi-U Evaluator (540) is the only action of the Multi-U Solver (520).

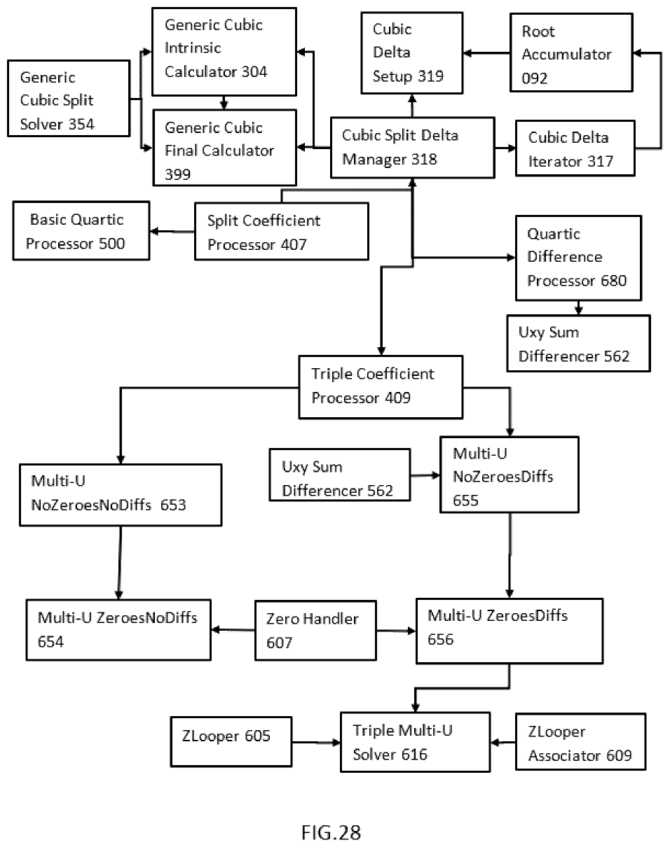

FIG. 23B, Multi-U Evaluator (540) Introduction: the UzSet is the focus for solving the two equations UzMinusEq and UzPlusEq (See FIG. 19E) which obtain their coefficients from the UzSet, because it contains the coefficients for the UzMinusEq and UzPlusEq equations. One type of approach is described below, but different approaches are summarized in FIG. 28, described later. Here is a summary of the processing. First, if full precision can be obtained, the equations UzMinusEq and UzPlusEq are processed by component Direct Solver (606), as described below; if both equations are processed, then return is immediate. Next, the optional Zero Handler (607) is called to handle the quartic equations which have at least one zero root, which is only True if the a0 coefficient of the quartic is zero. If only one equation is precisely solved, then solve the remaining equation using the One Solved Handler (608) and return. Finally, with two unsolved equations, a least error approach is taken as provided by the Generic-Z Handler (611) of FIG. 23B, described later. In all cases, the roots and root-pair sums are precisely returned.

FIG. 23B, Multi-U Evaluator (540) Root-pair Differences: Root-pair differences can always be returned if the Uxy Sum Differencer (562) is available: see its description detailing its requirements. In some cases below, such as “FIG. 23B, Multi-U Evaluator (540) Zero Root Check” there may be some ambiguity to the sign of the resulting root-pair difference; this is usually removed by subtracting second root from the first to obtain an approximate difference and negating the sign of the UxySumDiffTable entry, as needed, to obtain a better match. For such cases, if the root-pair difference is infinitesimal then the sign may be not be determinable due to total cancellation when subtracting roots.

FIG. 23B, Direct Solver (606): This component is called by the Multi-U Evaluator (540) to determine if the equations, UzMinusEq and UzPlusEq, can be precisely solved using the Precise Quadratic Solver (202); if the root-pair difference is greater than equal to the root-pair sum then its solvable. (Let UzMinusSubtract=Abs[(UzM1\hat{ }2−4 UzM0)], UzMinusAdd=Abs[UzM1\hat{ }2], and UzPlusSubtract=Abs[(UzP1\hat{ }2−4 UzP0)], UzPlusAdd=Abs[(UzP1\hat{ }2)]. Let IsMinusDirect=(1.0*UzMinusSubtract)>=UzMinusAdd and Let IsPlusDirect=(1.0*UzPlusSubtract)>=UzPlusAdd. Always use “greater than or equal” and not just “greater than” for IsMinusDirect and IsPlusDirect. Note: If an equation has a zero coefficient for c0 or c1 (see FIG. 1A) then the resulting Boolean will be True. Next, if one Boolean is True and one is False, then try to make them both True. Take the comparison which returned False and use an adjustment: If IsMinusDirect is False, reset it to (1.05*UzMinusSubtract)>=UzMinusAdd. Similarly, if IsPlusDirect is False, reset it to (1.05*UzPlusSubtract)>=UzPlusAdd. Now, if IsMinusDirect is True, then solve UzMinusEq with the Precise Quadratic Solver(202) which returns the two roots and their root-pair difference; the root-pair sum is −M1. Similarly, if IsPlusDirect is True, process UzPlusEq. If both Booleans are True, then return both sets of results. Otherwise, save the results of the solved equation and continue. Any equation directly solvable can return the directed root-pair differences directly from the call to the Precise Quadratic Solver (202).

FIG. 23B, Zero Root Handler (607): If the above described Multi-U Processor (541), of FIG. 23B, was utilized to remove zero roots, then this code is optional. Skip this processing if UzM0!=0 and UzP0!=0; only zero roots are processed. In this section, if either UzPlusEq or UzMinusEq, has a zero root, then both equations are completely processed by calling and returning results from this Zero Handler (607). Let SolvedC1 be the c1 coefficient of the solved equation (UzM1 or UzP1); and let SolvedC0 be the c0 coefficient (UzM0 or UzP0). If SolvedC0==0 and SolvedC1==0, then the two roots from the unsolved equation are extracted from either UxSet or UySet; for example, when using the UxSet, the two roots are {−UxM1, −UxP1}, with these roots having a root-pair sum taken from the unsolved equation (−UzM1 or −UzP1). Return the results. Otherwise, if only SolvedC0==0 and !(SolvedC1==0), then one root is found in the UxSet and the other in UySet. So, to find the first root, called the UxSet Root: if UxM0 is zero, the UxSet Root is −UxM1, otherwise −UxP1. Similarly, the second root of the unsolved equation, the UySet Root: if UyM0 is zero, the UySet root is −UyM1; otherwise its −UyP1. Why do these two methods succeed? Suppose SolvedC0==0 and SolvedC1==0 for the solved equation; this implies two zero roots appear together in UzSet. Therefore, in either of the other sets, each equation has one zero root plus one of the unsolved roots and is found as described above: refer to FIG. 24B for all these possibilities. In the latter case, with only SolvedC0==0 and SolvedC1!=0 , a zero root is paired with one, and only one root, of the UxSet, and one and only one root of the UySet. And those values are paired with a zero root. How are root-pair differences found for the newly solved equation? Any equation with a SolvedC0==0 or a SolvedC1==0 has already been solved during “FIG. 23B, Direct Solver(606)”, with its directed root-pair difference found by the Precise Quadratic Solver(202). The root-pair difference of the other equation can still be found if the UxySum DiffData table of FIG. 25B is available. First, match the known root-pair difference to the closest entry of the UxySumDiffData table and call this value's table index KnownIndex. If KnownIndex is 1 or 3, set the KeyIndex to 2, otherwise 2. The root-pair difference is found as the KeyIndex value of the UxySumDiffData table. In general, the directed root-pair difference is found by differencing the two roots and finding whether it matches closer to plus or minus the full precision result from the UxySumDiffData table. However, a guaranteed way to obtain the directed difference is to use the root-pair difference from the UxySumDiffData table as the difference parameter for the Precise Quadratic Solver (202), which is implemented to return the correct directed difference, in addition to the two ordered roots.

FIG. 23B, One Solved Handler (608): If neither equation is solved (IsMinusDirect and IsPlusDirect are False), then go to “FIG. 23B, Multi-U Evaluator (540) Generic Processing”, below. Otherwise, one Boolean is True, and one Boolean is False. None of the equations contain a zero root, because those cases are handled above: this implies all M0 and P0 of {UzSet, UySet, UzSet} are all non-zero (six values). Finally, the roots of the unsolved equation are relatively close together because it was not yet solved in the Direct Solver (606). The goal is to use the previously described Ratio Product Solver (203) of FIG. 2C, which requires 3 parameters to return precise roots: the root-pair sum, the root-pair product, and the root-pair ratio. Let UnsolvedSum be the negated c1 coefficient of the unsolved equation (−UzM1 or −UzP1); and let UnsolvedProduct be the c0 coefficient of the unsolved equation (UzM0 or UzP0). Then, the root-pair sum and product are given as {UnsolvedSum, UnsolvedProduct}. The third parameter is the ratio of the unsolved roots. The ratio of the known roots is found by dividing one of the two known roots (of the solved equation) into the other known root of the solved equation; it doesn't matter which is numerator or denominator. Now find the closest entry to this ratio value in the UxyDivideData table of FIG. 27A. The closest match is for the already solved equation. Do this. Set the UnsolvedIndex to 1 if the best match is index 2 or 4. Set the UnsolvedIndex to 2 if the best match is index 1 or 3. Now extract the ratio using index of UnsolvedIndex from the table. With these three parameters, call Ratio Product Solver (203) to obtain the two roots. Of course, the root-pair sum of the newly found roots is found in the unsolved equation as the −c1 coefficient, which is either −UzM1 or −UzP1. Return the results. To also return the root-pair difference, return the value of the UnsolvedIndex of the UxySumDiffData table and difference the just solved roots to decide if the UxySum DiffData entry should be negated for the directed root-pair difference.

FIG. 23B, Generic-Z Handler(611): this component is called by the Multi-U Evaluator(560) to solve the UzMinusEq and UzPlusEq equations, but only when it is known that none of the quadratic coefficients, {UzM1,UzM1,UzP1,UzP1}, are zero. Also, the two roots of each equation are known to be close together so that the Ratio Product Solver (203) can be called successfully, and, that all entries of the table UxyProductAddData of FIG. 26B are precise. This state is assured by the previous processing. Similarly, all entries in FIG. 27A are precise. In addition, the two other sets of quadratic coefficients from Ux and Uy are available. In the other two coefficient sets, M0 and P0 will be non-zero, but it is possible their corresponding M1 or P1 is zero. For example, let the roots be {−5,5,6,7}, and for UzMinusEq the roots are −5 and 6. Then in either UxSet or UySet, a −5 will be paired with 5, to create a zero for M1 or P1. All UzMinusEq and UzPlusEq roots, and root-pair sums are returned. The Generic-Z Handler(611), is shown in FIG. 23B. Amazingly, even without the root-pair differences, guaranteed full precision quartic roots are returned, but the procedure requires associated the roots of each quadratic equation to either rows 1 and 3 or 2 and 4.

FIG. 23B, Generic-Z Handler (611), Key Association Problem: When using the tables, a key problem is deciding when an equation, UzMinusEq and UzPlusEq, maps to data in rows {1,3} or to the rows {2,4}. For example, the roots in Layout #1 of FIG. 24B, are used as examples in the tables from FIG. 25B to FIG. 27A. Other layouts produce analogous results. For example, in FIG. 25B, the two roots, R1 and R4 are found in rows 1 and 3, and R2 and R3 are found in rows 2 and 4.

FIG. 23B, Generic-Z Handler (611), FIG. 23B, Generic-Z Handler(611), Assignments: There are two types of Row Assignment: {DirectAssignment, SwappedAssignment}. Many types of root extraction are available. But all extraction requires assigning rows {1,3} to either UzMinusEq or to UzPlusEq, and rows {2,4} to the remaining equation UzPlusEq or to UzMinusEq, respectively. When {1,3} is assigned to UzMinusEq, this is arbitrarily called DirectAssignment and otherwise the assignment is called SwappedAssignment.

FIG. 23B, Generic-Z Handler(611), Extraction Testing: Note: the root-pairs of both equations have roots close together (guaranteed by previous processing); therefore, table entries to FIG. 26B are precise. If rows {1,3} of FIG. 26B are divided by the correct sum (−UzM1 or −UzP1) then the roots are precisely found, and if rows {2,4} are divided by the other correct sum (−UzP1 or −UzM1), then we have our four precise roots as two roots from rows {1,3} and two roots from rows {2,4}; but, if the wrong sum is used, it produces incorrect roots. The Ratio Product Solver (203) of FIG. 2C established that the root-pair product, root-pair ratio, and root-pair sum is sufficient to find the roots. By dividing rows {1,3} or rows {2,4} by a non-zero value, the resulting ratio of values from rows {1,3} or rows {2,4} does not change the ratio of roots. So, no matter what, the ratio is always correct and doesn't require error testing. The root product and root sums will deviate for the wrong association. Therefore, relative error testing of only the root product and root sums determine the correct association, DirectAssociation or SwappedAssociation, of both equations to their associated rows.

FIG. 23B, Generic-Z Handler (611), 1st Association, SwappedError: assume UzMinusEq maps to rows 2 and 4, and UzPlusEq maps to rows 1 and 3. For this, divide-UzM1 into rows {1,3} of FIG. 26B, then the resulting two roots should sum to −UzP1, and their root product should be UzP0. Use RelativeError (818) of FIG. 3A to find the relative error for the root-pair product and root-pair sum; remember the worst case relative error of these two values. Now divide −UzP1 into rows {1,3} of FIG. 26B and again measure the worst-case relative error for the root-pair product and root-pair sum. Save the worst of the worst-case relative errors and call this value SwappedError.

FIG. 23B, Generic-Z Handler (611), 2nd Association, DirectError: Now perform an analogous operation after switching −UzP1 and −UzM0 on rows {1,3} and {2,4}, respectively, and compute the worst of the worst case error in the same manner: call the error DirectError. Again, see RelativeError (818) of FIG. 3A.

FIG. 23B, Generic-Z Handler (611), Choose Least Error: If SwappedError<DirectError, then UzMinusEq maps to rows 2 and 4, and UzPlusEq maps to rows 1 and 3; otherwise, UzMinusEq maps to rows 1 and 3, and UzPlusEq maps to rows 2 and 4. The precise roots of the correct association between equation and arrows, such as {{r1,r4}, {r2,r3}}, are known. Keep the roots ordered; for example, row 1 result followed by row 3 result, and similarly for rows {2,4}.

FIG. 23B, Generic-Z Handler (611), Root-Pair Difference: If the table UxySumDiffData of FIG. 25B is available, then use the mapping to find the correct entries in the UxySum DiffData. For example, if SwappedError<DirectError, then UzMinusEq difference is value at row index 2 of UxySum DiffData and UzPlusEq uses index 1 of UxySumDiffData. Otherwise, UzMinusEq uses index 1 of FIG. 25B UxySumDiffData, and UzPlusEq uses index 2 of UxySumDiffData.

FIG. 23B, Z-Looper Handler (605): this component, when present, reorders the {UxSet, UySet, UzSet} containing the three sets of quadratic coefficients. Normally, without the Z-Looper Handler (605), a single pass is made through the Multi-U Evaluator (541). This single pass returns all four roots, and the root-pair sums and differences for a specific set of {UzMinusEq, UzPlusEq}. And, because the root-pair sums, all six, are found, negated, in the M1 and P1 values for all three coefficient sets, all six root-pairs sums can be returned. Likewise, each of the quadratic coefficient sets can generate two root-pair differences; thus, all six are returned. What else is needed? An additional two passes with the reordering, such as {UySet, UzSet, and UxSet} and {UxSet, UzSet, and UySet}, returns two more sets of four roots. This additional pass associates the roots to the root-pair data. With three passes, all root pairs are associated with root values. Subsequent processing could return the selected root layout from FIG. 24B. However, some problems might remain. For example, if two roots are infinitesimally close together, then there may be some ambiguity, as to which layout is correct. These problems are addressed by the Z-Looper Associator (609), described next, but the correct layout (which is probably never needed) could be incorrect when roots are almost exact equal. Note, that even if the roots are mis ordered with regards to a tiny root-pair difference, it really doesn't matter because both roots are still correct within the numeric precision, after accounting for all numeric error.

### Multi-U Methods

FIG. 25C, Multi-U Methods: shows implementations for the Multi-U Evaluator (540). The first column, Multi-U NoDiff Evaluator (650) includes the two cases of Multi-U NoZeroesNoDiffs (653) and Multi-U ZeroesNoDiffs (654), which directly relates to the above discussion except that the FIG. 25B UxySumDiffData is not available. Multi-U NoZeroesNoDiffs (653) does not include the optional zero-root processing. Multi-U ZeroesNoDiffs (654) is similar but the Zero Handler (607) is implemented and called to handle cases where zero roots are possible. The second column of FIG. 25C is the Multi-U Diff Evaluator (651) are the same as the first column except that the FIG. 25B UxySum DiffData is available; this addition of root-pair differences allows for the guaranteed return of directed root-pair differences, as described above. As described earlier, the UxySum DiffData for the Multi-U Diff Evaluator (651) is a simple addition to the Multi-U Evaluator(540). However, the UxySumDiffData can also, optionally, pro-actively also help find the roots quickly. Consider the Generic-Z Handler(611) of FIG. 23B, where the main problem is to find the correlation of UzPlusEq and UzMinusEq to corresponding rows of 1 and 3 and also rows 2 and 4. In almost all cases (but not all), the root-pair differences from the actual equations, UzPlusEq and UzMinusEq, can be matched to the two root-pair differences for the UzSet found in the UxySum DiffData; this will fail if both of the equation's root-pair differences are so small that their actual value is completely numerically cancelled. However, this document has concentrated on methods that always work; more research may find subtle improvements or new ways of using the table data. In several above cases, the root-pair difference is matched to the difference between two roots; this is reasonable and gives precise results. However, alternatively, once the ambiguously signed root pair difference is found, it can be used with the known root-pair sum and product to call the Precise Quadratic Solver (202), which always returns the directed root-pair difference.

### Z-Looping

FIG. 23B, Z-Looper Handler (605): this component, when present, reorders the {UxSet, UySet, UzSet} containing the three sets of quadratic coefficients. Normally, without the Z-Looper (605), a single pass is made through the Multi-U Solver (520). This single pass returns all four roots, and the root-pair sums for a specific set of {UzMinusEq, UzPlusEq}, and optionally a only a pair of root-pair differences applicable to the UzMinusEq and UzPlusEq. The process can be repeated for a total of three times, with each of the resulting quadratic coefficient sets used as the final coefficients for the UzMinusEq and UzPlusEq. Consider the second process with the sets reordered as {UySet, UzSet, and UxSet}; in this case UySet is treated as the UxSet within the tables and UzSet is treated as the UySet in the tables and UxSet is now treated as the UzSet in the tables. Similarly, for the third pass the ordered sets could be {UxSet, UzSet, and UySet} with UxSet treated as the UxSet (no change), but with UzSet treated as the UySet and UySet treated as the UzSet. In this way (or something similar) each set is treated as a UzSet which produces the same roots (in a different order). However, the advantage is that all root-pair differences can be found, Subsequent processing could return the selected root layout from FIG. 24B. However, some problems might remain. For example, if two roots are infinitesimally close together, then there will always be some ambiguity, as to which layout is correct. These problems are addressed by the Z-Looper Associator (609), described next, but the correct layout (which is probably never needed!) could be incorrect when roots are almost exact equal.

FIG. 23B, Z-Looper Associator (609): this component, at the bottom of FIG. 23B, associates all four quartic roots from one set of {MinusEq, PlusEq} to another set of four roots in another quadratic coefficient set. The input consists of all original intrinsic root pairings and their final values. Suppose we call these three sets {SetA, SetB, SetC}. For example, SetA would have the following data: {MinusEqData, PlusEQData}, where the data for MinusEqData is {{iRA1, fRA1}, {iRA2, fRA2}}, with “i” for intrinsic and “f” for final. The PlusEqData is {{iRA3, fRA4}, {iRA3, fRA4}}. Then label the data for the other two quadratic coefficients, similarly, but using B and C instead of A. The goal is to know all associations so that root-pair sums and differences, which are already correctly associated within each set, but now roots across sets will be correctly associated. In effect, the goal is to find which of the eight layouts in FIG. 24B is applicable! Of course, if all roots in each set are comparatively unique, then it is trivial to match all four roots from one set to another. But what if some roots are infinitesimally close? Generally, root comparisons can of the intrinsic roots, but the final roots (correctly associated to the intrinsic roots) may help resolve ambiguity. For example, if the two intrinsic roots have values of X and X+epsilon, where epsilon is about 10\hat{ }−100 of X's value, then the intrinsic roots are not distinguishable at standard floating point precision. However, if the final offset is −X, then the two final roots, of the same intrinsic roots, will be {0,epsilon}, which are trivially distinguishable? Therefore, when comparisons are made, remember that the final roots could also be tested.

FIG. 23B, Z-Looper Associator (609): Two Roots Too Close: suppose only two of the four roots are numerically distinguishable, and two roots are too close together to distinguish between them. Of course, two roots may be identical, too. There is of course no way to easily distinguish almost identical roots, so the association only requires compatibility with one of the eight possible layouts. Let the two distinguishable roots be r1 and r2, and the two other roots, approximately equal, be designated as R. In some order, the three sets of roots from the three quadratic coefficient sets used in UzMinusEq and UzPlusEq, must be: {{r1,r2}, {R,R}}, {{r1,R}, {r2,R}}, {{r2,R}, {r1,R}}, where the ordering of each pairing might be reversed, as in {r1,R} is the same as {R,r1}, the pairing of {R,R} is okay, as each R can be assigned to one of the indistinguishable results. However, the next two sets can be assigned in two ways for indistinguishable roots R and R, now called R1 and R2. For example, we could have {{r1, R1}, {r2, R2}}, {{r2,R1}, {r1,R2}}. In this case, each indistinguishable root pair occurs only once with any other root. However, what if the two sets are {{r1, R1}, {r2, R2}}, {{r2, R2}, {r1, R1}} , then this violates the rule that any root, throughout all three sets, is paired only once with any other root.

FIG. 23B, Z-Looper Associator (609), Three Roots Too Close: processing three indistinguishable roots is just as easy. Just make sure that any one root is paired with each of the other three roots and that in any set of four roots, all four roots are assigned.

FIG. 23B, Z-Looper Associator (609), Root-Pair Differences: if root-pair differences are available, such as when using Uxy Sum Differencer (562) considerable advantage is gained in most cases.

FIG. 25B, Multi-U Discussion, On the fly Tables: The tables are shown as actual entities. In an actual implementation, the table entries can be generated on the fly as needed. The FIG. 25B UxySum DiffData table is only needed when root-pair differences are needed. UxyMultiplyData or UxyDivideData? The UxyMultiplyData table requires the a0 coefficient of the quartic to be non-zero after root values of zero are ruled out. Both tables require four divides, which are typically slower. For the UxyMultiplyData table, the a0 divisor can first be inverted to 1/a0, and then no other divides are necessary. The UxyDivideData at first needs four divides, but there are only two different divisors and these can be inverted and multiplication is then used.

### Quartic Difference Processor

FIG. 27B, Quartic Difference Processor (680): this component is a fast way to find all six root-pair differences of the quartic roots of a quartic equation. It involves only one cubic delta step, and therefore is a faster than the full Multi-U Solver (520). In FIG. 27B, the Derived Polynomial Creator (684) simply plugs the quartic coefficients into the standard form for the derived cubic polynomial. The Cubic Split Delta Manager (318), finds all three u-roots, the intrinsic roots and root pair differences of the u-roots are saved for a delta processing. Delta processing is used to find {iUxM1,iUxP1, iUyM1, iUyP1, iUzM1, iUzP1} values, as needed by the Uxy Sum Differencer(562). These values are also by-product (produced along the way) of computing the coefficients as done in the Split Coefficient Processor(407) and Triple Coefficient Processor (409). See the descriptions of FIG. 25A and FIG. 25B explain what is needed. Because delta operations are normally computed for all three u-roots at the same time, processing is very fast. Finally, the resulting values, such as {iUxM1, iUxP1, iUyM1, iUyP1, iUzM1, iUzP1}, are passed to the Uxy Sum Differencer(562) to return two root-pair differences; however, there are three u-roots, so all six root-pair differences are returned.

### Detailed Summary Of Augmentations

FIG. 28 diagrams the augmentations of the historic formulas for precisely solving all complex cubic and quartic polynomials; additionally, root-pair differences and root-pair sums are precisely calculated. For these augmented formulaic solutions, no iteration is required.

FIG. 28: Basic solving of cubic polynomial processing begins by splitting the processing into intrinsic and final forms. Three components are shown in the upper left corner. The Generic Cubic Split Solver (354) calls the Cubic Intrinsic Calculator (320) or the Generic Cubic Intrinsic Calculator (304), and then the Generic Cubic Final Calculator (399) or the Cubic Final Calculator (350), to find the cubic roots and all root-pair sums and differences. See FIG. 18A. Not shown, a Paired Root Sum Calculator (305) of FIG. 5 and FIG. 10, can be called by the Cubic Split Solver (351) to provide cubic root-pair sums. Also, FIG. 17A describes a univariate solution. In particular, the Cubic Intrinsic Root Solver (348), part of the Cubic Intrinsic Calculator (320), has three implementation methods: Cubic Intrinsic Product method, Triple Intrinsic Root CRS method, and Hybrid Intrinsic Root CRS method. The Cubic Intrinsic Root Solver (348) implements the Cubic Root Difference Solver (349) in three ways: Ambiguously Signed Discriminant method, Triple Root Pair CRS method, and Hybrid Difference Solver method.

FIG. 28: In the top-middle area of FIG. 28, two components, Cubic Delta Setup (319) and Cubic Split Delta Manager (318), form the basis of the process to quickly add the same constant, called delta, to all cubic roots, with correct association to the original cubic roots, without numeric cancellation and without having to again call the Cubic Intrinsic Calculator (320). The Cubic Split Solver (351) makes this easy. See FIG. 4B and FIG. 18B. This process is called cubic delta processing and is a critical invention needed for solving quartic equations. A delta specification can specify an additive constant and a “scaling” factor; the scaling factor is complex value scaling both the magnitude and rotating all roots. Even though the delta specification is specified in terms of the precise (only precise) roots of a cubic polynomial, the actual computation tricks the u-roots into being the exact roots.

FIG. 28: In the top-right area of FIG. 28, the two components, Cubic Delta Iterator (317) and the Root Accumulator (092), augment the delta process into an iterative loop to increase the root precision, on each iteration, by the underlying floating-point precision, and all without recomputing the cubic intrinsic processing. Why would one need this? After all, given the floating-point precision, the result will only suffer a small number of units of decimal precision; there is no unexpected cancellation. Why not just use a sufficient software floating point precision and avoid iteration? Perhaps your cube root processing cannot handle high precision. Or perhaps you find out later that more precision is needed. See FIG. 4C and FIG. 18C.

FIG. 28: The remaining components of FIG. 28 relate to processing quartic polynomials. In the upper-right, below the Cubic Delta Iterator (317), the Quartic Difference Processor (680) quickly returns all six precise root-pair differences of the four final quartic roots, all without attempting to solve the quartic. In fact, only the derived cubic polynomial, of the quartic polynomial, is needed. Magic is provided by the component below it, the Uxy Sum Differencer (562), which can find precise quartic root-pair differences. Refer to FIG. 27B. In this case, only the intrinsic quadratic coefficients of M1 and P1 are needed: {iUxM1, iUxP1, iUyM1, iUyP1, iUzM1, iUzP1}: for these values see FIG. 25A and FIG. 25B. As shown in FIG. 28, this operation utilizes delta processing, but much less than the full quartic roots processing.

In FIG. 28, the Split Coefficient Processor (407), beneath and to the left of the Cubic Split Delta Manager (318), creates a precise quadratic coefficient set, {M0, M1, P0, P1}, with respect to one of the u-roots by utilizing the three u-roots to the derived cubic polynomial, which is constructed from coefficients of the original quartic polynomial. Several methods may be used for implementation, as described, but all utilize the Cubic Split Delta Manager (318), already mentioned above. See FIG. 21A through FIG. 22C. See FIG. 19E for the use of these quadratic coefficients within two quadratic equations whose four roots are the roots of the original quartic equation. The most brute force method for the Coefficient Manager (430) of FIG. 21A and FIG. 21C uses three delta processes and is called the Brute Force Solver (453). A faster method, Sqrt1 Divide Solver (436) of FIG. 21B and FIG. 21C, only requires two delta iterations and finds the third delta result from the first two. Also, less likely to be fast, consider the Sqrt0 Divide Solver (441) of FIG. 21C and FIG. 22B. All three methods are collectively referred to as the Coefficient Manager (430); pick one.

In FIG. 28, to the left of the Split Coefficient Processor (407), the Basic Quartic Processor (500), takes one set of precise quadratic coefficients, {M0, M1, P0, P1}, and uses a pair of the historic quadratic solutions to produce the four quartic roots. With a resulting precision (half-precision) that may be sufficient in some cases. See FIG. 23A. The quadratic coefficient set, {M0, M1, P0, P1}, provides coefficients for MinusEq=x\hat{ }2+M1*x+M0 and PlusEq=x\hat{ }2+P1*x+P0. Directly solving these equations can cause numeric cancellation when processing the root-pair difference; therefore, the result can (only) be guaranteed to about half precision of the underlying floating-point input. However, using three sets of quadratic coefficients can raise the final precision to a guaranteed full-precision, as summarized next.

In FIG. 28, underneath the Split Coefficient Processor (407), the Triple Coefficient Processor (409) produces three sets of quadratic coefficients, {M0, M1, P0, P1}. Of course, it could be implemented by making three calls to the Split Coefficient Processor with each call using a different u-root of the derived cubic polynomial. But wait, during delta processing all roots of the derived polynomial are processed simultaneously, even during a call to the Split Coefficient Processor (407). Therefore, the effort for the Triple Coefficient Processor (409) is nearly identical to the Split Coefficient Processor (407). Also, to obtain quartic root-pair differences, the method can be modified to additionally return the intrinsic partial results: {iUxM1, iUxP1, iUyM1, iUyP1, iUzM1, iUzP1}, which are part of the basic calculation.

FIG. 28: In FIG. 28, beneath the Triple Coefficient Processor (409), two columns of components, left and right, are shown. The left-side column contains the components for directly finding full-precision roots, without ever having to compute the quartic root-pair differences. The right-most column shows components for finding precise quartic roots, their root-pair differences, and their root-pair sums. The three components in the middle column are sub-components for both other columns. The main component names include “Multi-U” to indicate all three u-roots are used to produce the three quadratic coefficient sets.

FIG. 28: Consider the two components in the middle column. In those descriptions, the root-pair differences from the Uxy Sum Differencer (562) are only needed when root-pair differences must be returned; for use of this component, the Triple Coefficient Processor (409) must return the intrinsic iM1 and iP1 data, which is a side-effect of producing the full quadratic coefficient sets. The Zero Handler (607) is treated special because it is not needed if zero roots of the quartic are processed elsewhere.

FIG. 28: Beginning with the left-side column, the Multi-U NoZeroesNoDiffs (653) can precisely solve for all four roots of the quartic polynomial, provided the a0 coefficient is non-zero indicating no zero roots. (When a0 is zero, one of the roots is zero, and the remaining three roots could be solved using a cubic equation by throwing away the a0 value and dividing the remaining polynomial by x; quartic processing is never needed). Underneath the Multi-U NoZeroesNoDiffs (653), the Multi-U ZeroesNoDiffs (654) references the Zero Handler (607) which is called to handle the case of zero roots; therefore, Multi-U ZeroesNoDiffs (654), can find all four precise quartic roots for any complex quartic polynomial.

FIG. 28: In FIG. 28, processing along the lower-right-side, the Multi-U NoZeroesDiffs (655) uses the Uxy Sum Differencer(562) to return the roots, root-pair differences and root-pair sums for both UzMinusEq and UzPlusEq, when there are no zero roots. The Multi-U ZeroesDiffs (656) adds a version of the Zero Handler (607) that not only processes the zero roots, but also completes processing of all root-pair differences. Because the Triple Coefficient Processor (409) is set to return all three sets of {iM1, iP1}, the six root-pair sums are also available; simply negate each M1 and P1 for root-pair sums associated to the pair of roots of each equation.

FIG. 28: Finally, at the bottom of FIG. 28, the Triple Multi-U Difference Solver (520) is introduced. It utilizes the ZLooper(605) to process roots, root-pair sum and differences, a total of three times. Of course, each time the four roots are returned. Because each of the three loops returns two root-pair sums and differences, it means all six root-pair sums and differences are returned. The ZLooper Associator (609) largely succeeds in associating the root-pair sums and differences to the correct pair of roots: see the description of the ZLooper Associator (609).

FIG. 28:, Multi-U Best Mode: If root-pair differences are not required, then use methods for Multi-U NoDiff Evaluator (650). Also, Multi-U NoZeroesNoDiffs (653) cannot handle UzMinusEq or UzPlusEq with a zero root. Suppose it is known that no zero roots will be encountered (e.g., quartic a0 coefficient is non-zero), should you use the Multi-U NoZeroesNoDiffs (653) instead of the complete solution of Multi-U ZeroesNoDiffs (654)? Not really, because the overhead is minimal. For similar reasons, when root-pair differences are required, the Multi-U ZeroesDiffs (656) will be essentially as fast as Multi-U NoZeroesDiffs (655).

### CONCLUSIONS, RAMIFICATIONS, SCOPE

Conclusions: This fast approach for solving cubic and quartic polynomials, augmentation of formulaic solutions, not only provides a simple way to solve cubic and quartic equations applicable to SIMD processing, but also provides cubic and quartic root-pair sums and differences. This is achieved by handling numeric cancellation and utilizing alternative code paths. Total dedication to preserving precision and exact zeroes, is required.

Ramifications: Fast and dependable solving of third-and fourth-degree equations through formulas will likely revolutionize many numerical applications. Solving for these roots is particularly applicable to SIMD graphic applications. The guarantee of precise root-pair sums and differences opens entirely new applications.

Scope: The scope is comprehensive: All roots of cubic and quartic complex polynomials can be rapidly solved with root-pair sums and differences, with all results precise.

1. A generic cubic intrinsic calculator method as an augmentation to historical formulaic cubic polynomial processing of a cubic polynomial of form x\hat{ }3+c2*x\hat{ }2+c1*x+c0==0, wherein x is an unknown variable with c2, c1 and c0 are expressions of a constant value, wherein augmentations are based on the following terminology: a Q=c1/3−(c2\hat{ }2)/9, a R=[(1/6)*(c1*c2 −3*c0)−(1/27) (c2\hat{ }3), a DSqrt=Sqrt[R\hat{ }2+Q\hat{ }3], a CSR1 and a CSR2 are defined as cube roots of a kernel1=R+DSqrt and a kernel2=R−DSqrt, respectively, with the cube root branches, for said CSR1 and said CSR2, respectively, chosen such that CSR1*CSR2 =−Q, which, given that there are three cubic roots possible, a list of three CSR pairs, called a CRS Pair List, is possible, with a SumCRS=CSR1+CSR2, and a DiffCRS=CSR1-CSR2, with a set of intrinsic roots defined by {iR1=SumCRS, iR2=−SumCRS/2+1 Sqrt[3]*DiffCRS/2, iR3=−SumCRS/2+1 Sqrt[3]*DiffCRS/2}, wherein the augmentation includes an intrinsic code path selected from an intrinsic code path group consisting of:
A) providing a cubic sumdiff CRS means to compute said SumCRS and said DiffCRS by taking the larger, by magnitude of said SumCRS and said DiffCRS with the other value found by mathematical identities;
B) providing a cubic intrinsic root solver means to compute the intrinsic roots of said cubic polynomial, selected from a group consisting of: a cubic intrinsic product means to find a third intrinsic root by dividing two times said R by the product of the other, of the two known intrinsic roots; a triple intrinsic root CRS means which uses each of the SumCRS values within said CRS Pair List as the intrinsic roots; and, a hybrid intrinsic root CRS means which utilizes two of the SumCRS values within said CRS Pair List as intrinsic roots with the third intrinsic root found by dividing the product of the other two intrinsic roots into product of intrinsic roots;
C) providing a cubic root difference solver means to find root-pair differences, selected from a group consisting of: providing an ambiguously signed discriminant means to find the last of the three root-pair differences by using said DSqrt; and, providing a triple root pair CRS means to find the last of the three cubic root-pair differences by generating three of the DiffCRS values, each multiplied by a constant; and, providing a hybrid difference solver means utilizing at least two of said DiffCRS values with said DSqrt.

2. The generic cubic intrinsic calculator method of claim 1 augmented to a univariate manager method, with scaling of roots to convert an intrinsic expression value into a constant value, comprising:
A) providing a univariate preprocessor means to pre-scale coefficients of the polynomial so that said intrinsic expression is converted to said constant value while the intrinsic roots of said polynomial are scaled;
B) calling said univariate preprocessor means to scale coefficients of the polynomial;
C) calling said generic cubic intrinsic calculator means with said cubic polynomial with scaled coefficients to find a scaled set of intrinsics of the cubic polynomial;
D) providing a univariate post processor means to produce unscaled versions of said scaled set of intrinsics by reverse scaling the effect of said univariate preprocessor means;
E) calling said univariate post processor means to produce the unscaled intrinsics that reverse said scaled intrinsics;
F) returning said unscaled intrinsics corresponding to the original cubic polynomial.

3. The univariate manager method of claim 2 wherein said generic cubic intrinsic calculator means is optimized into a Univariate Cubic Intrinsic Calculator modified to take advantage of the elimination of a variable.

4. The generic cubic intrinsic calculator method of claim 1 including two of the intrinsic code paths.

5. The generic cubic intrinsic calculator method of claim 1 including two of the intrinsic code paths wherein one of the intrinsic code paths is said sumdiff CRS means.

6. The generic cubic intrinsic calculator method of claim 1 wherein said intrinsic code path is said cubic intrinsic root solver means.

7. The generic cubic intrinsic calculator method of claim 1 wherein said intrinsic code path is said cubic root difference solver means.

8. The generic cubic intrinsic calculator method of claim 1 including two of the intrinsic code paths wherein of the intrinsic code paths is said cubic difference solver means.

9. The generic cubic intrinsic calculator method of claim 1, augmented to a cubic split solver method by further including a cubic final calculator method which adds a final offset to each root of the intrinsic roots to define a final offset polynomial which has a final roots set containing the roots of the original cubic polynomial, comprising:
A) providing a constrained double root solver means to find said final roots set containing all three final roots, with an input of the final offset polynomial, the intrinsic roots, and a known final root, to produce the final roots of the final offset polynomial, selected from a group consisting of:
i) providing an inverse double root solver means to find the final roots by finding a second known root as the largest magnitude root of the inverse polynomial of said final offset polynomial with the third root found by dividing the product of the two know roots into the product of all three final roots;
ii) providing an equation solver means to find said final roots set without recomputing intrinsic data, selected from a group consisting of:
a) providing a paired sum double root finder means to find the final roots by solving a quadratic equation whose two roots replace the two unknown roots;
b) providing a quadratic double root finder means to find the final roots by solving a quadratic equation with one extraneous root and the second known root which allows the third root to be found by dividing the two known roots into the product of all three roots;
B) providing a final roots constrainer means to add said final offset to each root of the intrinsic roots while sorting results into a set of known roots and a set of imprecise roots based on significant numeric cancellation error determined by a predefined error constraint constant which is compatible with said constrained double root solver means;
C) providing a cubic final calculator method to convert the intrinsic roots into the final roots based on three inputs: the final offset, the final offset polynomial, and the intrinsic roots, comprising:
i) calling said final roots constrainer means to determine a root count of the set of imprecise roots;
ii) when the imprecise root count is two, calling said constrained double root solver means, to obtain a set of three final roots;
iii) returning the final roots;
D) calling said cubic final calculator method to obtain the final roots;
E) returning the final roots.

10. The cubic split solver method of claim 9, wherein said constrained double root solver means is said quadratic double root finder means.

11. The cubic split solver method of claim 9, wherein said constrained double root solver means is chosen as paired sum double root finder means.

12. The cubic split solver method of claim 9, augmented to a paired root sum calculator method to additionally return a set of root-pair sums of said final offset polynomial with correct association to the intrinsic roots of said cubic polynomial, further including:
A) calling said cubic split process method to obtain all roots of the cubic polynomial;
B) creating a paired root summation polynomial derived from the cubic polynomial;
C) calling said cubic final calculator method to compute roots of the paired root summation polynomial which are the root pair sums of the cubic polynomial;
D) returning results.

13. The cubic split solver method of claim 9 augmented to a cubic split delta manager method by additionally determining a set of delta roots by effecting addition of a delta constant to each of the intrinsic roots to form the delta roots with correct association to the intrinsic roots, comprising:
A) calling said cubic split solver method with said cubic polynomial and saving said intrinsic roots set for delta processing;
B) providing a cubic delta setup means to construct a delta polynomial which has said delta roots equal to adding said delta constant to each root of said intrinsic roots set;
C) calling said cubic delta setup means to prepare said delta polynomial;
D) calling said cubic final calculator method to convert the intrinsic roots into the delta roots with correct association between intrinsic and final roots based on input of the final offset as said delta offset, the final offset polynomial as said delta polynomial, and the intrinsic roots;
E) returning results with the intrinsic roots correctly associated to the final delta roots.

14. The cubic split delta manager method of claim 13 augmented to a cubic delta iterator method to iteratively improve the precision of a root to a precision goal, by further including:
A) providing a root accumulator means to accumulate higher and higher precision roots;
B) calling said cubic split solver method with said cubic polynomial and saving said intrinsic roots set for delta processing with the final roots used to initialize said root accumulator means;
C) until achieving said precision goal, repeatedly calling said cubic split solver method with parameters adjusted to reflect accumulated root values while accumulating higher precision results in said root accumulator means;
D) returning the final roots after meeting said precision goal.

15. The cubic split delta manager method of claim 13 augmented to a split coefficient processor method for finding a quadratic coefficient set, {M0, M1, P0, P1} of a quartic polynomial by utilizing a u-root, which is any root of a derived cubic polynomial of said quartic polynomial, with delta processing using said cubic split delta manager method to eliminate numeric cancellation when evaluating expressions which define values within the quadratic coefficients, comprising:
A) forming a derived cubic polynomial from the coefficients of the quartic polynomial;
B) calling said cubic split solver method operating on said derived cubic polynomial to compute the intrinsic roots together with a set of final u-roots with the final u-roots correctly associated to the intrinsic roots;
C) providing a coefficient manager means to determine the quadratic coefficients, {M0, M1, P0, P1} of an input u-root for a quadratic equation set of MinusEq, PlusEq by delta processing expressions for the input u-root;
D) calling said coefficient manager means to extract the quadratic coefficients by utilizing one of the u-roots of the final u-roots;
E) returning said quadratic coefficients set, {M0, M1, P0, P1}.

16. The split coefficient processor method of claim 15 augmented to a basic quartic processor method to return a set of four quartic roots of said quartic polynomial for a chosen u-root of said derived cubic polynomial, comprising:
A) providing a quadratic solver means to solve a quadratic equation when given coefficients for a quadratic equation;
B) calling said split coefficient processor method to extract the set of quadratic coefficients, {M0, M1, P0, P1}, with reference to said chosen u-root;
C) providing a quick final solver means to apply said quadratic solver means to a pair of quadratic equations, {x\hat{ }2+M1 x+M0==0, x\hat{ }2+P1 x+P0==0}, with resulting quadratic roots stored as the four quartic roots;
D) calling said quick final solver means to obtain the four quartic roots;
E) returning the four quartic roots.

17. The cubic split delta manager method of claim 13 augmented to a Quartic Difference Processor method for returning all six root-pair differences of a quartic polynomial by returning all u-roots and u-root root-pair differences, comprising:
A) forming a derived cubic polynomial from the coefficients of the quartic polynomial;
B) calling said cubic split solver method operating on said derived cubic polynomial to compute the intrinsic u-roots together with a set of final u-roots with root-pair differences, called with the final u-roots correctly associated to the intrinsic u-roots;
C) calling the cubic split delta manager method to return a set of all three Part1 values through delta processing;
D) from the three Part1 values, constructing an intrinsic partial results comprised of {iUxM1, iUxP1, iUyM1, iUyP1, iUzM1, iUzP1};
E) providing a Uxy Sum Differencer means to compute a root-pair difference between two quartic roots, given the appropriate values from the intrinsic partial set with the root-pair differences for two u-roots;
F) calling said Uxy Sum Differencer means six times to return a root-pair difference with the appropriate parameters from the intrinsic partial set together with the appropriate u root-pair difference of two u-roots so as to obtain all six quartic root-pair differences;
G) returning all six root-pair differences.

18. The split coefficient processor method of claim 15 augmented to a triple coefficient processor method, which returns a triple coefficient list containing the quadratic coefficients sets, {UxSet, UySet, UzSet), each containing {M0, M1, P0, P1} for a specific u-root, by returning delta processing results from all the final u-roots of said derived cubic polynomial processor method.

19. The triple coefficient processor method of claim 18 augmented for returning a quartic roots set containing the four quartic roots of said quartic polynomial by utilizing arithmetic relationships between the quadratic coefficients sets within said triple coefficient list, comprising:
A) calling said triple coefficient processor method to produce the triple coefficient list;
B) providing a Multi-U NoDiff Evaluator means to return the quartic roots set of a quartic equation by using mathematical relationships between values within the quadratic coefficient sets of said triple coefficient list;
C) calling said to a Multi-U NoDiff Evaluator means to return the quartic roots set;
D) returning the quartic roots set.

20. Thes9 triple coefficient processor method of claim 19 augmented to additionally return root-pair differences of a UzMinusEq and a UzPlusEq equation together with a pair of roots for s9each of the equations, wherein a {iM1,iP1}set is provided for both the UxSetand UySet of quadratic coefficients, wherein said generic cubic intrinsic calculator using said cubic difference solver means additionally provides a UxUyDiff with the root-pair difference between the Ux and Uy roots of the derived cubic polynomial, wherein said Multi-U NoDiff Evaluator means is augmented to multi-u diff evaluator means to additionally return root-pair differences, comprising:
A) calling said triple coefficient processor method to produce the triple coefficient list together with the return of the {iM1,iP1} sets with said UxUyDiff for the Ux and Uy quadratic coefficient sets;
B) providing a Uxy Sum Differencer means to compute a root-pair difference when provided with input of required values from said {iM1,iP1}sets together with said UxUyDiff value;
C) twice calling said Uxy Sum Differencer means to return a pair of root-pair differences for the UzMinusEq and the UzPlusEq equations by passing appropriate {iM1,iP1} values as parameters together with said UxUyDiff;
D) calling said multi-u diff evaluator means to return roots and root-pair differences for said UzMinusEq and said UzPlusEq equations;
E) returning results.

21. The method from claim 20 augmented to additionally return quartic roots and a set of root-pair differences by sequentially designating one of the quadratic coefficient sets as a designated UzSet coefficient set with the other two coefficient sets assigned as the UxSet and UySet coefficient sets, wherein a {iM1,iP1}set is provided for each of the three coefficient sets together with the three u-root root-pair differences, wherein the directed root-pair differences, a total of three root-pair differences between u-roots, are provided, comprising:
A) calling the method, of claim 20, three times to return results for each of three quartic coefficients assigned as the u-root with the necessary {iM1,iP1}sets and u-root difference;
B) optionally, additionally, returning the three sets of {−M1,−P1} values as the corresponding root-pair sums.

22. A cubic final calculator method for finding a final roots set containing final roots of a cubic polynomial when provided with the polynomial's intrinsic roots and a final offset to add to each intrinsic root to produce said final roots set, comprising:
A) providing a constrained double root solver means to find said final roots set containing all three final roots, with an input of the final offset polynomial, the intrinsic roots, and a known final root, to produce the final roots of the final offset polynomial, selected from a group consisting of:
i) i) providing an inverse double root solver means to find the final roots by finding a second known root as the largest magnitude root of the inverse polynomial of said final offset polynomial with the third root found by dividing the product of the two know roots into the product of all three final roots;
ii) providing an equation solver means to find said final roots set without recomputing intrinsic data, selected from a group consisting of:
a) providing a paired sum double root finder means to find the final roots by solving a quadratic equation whose two roots replace the two unknown roots;
b) providing a quadratic double root finder means to find the final roots by solving a quadratic equation with one extraneous root and the second known root;
B) providing a final roots constrainer means to add said final offset to each root of the intrinsic roots while sorting results into a set of known roots and a set of imprecise roots based on significant numeric cancellation error determined by a predefined error constraint constant compatible with said constrained double root solver means;
C) providing a cubic final calculator method to convert the intrinsic roots into the final roots based on three inputs: the final offset, the final offset polynomial, and the intrinsic roots, comprising:
i) calling said final roots constrainer means to determine a root count of the set of imprecise roots;
ii) when the imprecise root count is two, calling said constrained double root solver means, to obtain at least one more root with the third root, if still unknown, found by dividing the product of known roots into product of all roots of the final offset polynomial;
iii) returning the final roots;
D) calling said cubic final calculator method to obtain the final roots;
E) returning the final roots.

23. The cubic final calculator method of claim 22 wherein said constrained double root solver means is said equation solver means.

24. Providing a cubic split delta manager method for solving a cubic polynomial with a delta specification to process a delta polynomial of said cubic polynomial without recomputing intrinsic roots, comprising:
A) providing a generic cubic intrinsic calculator means to find a set of three intrinsic roots of said cubic polynomial through any means;
B) providing a generic cubic final calculator means to find a set of final roots and an associated set associated intrinsic roots, for a delta cubic polynomial given the three intrinsic roots and a final offset to add to the intrinsic roots to produce the set of final root, by any means;
C) providing a delta setup means to form said delta polynomial of said cubic polynomial from said delta specification;
D) providing a split delta manager method to compute the final roots of said delta polynomial based on said cubic polynomial and said delta specification, comprising:
i) calling said generic cubic intrinsic calculator means to find the intrinsic roots for said cubic polynomial for later uses;
ii) calling said delta setup means with said delta specification passed as the delta specification to produce said delta polynomial;
iii) calling said generic cubic final calculator means to obtain the final roots of said delta polynomial using said delta specification to determine the final offset;
iv) returning results with the intrinsic roots correctly associated to the final delta roots;
E) calling said split delta manager method to return said final roots of said delta polynomial;
F) returning the calculated roots.

25. The cubic split delta manager method of claim 24 augmented to a split coefficient processor method for finding a set of quadratic coefficients, {M0,M1,P0,P1} of a quartic polynomial by utilizing a u-root, any root of a derived cubic polynomial of said quartic polynomial, with cubic delta processing to eliminate numeric cancellation when evaluating expressions which define components of said quadratic coefficients set, comprising:
A) providing a derived polynomial means to create said derived cubic polynomial from said quartic polynomial;
B) calling said derived cubic polynomial means to find said derived cubic polynomial;
C) calling said cubic split process method operating on said derived cubic polynomial to compute the intrinsic roots together with a final root set containing all roots, the u-roots, of said derived cubic polynomial, with the final root set correctly associated to said intrinsic roots set;
D) providing a coefficient manager means to determine a quadratic coefficients set, {M0, M1, P0, P1} for MinusEq and PlusEq quadratic equations by incorporating delta processing of said derived cubic polynomial;
E) calling said coefficient manager means to extract said quadratic coefficients set associated with said u-root;
F) returning said quadratic coefficients set, {M0, M1, P0, P1}.

26. The split coefficient processor method of claim 25 augmented to a basic quartic roots method to return a set of four quartic roots of said quartic polynomial for a chosen root, the u-root, of said derived cubic polynomial, comprising:
A) providing a quadratic solver means to solve a quadratic equation specified with coefficients of a quadratic equation;
B) calling said split coefficient processor method to extract said quadratic coefficients set, {M0, M1, P0, P1}, with said chosen root;
C) applying said quadratic solver means to the pair of quadratic equations, {x\hat{ }2+M1x+M0, x\hat{ }2+P1 x+P0} with resulting quadratic roots stored as the four quartic roots;
D) returning the four quartic roots.

27. The split coefficient processor method of claim 25 augmented to a triple coefficient processor method wherein delta results for the quadratic coefficient sets are returned for each of the three roots of the derived cubic polynomial to produce a triple coefficient list.

28. The triple coefficient processor method of claim 27 augmented for finding a quartic roots set of four quartic roots of said quartic polynomial by utilizing mathematical relationships between the three quadratic coefficients sets, comprising:
A) calling said triple coefficient processor method to produce a triple coefficient list;
B) providing a multi-u evaluator means to return the four quartic roots from said triple coefficient list by using mathematical relationships within said triple coefficient list;
C) calling said multi-U evaluator means to return results.

29. A method for finding a set of final roots of a quartic polynomial from three quadratic coefficient sets by extracting roots from a pair of quadratic equations, UzPlusEq and UzMinusEq having coefficients from one of the quadratic coefficient sets, comprising:
A) determining which of the two quadratic equations will return results of sufficient precision;
B) calling said quadratic solver means for the quadratic equations which result in sufficient precision of the resulting two roots;
C) using mathematical relationships between quadratic coefficient sets to find roots of equations which fail the precision test of above (B);
D) returning the set of four final quartic roots.
